(19) United States
(12) Patent Application Publication
(10) Pub. No.: US 2012/0140679 A1
(43) Pub. Date: Jun. 7, 2012

(54) PATH SETTING METHOD AND TRANSMISSION DEVICE

(75) Inventors: Toru INABA, Kawasaki (JP); Eiji Sugawara, Kawasaki (JP)

(73) Assignee: FUJITSU LIMITED, Kawasaki-shi (JP)

(21) Appl. No.: 13/289,171

(22) Filed: Nov. 4, 2011

(30) Foreign Application Priority Data
Dec. 1, 2010 (JP) 2010-268071

(51) Int. Cl. H04L 12/28

(52) U.S. Cl. 370/258

(57) ABSTRACT

A path setting method for setting a backup path corresponding to a currently used path in a ring network using a label switching method includes setting an unused first label as a transmitting label of the backup path corresponding to the currently used path in a first direction; reporting the first label to a adjoining transmission device in the first direction; setting the first label as a receiving label of the backup path in the first direction; setting an unused second label as the transmitting label of the backup path in a second direction; reporting the second label to a adjoining transmission device in the second direction; and setting the second label as the receiving label of the backup path in the second direction, in which the backup path is set when the currently used path is set between two transmission devices.

### CROSS-REFERENCE TO RELATED APPLICATIONS

This application is based upon and claims the benefit of priority of Japanese Patent Application No. 2010-268071, filed Dec. 1, 2010. The entire contents of which are incorporated herein by reference.

### FIELD

The embodiment discussed herein is related to a technique of establishing a path in a ring type network using a label switching method.

### BACKGROUND

Recently, with the cost reduction of a carrier network and the increase of demand for IP traffic, SDH/SONET (Synchronous Digital Hierarchy/Synchronous Optical NETwork) systems have been gradually replaced by packet based networks having higher line usage efficiency. Among the packet based methods, a packet-based transport method called MPLS-TP (Multi-Protocol Label Switching-Transport Profile) is being developed as a method capable of visualizing a path. Similar to MPLS, but unlike the routing process in the related art using the IP address, the MPLS-TP employs a label-switching-type packet forwarding technique using identification data called a “label” attached to the packet.

On the other hand, there has been known a protection technique capable of recovering from a state where packet transmission is cut due to a failure in the ring type network and correcting the failure in a short time period. Next, specific examples of the protection technique in the MPLS-TP in the related art will be described with reference to FIGS. 1 through 5. A part (a) of FIG. 1 illustrates a connecting state of a ring type network including six node devices (transmitting devices) N1 through N6. On the other hand, a part (b) of FIG. 1 illustrates the data of the node devices and the corresponding adjacent node devices, the receiving lines, and the transmitting lines. FIG. 2 illustrates an example of a currently used path (transmitting and receiving nodes N1 through N5) set in the ring type network of FIG. 1. More specifically, a part (a) of FIG. 2 illustrates a transmitting and receiving path of the ring type network. On the other hand, a part (b) of FIG. 2 illustrates the data of node devices and the corresponding transmitting and receiving lines and the labels (transmitting labels and receiving labels) attached to the transmitting and receiving packet data.

Further, FIG. 3 illustrates a backup path set when a failure occurs between the node device N1 and the node device N2 in the currently used path illustrated in FIG. 1. More specifically, a part (a) of FIG. 3 illustrates the route of the backup path. On the other hand, a part (b) of FIG. 3 illustrates the node devices and the corresponding transmitting lines, the receiving lines, the transmitting labels, and receiving labels that have been set (established) in the node devices. Further, FIG. 4 illustrates a protection operation in a case where a failure occurs between the node device N1 and the node device N2 while a main signal (i.e., packet data) is transmitted and received in East (clockwise) direction of the currently used path of FIG. 2. On the other hand, FIG. 5 illustrates the protection operation in a case where a failure occurs between the node device N1 and the node device N2 while the main signal (i.e., packet data) is transmitted and received in West direction of the currently used path of FIG. 2. More specifically, parts (a) of FIGS. 4 and 5 illustrate the respective backup (detour) paths in the networks. On the other hand, parts (b) of FIGS. 4 and 5 illustrate the respective switching contents of the lines and the labels.

Further, FIG. 3 illustrates an example where the transmitting labels and receiving labels of C2 through C6 and D1 and D3 through D6 of the backup path are established. In a protection technique in the MPLS-TP in the related art, the labels for the backup path are separately established for each of the positions where a failure occurs in the same currently used path. For example, when a failure occurs between the node device N2 and the node device N3, labels E1, E2, . . . and F1, F2, . . . may be established, and when a failure occurs between the node device N3 and the node device N4, labels G1, G2, . . . and H1, H2, . . . may be established.

A communication path of the main signal (packet data) in the East of the currently used path is expressed as CA-1→N1-6 [symbol] N1-1(A1)→N2-4(A1) [symbol] [symbol] N2-1(A2)→N3-4(A2) [symbol] N3-1(A3)→N4-4(A3) [symbol] N4-5→CZ-2. In this case, when a failure occurs between the node device N1 and the node device N2, as illustrated in FIG. 4, the main signal is transmitted (rescued) via the following backup path by the protection operation. Namely, the backup path (i.e., the communication path after switching is conducted) is expressed as CA-1→N1-6 [symbol] N1-3(D1)→N6-2 (D1) [symbol] N6-3 (D6)→N5-2 (D6) [symbol] N5-3(D5)→N4-2(D5) [symbol] N4-3(D4)→N3-2(D4) [symbol] N3-3(D3)→N2-2(D3) [symbol] N2-1(A2)→N3-4(A2) [symbol] N3-1(A3)→N4-4(A3) [symbol] N4-5→CZ-2. Namely, the path of the main signal is switched at the node device N1 which is one end of the path where the failure occurs between the node devices (a failure end). Further, the main signal is returned at the node device N2 which is the other failure end.

Further, the communication path of the main signal in West (counterclockwise) direction of the currently used path in FIG. 2 is expressed as CZ-1→N4-6 [symbol] N4-3(B4)→N3-2(B4) [symbol] N3-3(B3)→N2-2(B3) [symbol] N2-3(B2)→N1-2(B2) [symbol] N1-5→CA-2. In this case, when a failure occurs between the node device N1 and the node device N2, as illustrated in FIG. 5, the main signal is transmitted (rescued) via the following backup path by the protection operation. Namely, the backup path (i.e., the communication path after switching is performed) is expressed as CZ-1→N4-6 [symbol] N4-3(B4)→N3-2(B4) [symbol] N3-3(B3)→N2-2(B3) [symbol] N2-1(C2)→N3-4(C2) [symbol] N3-1(C3)→N4-4(C3) [symbol] N4-1(C4)→N5-4(C4) [symbol] N5-1(C5)→N6-4(C5) [symbol] N6-1(C6)→N1-4 (C6) [symbol] N1-5→CA-2. Namely, the main signal is returned at the node device N2 which is the failure end. Further, the path of the main signal is switched at the node device N1 which is the other failure end.

Besides the method illustrated with reference to FIGS. 3 through 5, there is another known technique (method) in which labels used in a case of failure are preliminarily established for each of the links in the directions among the adjacent nodes, and in conjunction with a failure report message sequentially transmitted among the nodes in the same direction of the ring upon an occurrence of a failure, a backup path is established by connecting the links defined by the labels used in a case of failure. In this method, the labels are replaced (renamed) at the failure end and the signal is stacked and returned in the failure end.

For related art, reference may be made to Japanese Laid-open Patent Publication No. 2010-11130.

### SUMMARY

According to an aspect of an embodiment, a path setting method for setting a backup path corresponding to a bi-directional currently used path in a ring type network including a plurality of transmission devices connected in a ring shape and using a label switching method includes setting, by each of the transmission devices, an unused first label as a transmitting label of the backup path corresponding to the bi-directional currently used path in a first direction of the ring type network; reporting, by each of the transmission devices, the first label to a adjoining transmission device in the first direction; setting, by the adjoining transmission device, the first label as a receiving label of the backup path in the first direction; setting, by each of the transmission devices, an unused second label as the transmitting label of the backup path in a second direction opposite to the first direction; reporting, by each of the transmission devices, the second label to a adjoining transmission device in the second direction; and setting, by the adjoining transmission device, the second label as the receiving label of the backup path in the second direction, in which the backup path is set when the currently used path is set between two of the transmission devices.

According to another aspect of an embodiment, a transmission device in a ring type network including plural of the transmission devices connected in a ring shape and using a label switching method includes a first storage that stores path management information including receiving lines, receiving labels, transmitting lines, and transmitting labels as setting information of a backup path corresponding to a currently used path; a second storage that stores label management information including unused label information; a third storage that stores ring management information including the transmitting line and the receiving line between the transmission devices adjoining each other in the ring type network; a message communication circuit that transmits and receives a message with another transmission device in the ring type network; and a controller that acquires an unused transmitting label from the label management information as the transmitting label of the backup path corresponding to a specific currently used path, and sets the unused transmitting label in the path management information, in which the message communication circuit is configured to transmit a message including the unused transmitting label to an adjoining transmission device.

The object and advantages of the disclosure will be realized and attained by means of the elements and combinations particularly pointed out in the claims.

It is to be understood that both the foregoing general description and the following detailed description are exemplary and explanatory and are not restrictive of the invention as claimed.

### BRIEF DESCRIPTION OF DRAWINGS

FIG. 1 illustrates an example ring type network in the related art;

FIG. 2 illustrates an example currently used path established in the ring type network of FIG. 1;

FIG. 3 illustrates an example backup path established when a failure occurs in the currently used path of FIG. 2;

FIG. 4 illustrates an example protection operation executed when a failure occurs during the transmission and reception of a main signal in one direction of the currently used path of FIG. 2;

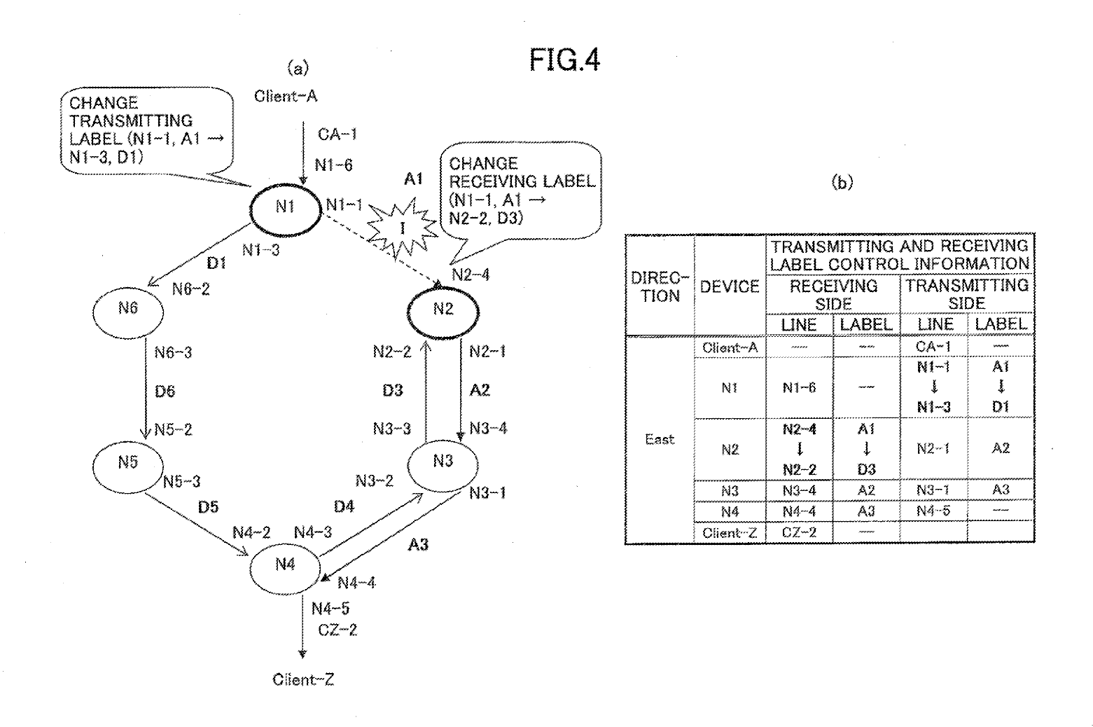

FIG. 5 illustrates an example protection operation executed when a failure occurs during the transmission and reception of a main signal in the other direction of the currently used path of FIG. 2;

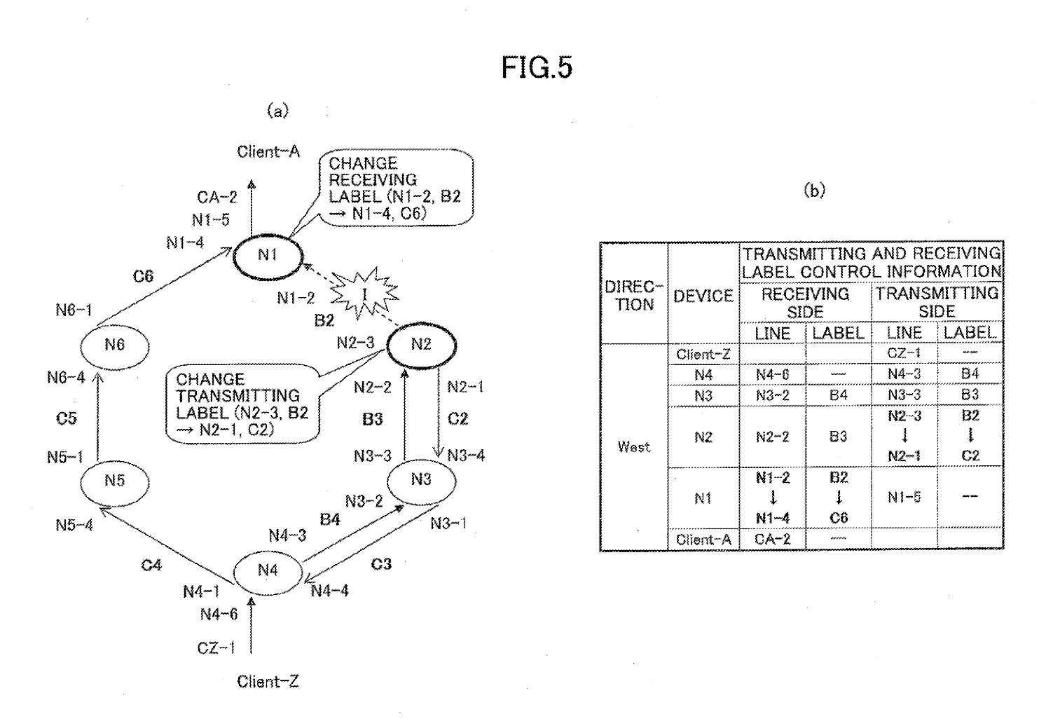

FIG. 6 illustrates an example currently used path established in the ring type network according to an embodiment;

FIG. 7 illustrates a bi-directional backup path established in the ring type network in response to the currently used path of FIG. 6 according to an embodiment;

FIG. 8 illustrates a list of the currently used path of FIG. 6 and the backup path of FIG. 7;

FIG. 9 is a block diagram of an example configuration of the node device according to an embodiment;

FIG. 10 illustrates an example format of LSP management information;

FIG. 11 illustrates example contents of transmitting and receiving label control information;

FIG. 12 illustrates an example LSP management information link in the LSP management information;

FIG. 13 is example sequence diagram of adding and deleting the currently used path in the ring type network according to an embodiment;

FIG. 14 illustrates an example format of a currently used path control request message;

FIG. 15 illustrates an example format of a currently used path control response message;

FIG. 16 illustrates an example of the LSP management information generated in an ADD node device according to an embodiment;

FIG. 17 illustrates an example of the LSP management information generated in a relay node device according to an embodiment;

FIG. 18 illustrates an example of the LSP management information generated in a DROP node device according to an embodiment;

FIG. 19 illustrates an example format of a backup path management information control request message;

FIG. 20 illustrates an example format of a backup path management information control response message;

FIG. 21 illustrates an example of the LSP management information generated in a non-relay node device according to an embodiment;

FIG. 22 is an example of a schematic sequence diagram of the entire process of adding and deleting the backup path in the ring type network according to an embodiment;

FIG. 23 illustrates an example format of a backup path control request message;

FIG. 24 illustrates an example format of a backup path control message;

FIG. 25 illustrates an example format of a backup path control response message;

FIG. 26 is an example flowchart of the entire process of adding and deleting the backup path according to an embodiment;

FIG. 27 is an example flowchart of the entire backup path control process according to an embodiment;

FIG. 28 is an example flowchart of the entire process of adding a backup path ring according to an embodiment;

FIG. 29 is an example flowchart of the entire process of adding the backup path ring according to an embodiment;

FIG. 30 illustrates an example of the LSP management information set in the node device according to an embodiment;

FIG. 31 is an example flowchart of a backup path control message generation process in the node device according to an embodiment;

FIG. 32 is an example flowchart of an error process in the node device according to an embodiment;

FIG. 33 is an example flowchart of a backup path ring addition process according to an embodiment;

FIG. 34 is an example LSP management information set in the node device according to an embodiment;

FIG. 35 is another example flowchart of a backup path ring addition process according to an embodiment;

FIG. 36 is another example LSP management information set in the node device according to an embodiment;

FIG. 37 is still another example LSP management information set in the node device according to an embodiment;

FIG. 38 is another example flowchart of a backup path control message generation process in the node device according to an embodiment;

FIG. 39 is another example flowchart of an error process in the node device according to an embodiment;

FIG. 40A is still another example flowchart of a backup path ring addition process according to an embodiment;

FIG. 40B is still another example flowchart of a backup path ring addition process according to an embodiment;

FIG. 41 is another example LSP management information set in the node device according to an embodiment;

FIG. 42 is an example flowchart of the entire process of deleting the backup path ring according to an embodiment;

FIG. 43 is an example flowchart of a backup path ring deletion process according to an embodiment;

FIG. 44 is another example flowchart of a backup path ring deletion process according to an embodiment;

FIG. 45 is still another example flowchart of a backup path ring deletion process according to an embodiment;

FIG. 46A is a sequence diagram illustrating example contents of messages sequentially transmitted in the ring type network when the backup path is added according to an embodiment;

FIG. 46B is another sequence diagram illustrating example contents of messages sequentially transmitted in the ring type network when the backup path is added according to an embodiment;

FIG. 47A is still another sequence diagram illustrating example contents of messages sequentially transmitted in the ring type network when the backup path is added according to an embodiment;

FIG. 47B is still another sequence diagram illustrating example contents of messages sequentially transmitted in the ring type network when the backup path is added according to an embodiment;

FIG. 48A is a sequence diagram illustrating example contents of messages sequentially transmitted in the ring type network when the backup path is deleted according to an embodiment;

FIG. 48B is another sequence diagram illustrating example contents of messages sequentially transmitted in the ring type network when the backup path is deleted according to an embodiment;

FIG. 49A is still another sequence diagram illustrating example contents of messages sequentially transmitted in the ring type network when the backup path is deleted according to an embodiment;

FIG. 49B is still another sequence diagram illustrating example contents of messages sequentially transmitted in the ring type network when the backup path is deleted according to an embodiment;

FIG. 50 illustrates an example protection operation when a single failure occurs in the ring type network according to an embodiment;

FIG. 51 illustrates another example protection operation when a single failure occurs in the ring type network according to an embodiment;

FIG. 52A illustrates an example protection operation when multiple failures occur in the ring type network according to an embodiment;

FIG. 52B illustrates another example protection operation when multiple failures occur in the ring type network according to an embodiment;

FIG. 53 is an example flowchart of a switch control process when a failure occurs and the failure is removed according to an embodiment;

FIG. 54A is an example flowchart of a switch setting process of FIG. 53;

FIG. 54B is an example flowchart of a process of a node device on a receiving side of an LSP switch setting process;

FIG. 54C is an example flowchart of a process of the node device on a transmitting side of the LSP switch setting process;

FIG. 55A is an example flowchart of a switch release process of FIG. 53;

FIG. 55B is an example flowchart of a process of the node device on a receiving side of the LSP switch release process;

FIG. 55C is an example flowchart of a process of the node device on a transmitting side of the LSP switch release process;

FIG. 56 illustrates an example loop back operation when a failure occurs while an MIP is set to a specific node device of the ring type network according to an embodiment; and

FIG. 57 illustrates another example loop back operation when a failure occurs while an MIP is set to a specific node device of the ring type network according to an embodiment.

### DESCRIPTION OF EMBODIMENT

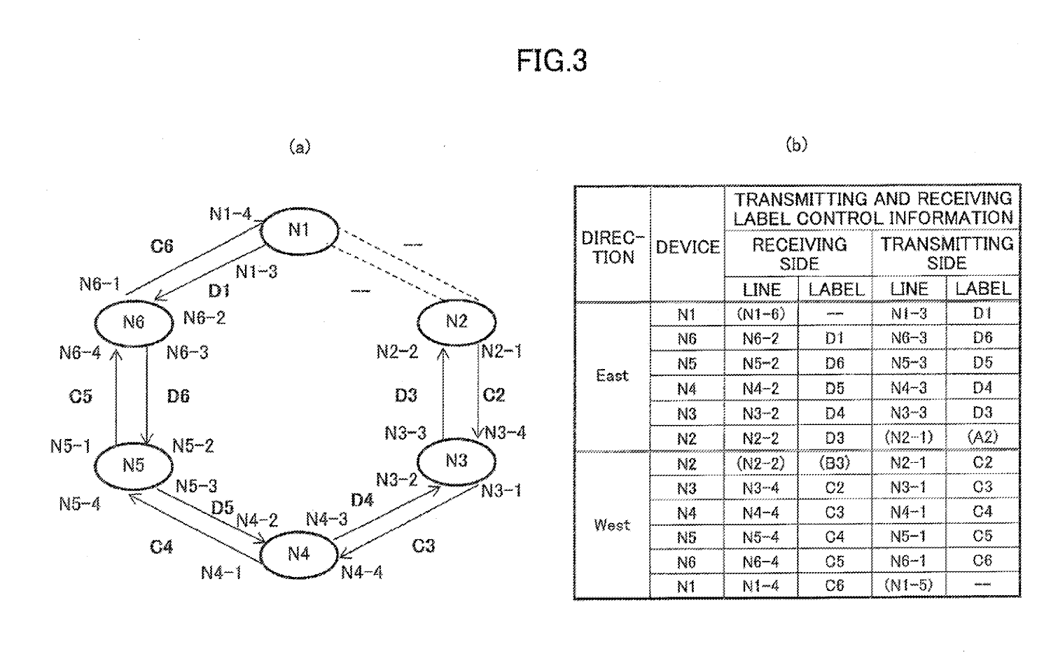

In the protection operation in the related art in the MPLS-TP based ring type network, the management and control procedures may become complicated when the OAM (Operation and Maintenance) function is performed during the protection operation. Namely, it may be necessary to establish the backup path as illustrated in FIG. 3 for each of the positions where a failure may occur for a single (the same) currently used path. Because of this feature, even in the OAM function to the same node device, it may become necessary to change the setting of the MIP (ME Intermediate Point) depending on the positions where a failure may occur. This is because it is not possible to preliminarily determine the path of the OAM packet data because the packet communication path may vary depending on the positions where a failure occurs. Therefore, in the protection operation in the related art where the labels are replaced (renamed) at the failure end and the signal is stacked and returned in the failure end, the labels in the OAM packet data may be stacked. Therefore, the management and control procedures in the relay nodes may become complicated, and the performance (e.g., the processing speed) may be reduced.

In the following, a node device which is an example of a transmission device according to an embodiment, and a ring type network including the node device will be described in the following order.

### 1. Ring Type Network

### 2. Configuration of Node Device

### 3. Sequences of Adding and Deleting Currently Used Path

### 4. Sequences of Adding and Deleting Backup Path

4.1 Adding and Deleting Process of Backup Path (Process Per Each Node Device)
   (A) Process Outline
   (B) Backup Path Ring Adding process
      (B-1) Backup Path Ring Adding process (ADD Node)
      (B-2) Backup Path Ring Adding process (Sequence End Point Node)
      (B-3) Backup Path Ring Adding process (THR/Drop Nodes)
      (B-4) Backup Path Ring Adding process (Non THR Node)
   (C) Backup Path Ring Deleting process
      (C-1) Backup Path Ring Deleting process (ADD Node)
      (C-2) Backup Path Ring Deleting process (Sequence End Point Node)
      (C-3) Backup Path Ring Deleting process (THR/DROP/Non THR Node)
4.2 Example of Transmitting and Receiving Messages between Node Devices
   5. Protection Operation during Failure

### 6. Loop Back Operation of OAM

### 1. Ring Type Network

In the following, methods will be described of realizing (achieving) a failure backup (relief) function when a failure occurs and a maintenance function in a network in which plural node devices are connected in a ring (hereinafter referred to as a “ring type network”). Further, in the following descriptions, a node device may be simplified as a “node”. In this embodiment, there are provided node devices of the ring type network and a monitor control device in communication with each of the node devices.

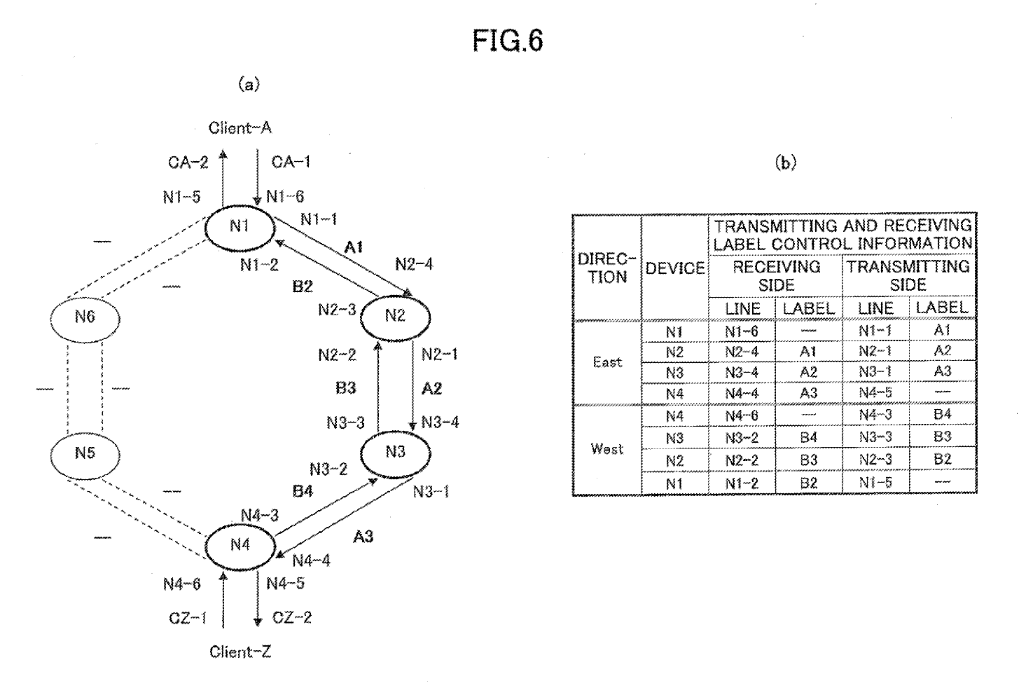

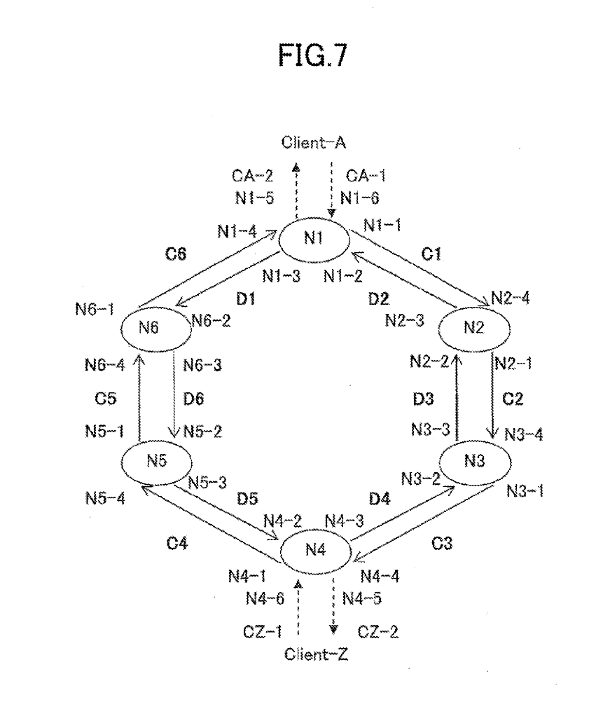

In the ring type network in this embodiment, when a currently used path is established by an LSP (Label Switch Path) which is a forwarding path of packet data, a ring shaped (bi-directional) backup path is also preliminarily established bidirectionally (in both directions) for each of the currently used paths. FIGS. 6 and 7 illustrate a currently used path and the corresponding ring shaped backup paths established in response to the currently used path. FIG. 6 illustrates an example of the currently used path established in the ring type network. A part (a) of FIG. 6 illustrates transmitting and receiving path of the ring type network. A part (b) of FIG. 6 illustrates transmitting and receiving lines and the labels attached to transmitting and receiving packet data (transmitting labels and receiving labels). In the example of FIG. 6, the ring type network includes six node devices N1 through N6. The receiving lines and the transmitting lines denote the slots, the port numbers, the line numbers or the like of the corresponding node devices. Namely, the symbol “Nx-y(x,y: integers)” denotes the receiving line or the transmitting line of the node device Nx. FIG. 6 illustrates a case where a packet transmitting and receiving path between a client A and a client Z is established. Herein, the packet transmitting and receiving path corresponds to the currently used path established in the East and West directions between the node devices N1 and N4 in the ring type network.

Herein, one of the East direction and the West direction corresponds to an example of a first direction of the ring type network, and the other of the East direction and the West direction corresponds to an example of a second direction of the ring type network.

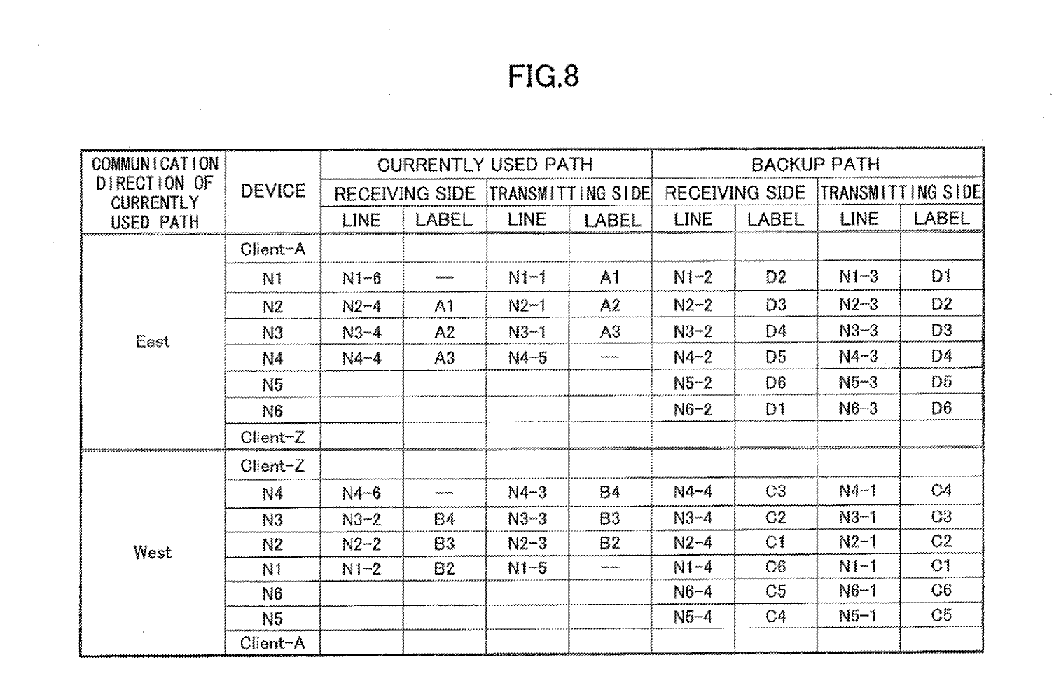

In the ring type network in this embodiment, when the currently used path as exemplarily illustrated in FIG. 6 is established, a ring shaped backup path is also (preliminarily) established bidirectionally. FIG. 7 illustrates the bidirectional backup path established in the ring type network in response to the currently used path of FIG. 6. FIG. 8 illustrates the transmitting and receiving lines of the node devices and the labels to be attached to the transmitting and receiving packet data in the backup path (i.e., transmitting labels and receiving labels). The currently used path of FIG. 8 is similar to the currently used path of the part (b) of FIG. 6. However, in the backup path of FIG. 8, new labels C1 through C6 and D1 through D6 are provided (established) for respective transmitting and receiving lines.

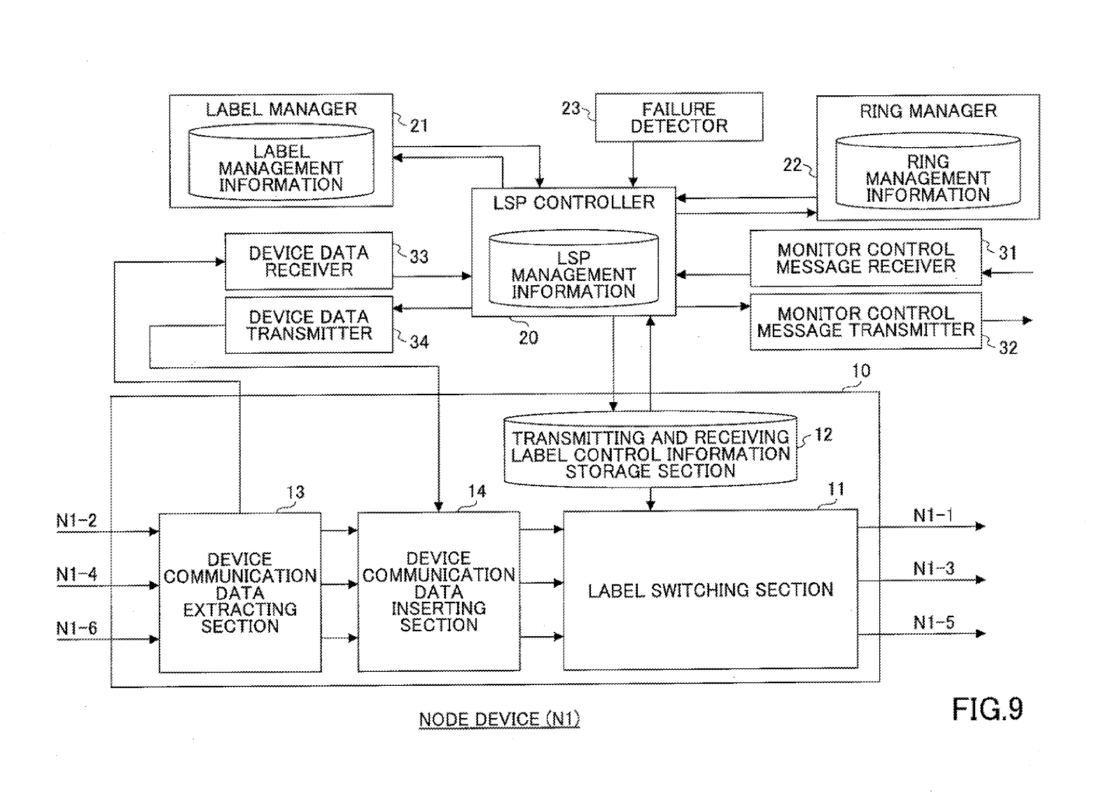

In the following, an example configuration of the node devices and an example process performed in the ring type network to establish the ring shaped backup path bidirectionally for each of the currently used paths will be described. First, an example configuration of the node device will be described with reference to FIG. 9.

### 2. Configuration of Node Device

FIG. 9 is a block diagram illustrating an example configuration of the node device N1 of the ring type network of FIG. 6. However, the configuration of FIG. 9 may also be applied to any other node devices.

As illustrated in FIG. 9, the node device in this embodiment includes a Network Processor 10, an LSP controller 20, a label manager 21, a ring manager 22, a failure detector 23, a monitor control message receiver 31, a monitor control message transmitter 32, a device data receiver 33, and a device data transmitter 34. Herein, the functions of the LSP controller 20, the label manager 21, and the ring manager 22 may be executed by a program and a hardware using a general-purpose processor and a memory. Further, the monitor control message receiver 31 and the monitor control message transmitter 32 may be configured as a hardware circuit, and may be collectively referred to as a message communication circuit. Further, the device data receiver 33 and the device data transmitter 34 may be configured as a hardware circuit, and may be collectively referred to as device data communication circuit.

The Network Processor 10 performs processes on a main signal (i.e., packet data). For example, the Network Processor 10 of the node device N1 includes input lines N1-2, N1-4, and N1-6 to input the main signal (hereinafter may be simplified as a “signal”) and output lines N1-1, N1-3, and N1-5 to output the signal. The Network Processor 10 switches the signal between the input lines and the output lines. Further, in a failure backup (relief) mode (i.e., when backup (relief) is necessary due to a failure), the Network Processor 10 returns (sends back) the signal in the ring type network.

Further, the Network Processor 10 has a Label Switching function, a Label Header Updating function, a Label Header Reference function, a function to discard the packet data having a designated (specified) label and the like.

Further, as illustrated in FIG. 9, the Network Processor 10 includes a label switching section 11, a transmitting and receiving label control information storage section 12, a device communication data extracting section 13, and a device communication data inserting section 14.

The transmitting and receiving label control information storage section 12 stores transmitting and receiving label control information which is control information to perform label switching control and Loopback (LPBK) control. The transmitting and receiving label control information storage section 12 corresponds to an example of a second storage.

The label switching section 11 operates based on the transmitting and receiving label control information stored in the transmitting and receiving label control information storage section 12, and performs the label switching control and the Loopback control.

The device communication data extracting section 13 extracts receiving data for communications between devices from the signal input via the input line, and outputs the receiving data to the device data receiver 33. The device communication data inserting section 14 inserts transmitting data for communications between devices into a signal to be output to (via) the output line, the transmitting data having been received from the device data transmitter 34. In this embodiment, communication data between devices (hereinafter may be referred to as “device communication data”) may be a backup path control message described below. The device data receiver 33 and the device data transmitter 34 are an example of a message communication circuit.

The LSP controller 20 stores LSP management information, and has a label management function used in LSP control and the LSP. The LSP management information is used to manage the currently used paths for each of LSP settings, the transmitting and receiving labels used in the backup paths, and various information items. The LSP controller 20 is an example of a controller and a first storage. The LSP management information corresponds to an example of path management information.

The LSP management information is managed for each of the paths of the packet data in the ring type network. Herein, the LSP management information includes plural information items. Therefore, herein, the term “LSP management information” may be used as a term representing those information items. Each LSP management information item is set (stored) in a certain address region of a memory. In the following descriptions, for example, plural sets of LSP management information set in the node device N1 may be denoted as N1-#1, N1-#2, . . . , N1-#n. The format of the LSP management information will be described below.

The label manager 21 stores label management information, manages the labels used in the node device, and searches for the labels. The label management information is a table to manage the usage status of the transmitting labels (i.e., the state whether each of the transmitting labels are currently used or not) to be used in the currently used path and the backup path for each of the lines.

The ring manager 22 stores ring management information of the ring type network including the node devices, and manages the configuration of the ring type network. To manage the configuration of the ring type network, the ring management information manages information items including directions, adjoining node devices, currently used receiving line numbers, currently used transmitting line numbers, backup receiving line numbers, and backup transmitting line numbers, so that one of the node devices may manage each of the adjoining node devices. The ring manager 22 corresponds to an example of a third storage.

The monitor control message receiver 31 receives a message from the monitor control device and the like. The monitor control message transmitter 32 transmits a message to the monitor control device and the like. In this embodiment, the monitor control message receiver 31 may receive a currently used path control request message, a backup path control request message and the like from the monitor control device. The currently used path control request message and the backup path control request message will be described below. Further, in this embodiment, the monitor control message transmitter 32 may transmit a currently used path control response message, a backup path control response message and the like to the monitor control device. The currently used path control response message and the backup path control response message will be described below.

The failure detector 23 detects a failure in the line by, for example, determining that a scheduled signal is not received. Then, the failure detector 23 reports the failure to the LSP controller 20.

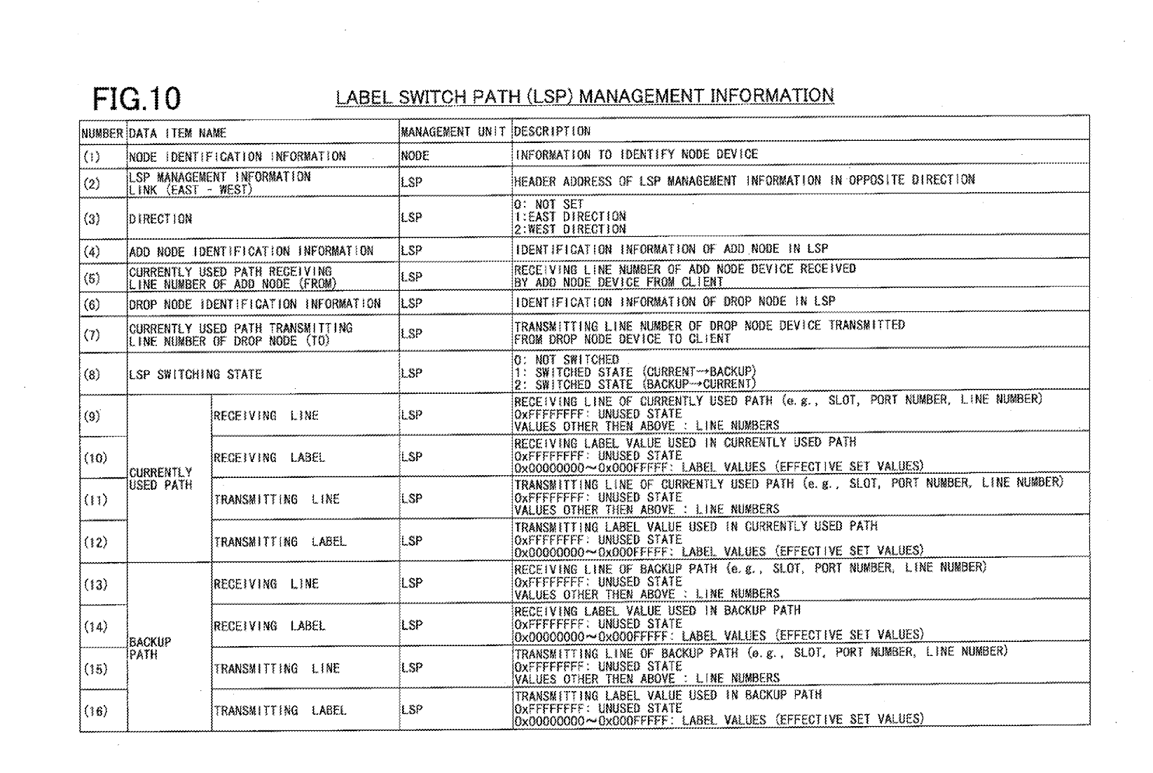

Next, the contents of the LSP management information managed by the LSP controller 20 of the node device will be described. In the ring type network in this embodiment, as described above, when the currently used path is established, the ring shaped backup path is also (preliminarily) established bidirectionally. In this case, in the node device, when the currently used path and the backup path are established, the LSP management information is updated. The LSP management information is prepared for each of the established currently used paths. Further, in the same path in which data are transmitted and received in the same node device, both directions of the path are mutually linked to each other so that LSP management information having the different directions may mutually refer to each other. FIG. 10 illustrates an example format (i.e., data contents) of the LSP management information. As illustrated in FIG. 10, the LSP management information includes the following data items. The following numbers (1) through (16) representing the corresponding contents of the data items of the LSP management information may be referred to in the descriptions below.

### LSP Management Information

### (1) Node Identification Information

### (2) LSP Management Information Link

### (3) Direction

### (4) ADD Node Identification Information

### (5) Currently Used Path Receiving Line Number of ADD Node

### (6) DROP Node Identification Information

### (7) Currently Used Path Transmitting Line Number of DROP Node

### (8) LSP Switching State

### (9) Receiving Line of Currently Used Path

### (10) Receiving Label of Currently Used Path

### (11) Transmitting Line of Currently Used Path

### (12) Transmitting Label of Currently Used Path

### (13) Receiving Line of Backup Path

### (14) Receiving Label of Backup Path

### (15) Transmitting Line of Backup Path

### (16) Transmitting Label of Backup Path

The “(1) Node Identification Information” is the information to be used to identify the node device, and may be, for example, a MAC address. In this case, when a single node device manages plural sets of the LSP Management Information, each of the sets of the LSP Management Information has the same “(1) Node Identification Information”. The “(2) LSP Management Information Link” may be any data as long as the data may be used to associate one of a pair of the LSP Management Information with the other of the pair of the LSP Management Information in the same node device, the pair of the LSP management information having different directions from each other in the path in which data are transmitted and received. To that end, in this embodiment, as the “(2) LSP Management Information Link” of the LSP management information corresponding to one direction of the currently used path from among the currently used paths in which data are transmitted and received in the same node device, the header address of the LSP management information having the other direction is stored (used). However, this is an example only, and any other appropriate data may be alternatively used. The “(3) Direction” is the data indicating the direction of the established currently used path.

The “(4) ADD Node Identification Information” is the information to be used to identify the ADD node device (i.e., transmitting node device), and may be, for example, the MAC address. The “(5) Currently Used Path Receiving Line Number of ADD Node” is the currently used path receiving line number of the ADD node device. The “(6) DROP Node Identification Information” is the information to be used to identify the DROP node device (i.e., receiving node device), and may be, for example, the MAC address. The “(7) Currently Used Path Transmitting Line Number of DROP Node” is the currently used path transmitting line number of the DROP node device. The numbers (9) through (12) denote the receiving line, the receiving label, the transmitting line, and the transmitting label, respectively, of the currently used path in the node device. For example, the receiving line and the transmitting line may be the slot, the port number, the line number or the like of the node device. The numbers (13) through (16) denote the receiving line, the receiving label, the transmitting line, and the transmitting label, respectively, of the backup path in the node device. For example, the receiving line and the transmitting line may be the slot, the port number, the line number or the like of the node device. In the example of FIG. 10, as the line data and the label data indicating the unused state, data “0xFFFFFFFF” are used. However, it should be noted that the data value “0xFFFFFFFF” is an example only.

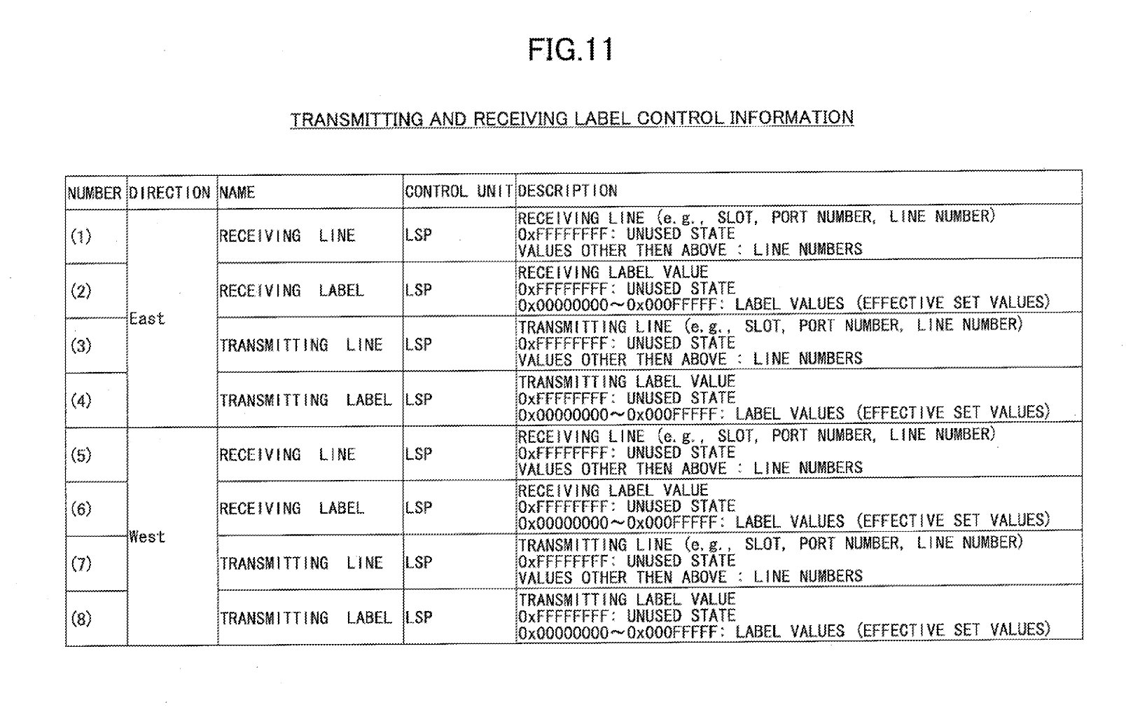

Further, FIG. 11 illustrates contents of the transmitting and receiving label control information managed by the transmitting and receiving label control information storage section 12 of the node device. As illustrated in FIG. 11, the transmitting and receiving label control information includes the data of the receiving line, the receiving label, the transmitting line, the transmitting label in East direction and the receiving line, the receiving label, the transmitting line, the transmitting label in West direction. The data of the lines and labels in the transmitting and receiving label control information is set by the LSP controller 20 in accordance with the path of the signal to be communicated. The label switching section 11 performs a label switching process and a loop back process by referring to the transmitting and receiving label control information. In the example of FIG. 11, the data “0xFFFFFFFF” are used as the line data and the label data indicating the unused state. Further, the data “0x00000000” to “0x000FFFFF” are used as the data of the line numbers and the labels (label values). However, it should be noted that those data are examples only.

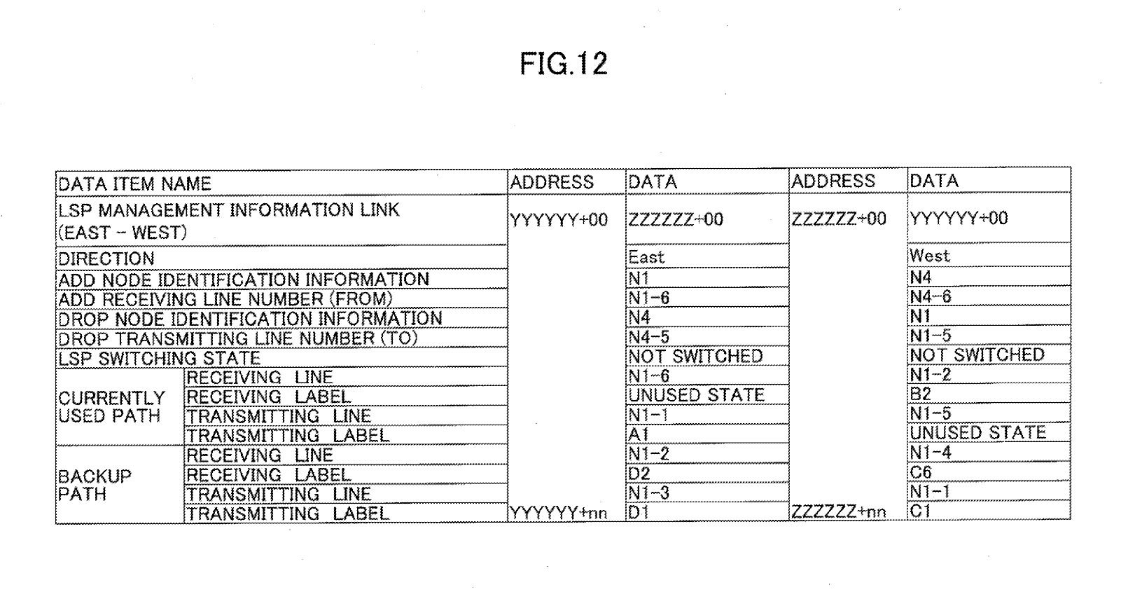

FIG. 12 illustrates an example of the “(2) LSP Management Information Link” of the LSP management information. As described above, the “(2) LSP Management Information Link” is the data to be used to associate one of the pair of the LSP Management Information with the other of the pair of the LSP Management Information in the same node device, the pair of the LSP management information having the different directions from each other in the path in which data are transmitted and received. In the example of FIG. 12, the data of the “(2) LSP Management Information Link” of one of the pair of the LSP management information indicates the header address of the other of the pair of the LSP management information, and vice versa. FIG. 12 illustrates a case of the node device N1. In this example, the header address of one of the pair of the LSP management information is “YYYYYY+00”, and the header address of the other of the pair of the LSP management information is “ZZZZZZ+00”. In this case, the data value of one “(2) LSP Management Information Link” is “ZZZZZZ+00” which is the header address of the other of the pair of the LSP management information, and the data of the other “(2) LSP Management Information Link” is “YYYYYY+00” which is the header address of the one of the pair of the LSP management information.

The pair of the LSP management information illustrated in FIG. 12 corresponds to an example of first path management information and second path management information.

### 3. Sequences of Adding and Deleting Currently Used Path

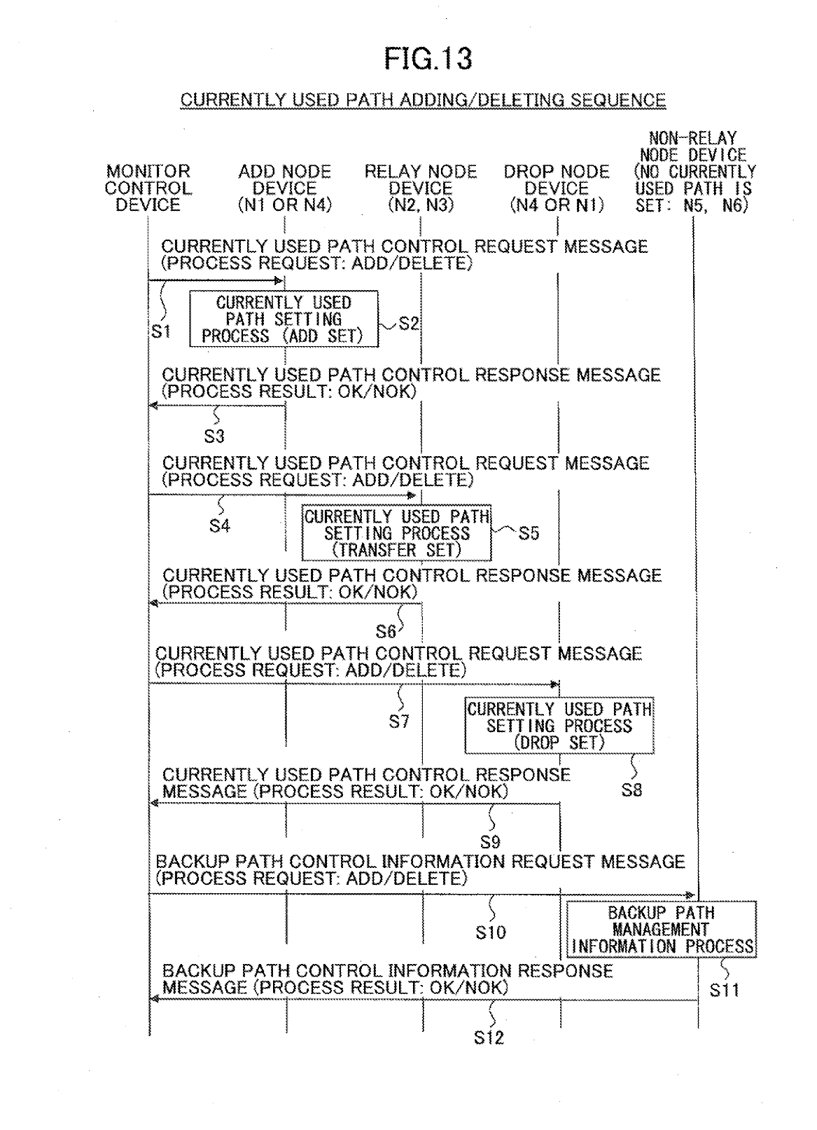

Next, sequences of adding and deleting the currently used path in the ring type network according to this embodiment will be described with reference to the sequence diagram of FIG. 13. In the following description, processes are described in a case where the currently used path of FIG. 6 is established in the ring type network including six node devices N1 through N6 illustrated in FIG. 6.

As described above, there is provided the monitor control device separately (independently) in communication with the node devices in the ring type network in this embodiment. Accordingly, the monitor control device is able to monitor and control each of the node devices. In a case of adding and deleting the currently used path, the monitor control device transmits a currently used path control request message to each of the node devices. Based on the currently used path control request message, the LSP management information of each of the node devices is updated.

Further, hereinafter, the node device transmitting (ADD) a main signal from a client using the currently used path is referred to as the “ADD node device”. The node device receiving (DROP) the main signal to the client using the currently used path is referred to as the “DROP node device”. The node device relaying (THR) the main signal from the client using the currently used path is referred to as a “relay node device” or the “THR node device”. The node device not relaying, transmitting, and receiving using the currently used path is referred to as a “non-relay node device” or a “non THR node device”.

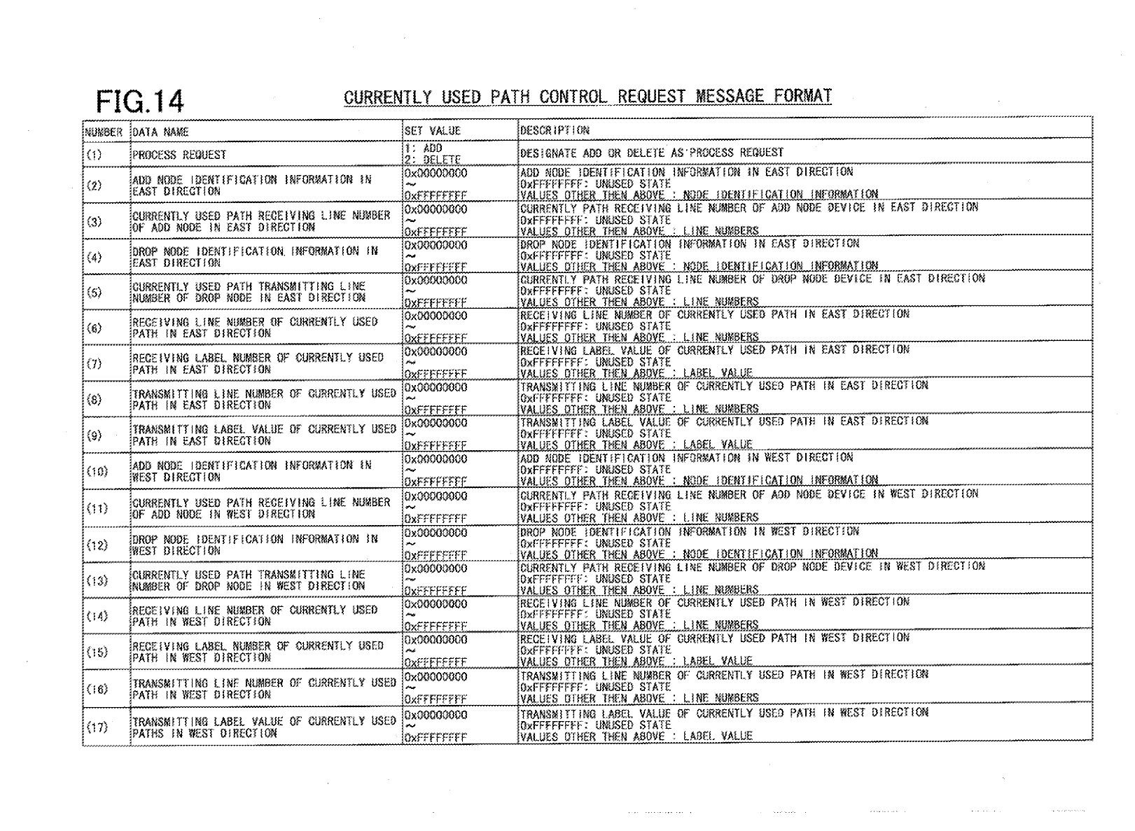

As illustrated in FIG. 13, first, the monitor control device transmits the currently used path control request message to the ADD node device (node device N1 or N4 in the example of FIG. 6) (step S1). FIG. 14 illustrates an example format of the currently used path control request message. As illustrated in FIG. 14, the format of the currently used path control request message includes seventeen data items (1) through (17) described below. Namely, as illustrated in FIG. 14, the currently used path control request message includes the following data items. The following numbers (1) through (17) representing the corresponding contents of the data items of the currently used path control request message may be referred to in the descriptions below.

### Currently Used Path Control Request Message

### (1) Process Request

(2) ADD Node Identification Information in East direction
(3) Currently Used Path Receiving Line Number of ADD Node in East direction
(4) DROP Node Identification Information in East direction
(5) Currently Used Path Transmitting Line Number of DROP Node in East direction
(6) Receiving Line Number of Currently Used Path in East direction
(7) Receiving Label Number of Currently Used Path in East direction
(8) Transmitting Line Number of Currently Used Path in East direction
(9) Transmitting Label Value (Number) of Currently Used Path in East direction
(10) ADD Node Identification Information in West direction
(11) Currently Used Path Receiving Line Number of ADD Node in West direction
(12) DROP Node Identification Information in West direction
(13) Currently Used Path Transmitting Line Number of DROP Node in West direction
(14) Receiving Line Number of Currently Used Path in West direction
(15) Receiving Label Number of Currently Used Path in West direction
(16) Transmitting Line Number of Currently Used Path in West direction
(17) Transmitting Label Value (Number) of Currently Used Path in West direction

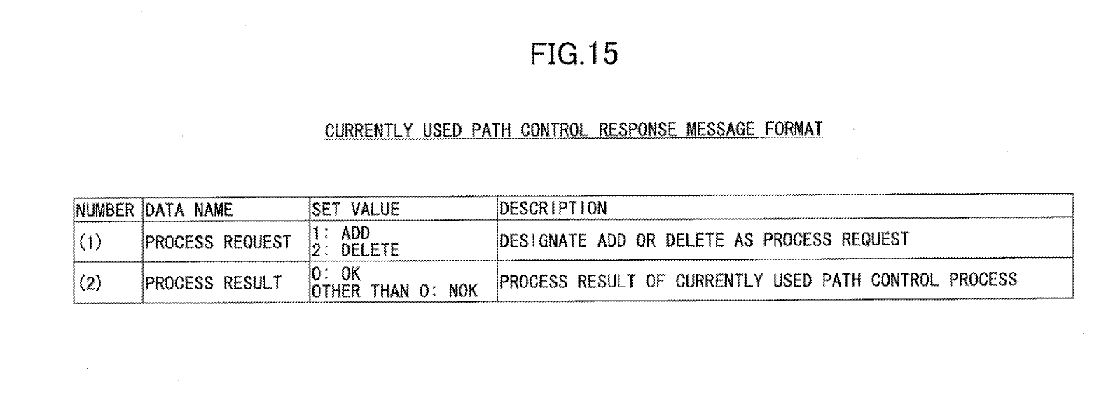

Upon receiving the currently used path control request message, the ADD node device performs a currently used path establish process (step S2). Then, the ADD node device transmits a currently used path control response message including a result of the currently used path establish process to the monitor control device (step S3). FIG. 15 illustrates an example format of the currently used path control response message.

As illustrated in FIG. 15, the currently used path control response message includes the following data items.

### Currently Used Path Control Response Message

### (1) Process Request

### (2) Process Result

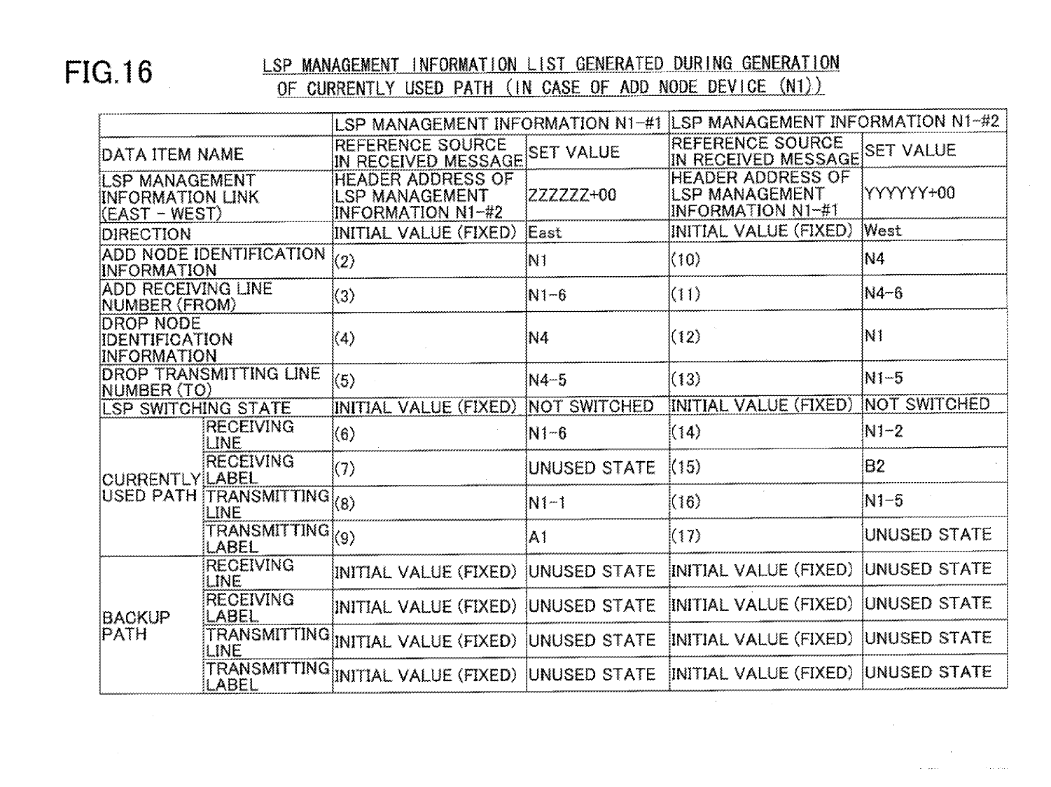

In the currently used path establish process in step S2, when the currently used path is to be added, the LSP management information to be managed by the ADD node device is newly established (generated) and data are written into the LSP management information. FIG. 16 illustrates the LSP management information generated in the ADD node device N1 illustrated in FIG. 6. FIG. 16 illustrates the setting values of the data in the pair of the LSP management information N1-#1 and N1-#2 having different directions from each other and reference sources (i.e., the numbers (2) through (17)) of the currently used path control request message to be used when the corresponding data are set. In the pair of the LSP management information N1-#1 and N1-#2, the data set in the Direction are opposite to each other (i.e., N1-#1:East, N1-#2:West). Upon the currently used path being established, switching of the LSP is not performed. Therefore, as the data of the LSP switching state, data value “No Switch (0)” is set. Further, as the data of the backup path, data of “Unused state (0xFFFFFFFF)” are set.

Referring back to FIG. 13, after the currently used path of the ADD node devices has been established, the monitor control device transmits the currently used path control request message to the relay node devices (node devices N2 and N3 in the example of FIG. 6) (step S4). Upon receiving the currently used path control request message, the relay node devices perform the currently used path establish process (step S5). Then, the relay node devices transmit the currently used path control response message including a result of the currently used path establish process to the monitor control device (step S6). In the currently used path establish process in step S5, the processes similar to those performed by the ADD node devices as described above are performed.

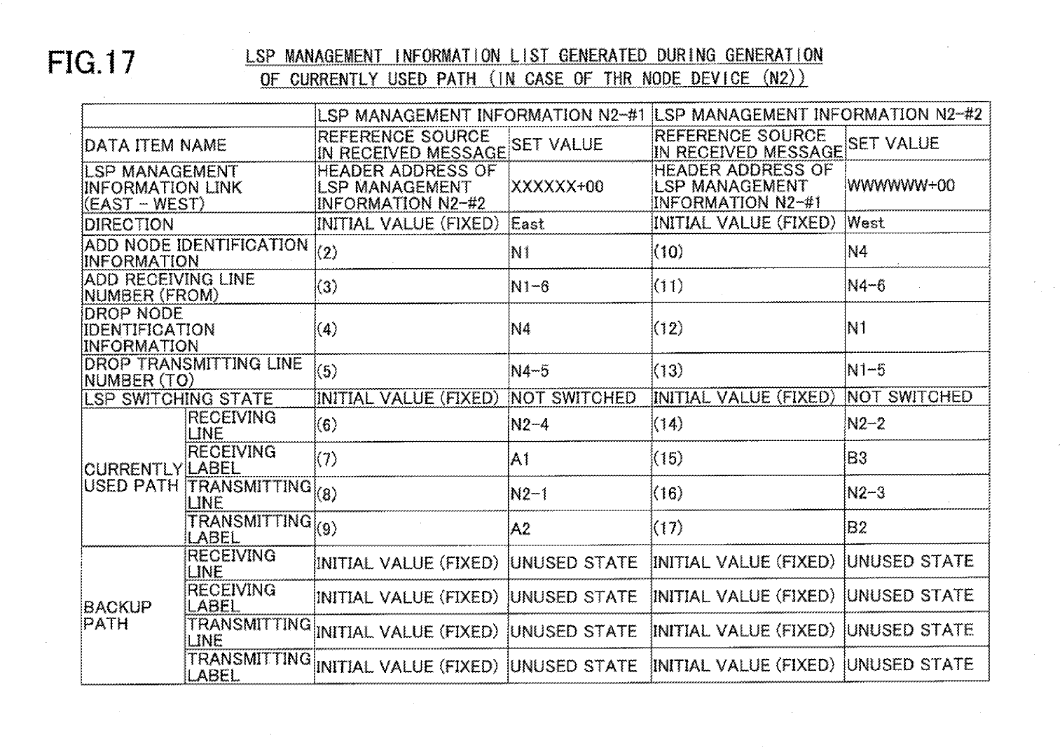

FIG. 17 illustrates the LSP management information generated in the relay node device N2 of illustrated in FIG. 6. FIG. 17 illustrates the setting values of the data in the pair of the LSP management information N2-#1 and N2-#2 having different directions from each other and reference sources (i.e., the numbers (2) through (17)) of the currently used path control request message to be used when the corresponding data are set. In the pair of the LSP management information N2-#1 and N2-#2, the data set in the Direction are opposite to each other (i.e., N2-#1:East, N2-#2:West). Upon the currently used path being established, switching of the LSP is not performed. Therefore, as the data of the LSP switching state, data value “No Switch (0)” is set. Further, as the data of the backup path, the data of “Unused state (0xFFFFFFFF)” are set.

Referring back to FIG. 13 again, after the currently used path of the relay node devices has been established, the monitor control device transmits the currently used path control request message to the DROP node device (node device N4 or N1 in the example of FIG. 6) (step S7). Upon receiving the currently used path control request message, the DROP node device performs the currently used path establish process (step S8). Then, the DROP node devices transmits the currently used path control response message including a result of the currently used path establish process to the monitor control device (step S9). In the currently used path establish process in step S8, the processes similar to those performed by the ADD node devices as described above are performed.

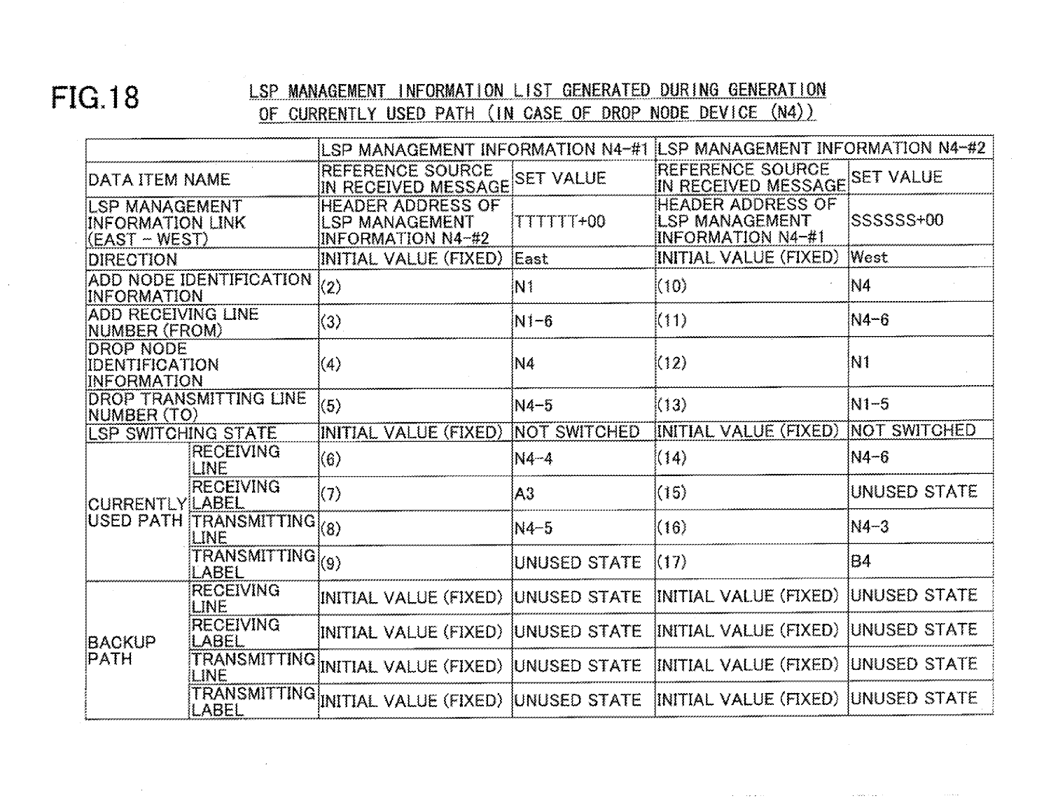

FIG. 18 illustrates the LSP management information generated in the DROP node device N4 illustrated in FIG. 6. FIG. 18 illustrates the setting values of the data in the pair of the LSP management information N4-#1 and N4-#2 having different directions from each other and reference sources (i.e., the numbers (2) through (17)) of the currently used path control request message to be used when the corresponding data are set. In the pair of the LSP management information N4-#1 and N4-#2, the data set in the Direction are opposite to each other (i.e., N4-#1:East, N4-#2:West). Upon the currently used path being established, switching of the LSP is not performed. Therefore, as the data of the LSP switching state, data value “No Switch (0)” is set. Further, as the data of the backup path, the data of “Unused state (0xFFFFFFFF)” are set.

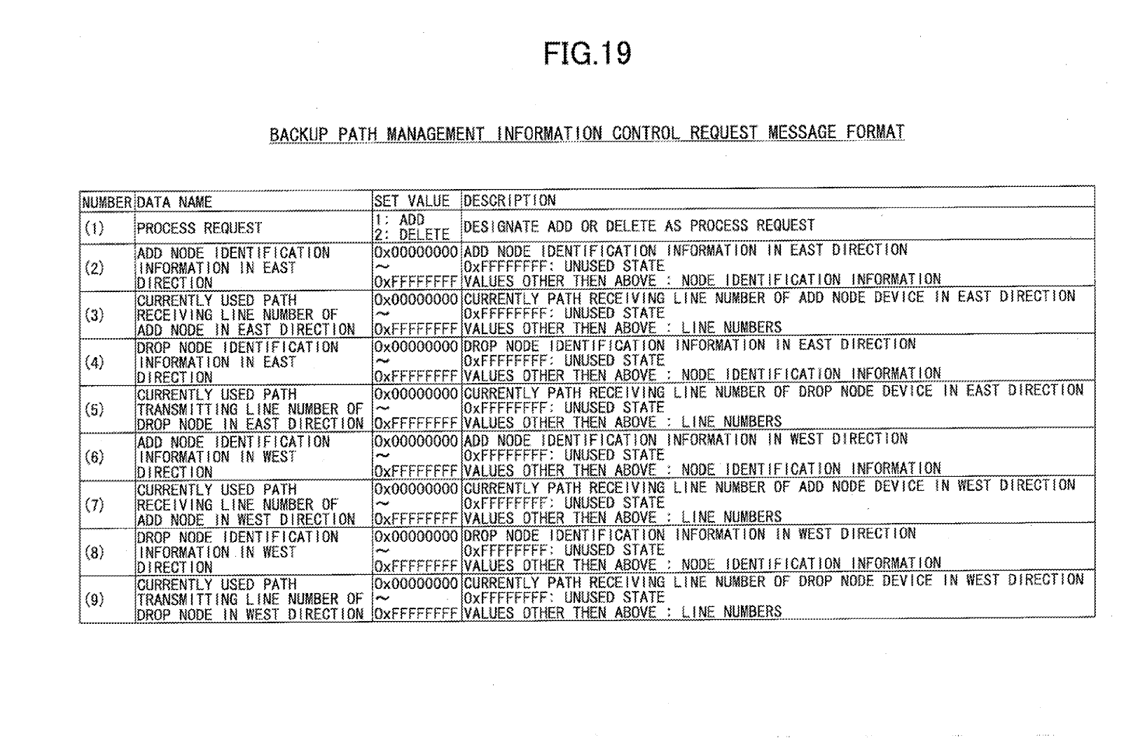

Referring back to FIG. 13 again, after the currently used path of the DROP node devices has been established, the monitor control device transmits a backup path management control request message to the non-relay node devices (node devices N5 and N6 in the example of FIG. 6) (step S10). FIG. 19 illustrates an example format of the backup path management control request message. As illustrated in FIG. 19, the backup path management control request message includes nine data items (1) through (9). The contents of the data items are illustrated in FIG. 19. Namely, as illustrated in FIG. 19, the backup path management control request message includes the following data items. The following numbers (1) through (9) representing the corresponding contents of the data items of the backup path management control request message may be referred to in the descriptions below.

### Backup Path Management Control Request Message

### (1) Process Request

(2) ADD Node Identification Information in East direction
(3) Currently Used Path Receiving Line Number of ADD Node in East direction
(4) DROP Node Identification Information in East direction
(5) Currently Used Path Transmitting Line Number of DROP Node in East direction
(6) ADD Node Identification Information in West direction
(7) Currently Used Path Receiving Line Number of ADD Node in West direction
(8) DROP Node Identification Information in West direction
(9) Currently Used Path Transmitting Line Number of DROP Node in West direction

In the non-relay node devices, no currently used path is established. Because of this feature, the backup path management control request message does not include the data items indicating the receiving line, the receiving label, the transmitting line, and the transmitting label of the currently used path. In other words, beside the data items relevant to the currently used path, the data items of the backup path management control request message are the same as those of the currently used path control request message. Namely, the data items (contents) (1) through (9) of the backup path management control request message correspond to the data items (1) through (5) and (10) through (13) of the currently used path control request message.

Upon receiving the currently used path control request message, the non-relay node devices perform a backup path control information process (step S11). Then, the non-relay node devices transmit a backup path management information control response message including a result of the backup path control information process to the monitor control device (step S12). In the backup path control information process, the data of the ADD node device and the DROP device included in the backup path management information control response message are set in the LSP management information of the non-relay node devices.

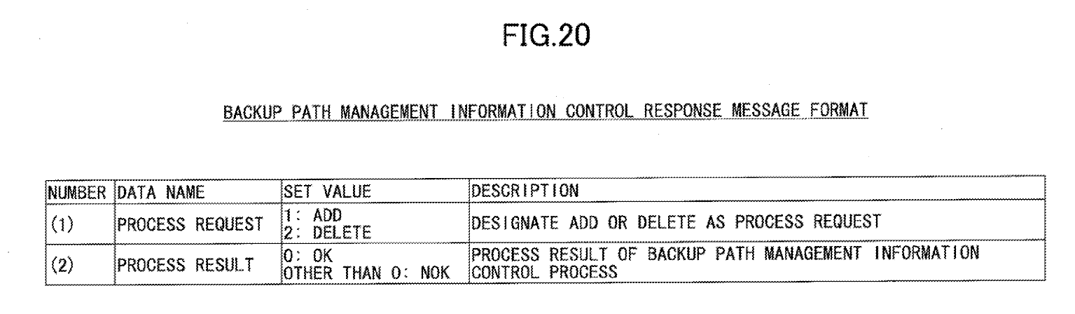

FIG. 20 illustrates an example format of the backup path management information control response message. As illustrated in FIG. 20, the backup path management information control response message includes the following data items.

### Backup Path Management Information Control Response Message

### (1) Process Request

### (2) Process Result

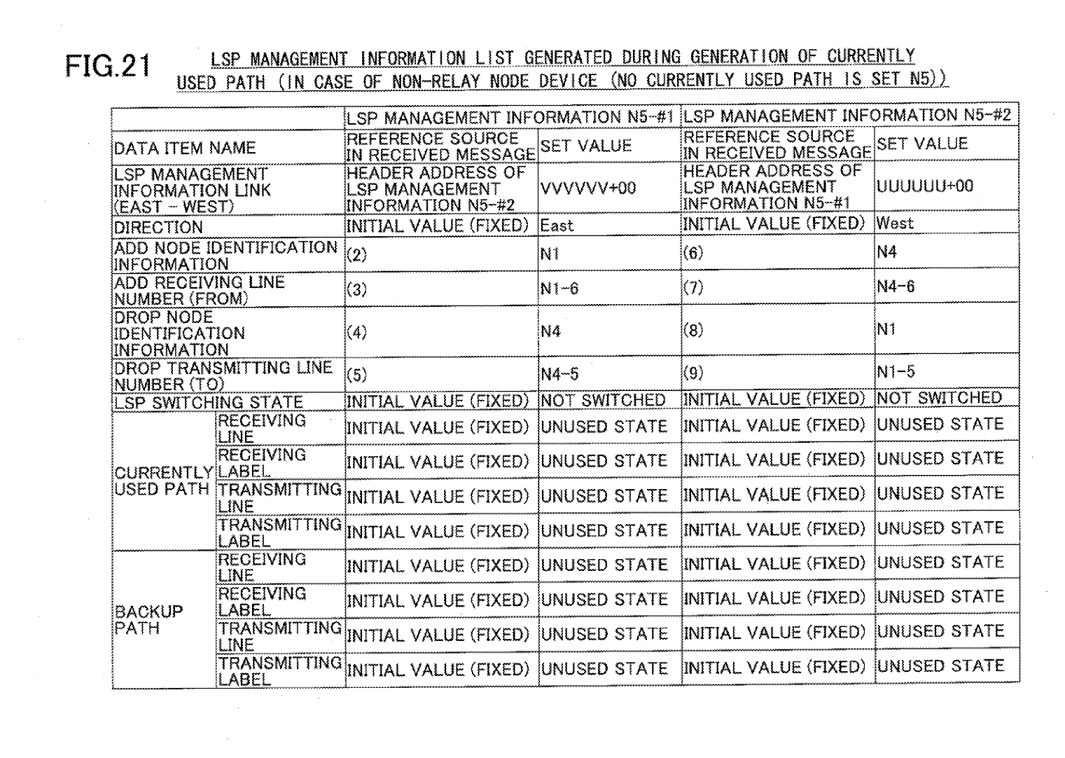

FIG. 21 illustrates the LSP management information generated in the non-relay node device N5 illustrated in FIG. 6. FIG. 21 illustrates the setting values of the data in the pair of the LSP management information N5-#1 and N5-#2 having different directions from each other and reference sources (i.e., the numbers (2) through (9)) of the backup path management information control response message to be used when the corresponding data are set. In the pair of the LSP management information N5-#1 and N5-#2, the data set in the Direction are opposite to each other (i.e., N5-#1:East, N5-#2:West). Upon the currently used path being established, switching of the LSP is not performed. Therefore, as the data of the LSP switching state, data value “No Switch (0)” is set. Further, as the data of the backup path, the data of “Unused state (0xFFFFFFFF)” are set.

### 4. Sequences of Adding and Deleting Backup Path

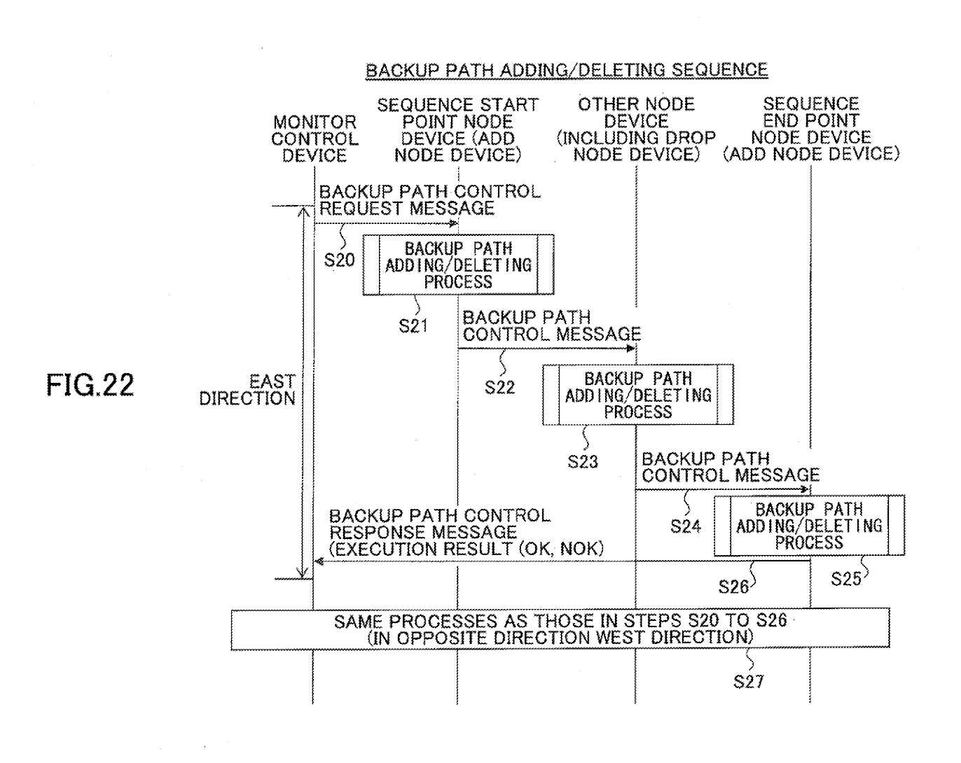

Next, sequences of adding and deleting the backup path in the ring type network according to this embodiment will be described with first reference to the sequence diagram of FIG. 22.

After the currently used path has been additionally established in accordance with the sequence diagram of FIG. 13, the backup path corresponding to the additionally established currently used path is additionally established. In the process of adding the backup path, first, the monitor control device transmits the backup path control request message to the ADD node device. Then, the backup path control request message is sequentially transferred through the node devices in the ring type network bidirectionally. By doing this, the backup path is established bidirectionally. Herein, the ADD node device that first transmits the message in the ring type network is referred to as a “sequence start point node device”. On the other hand, the ADD node device that last receives the message having traveled the ring type network is referred to as a “sequence end point node device”. In the example of the ring type network illustrated in FIG. 6, in East direction, the node device N1 which is the ADD node device corresponds to the sequence start point node device and the sequence end point node device as well. On the other hand, in West direction, the node device N4 which is the ADD node device corresponds to the sequence start point node device and the sequence end point node device as well.

As illustrated in FIG. 22, a message transfer process in East direction is first performed.

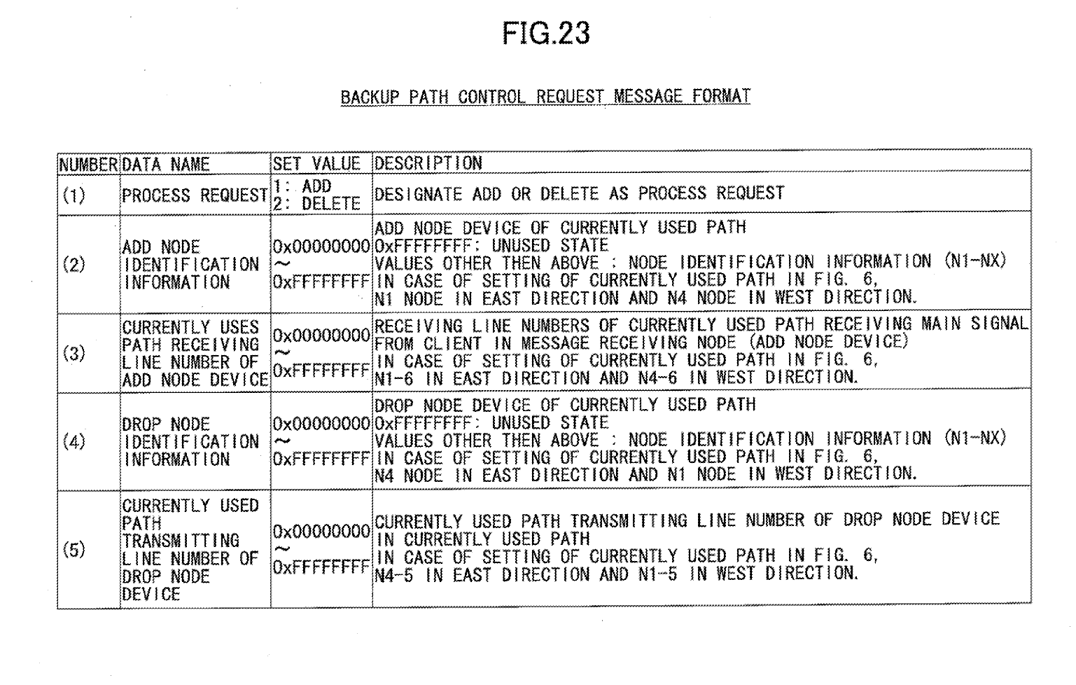

Specifically, the monitor control device transmits the backup path control request message to the ADD node device (node device N1 in the example of FIG. 6) (step S20). FIG. 23 illustrates an example format of the backup path control request message. As illustrated in FIG. 23, the backup path control request message includes five data items (1) through (5). Namely, as illustrated in FIG. 23, the backup path control request message includes the following data items. The following numbers (1) through (5) representing the corresponding contents of the data items of the backup path control request message may be referred to in the descriptions below.

The backup path control request message is transmitted only to the ADD node device from the monitor control device and is used to add and delete the backup path.

Backup Path Control Request Message

### (1) Process Request

### (2) ADD Node Identification Information

### (3) Currently Used Path Receiving Line Number of ADD Node

### (4) DROP Node Identification Information

### (5) Currently Used Path Transmitting Line Number of DROP Node

Upon receiving the backup path control request message, the ADD node device as the sequence start point node device performs a backup path adding/deleting process described below (step S21). As a result of the backup path adding/deleting process, the ADD node device transmits the backup path control message to the adjoining node device in East direction (step S22). By performing the backup path adding/deleting process, the back up path is added or deleted in the node device. More specifically, when the backup path adding/deleting process is performed, a data process is performed on the data of the LSP management information mainly managed by the node device. Details of the backup path adding/deleting process will be described below.

The node devices (e.g., the DROP node device) other than the ADD node device, performs the backup path adding/deleting process described below (step S23). As a result of the backup path adding/deleting process, the backup path control message is sequentially transferred to the adjoining node device in East direction in the ring type network (step S24).

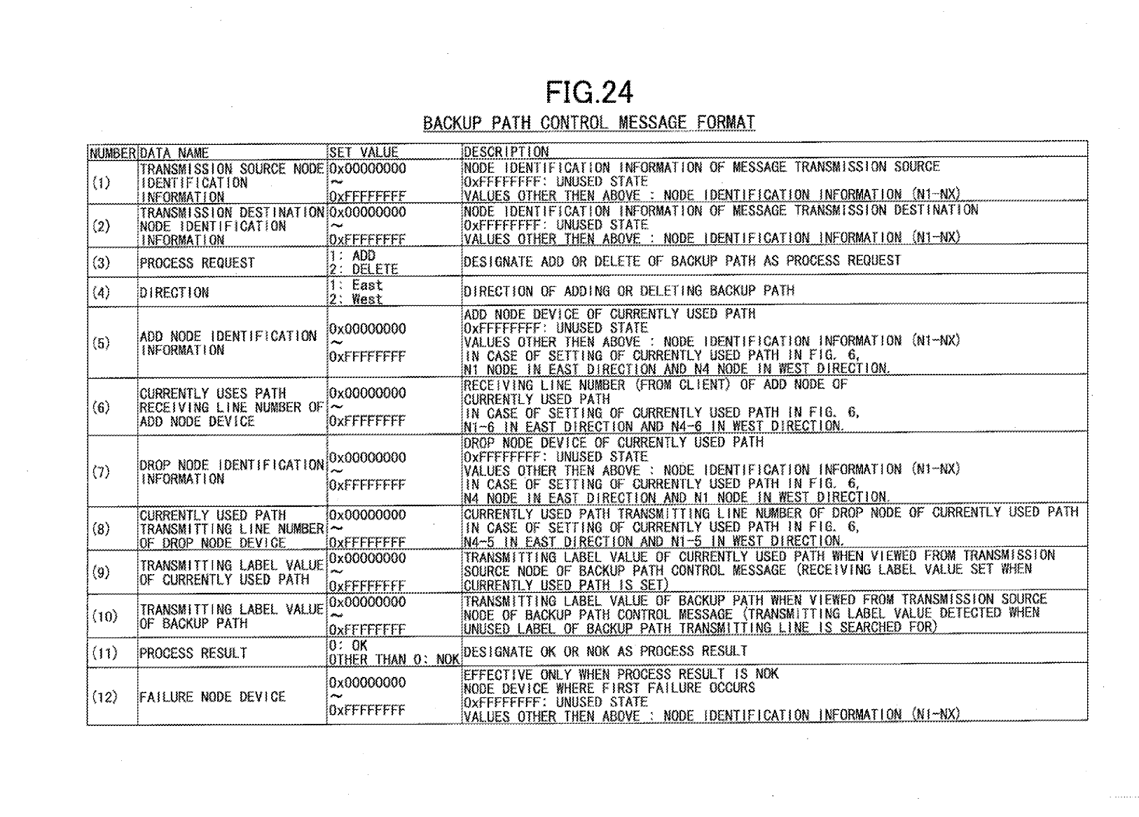

FIG. 24 illustrates an example format of the backup path control message. As illustrated in FIG. 24, the backup path control message includes twelve data items (1) through (12) having the contents as illustrated in FIG. 24. Namely, as illustrated in FIG. 24, the backup path control message includes the following data items. The following numbers (1) through (12) representing the corresponding contents of the data items of the backup path control message may be referred to in the descriptions below.

### Backup Path Control Message

### (1) Transmission Source Node Identification Information

### (2) Transmission Destination Node Identification Information

### (3) Process Request

### (4) Direction

### (5) ADD Node Identification Information

### (6) Currently Used Path Receiving Line Number of ADD Node Device

### (7) DROP Node Identification Information

### (8) Currently Used Path Transmitting Line Number of DROP Node Device

### (9) Transmitting Label Value of Currently Used Path

### (10) Transmitting Label Value of Backup Path

### (11) Process Result

### (12) Failure Node Device

When the backup path control message travels around the loop of the network in East direction and is transmitted (returned) to the ADD node device, the ADD node device as the sequence end point node device performs the backup path adding/deleting process described below (step S25). Then, the ADD node device transmits a backup path control response message to the monitor control device (step S26).

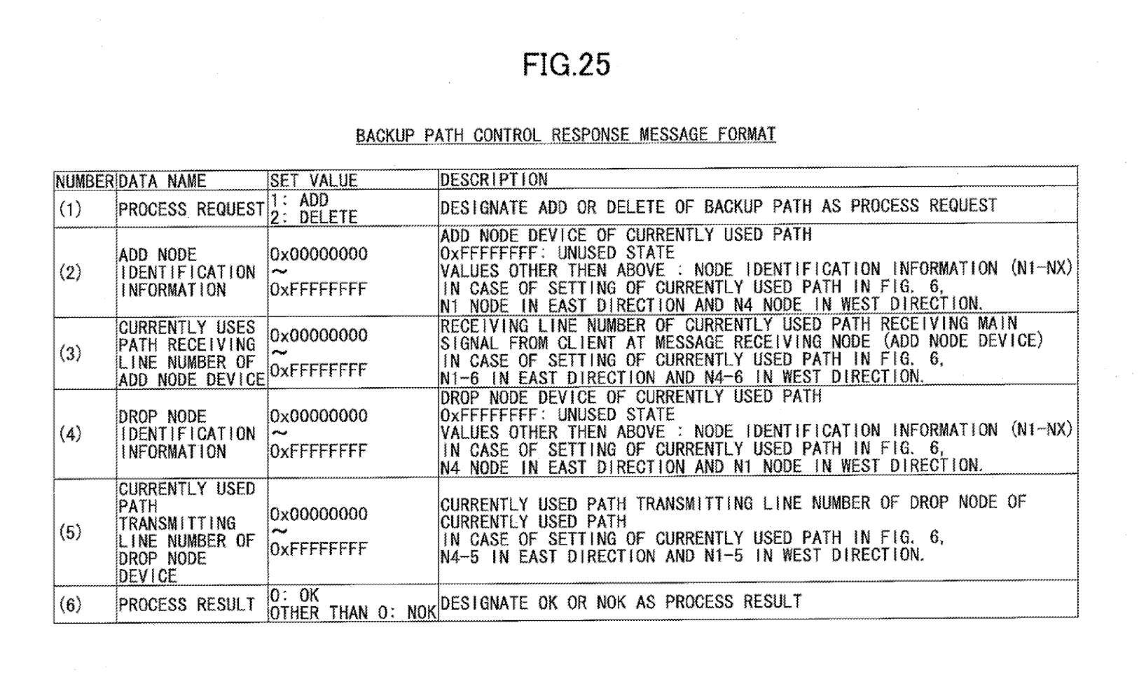

FIG. 25 illustrates an example format of the backup path control response message. As illustrated in FIG. 25, the backup path control response message includes six data items (1) through (6). The contents of the data items are described in FIG. 25. Namely, as illustrated in FIG. 25, the backup path control response message includes the following data items. The following numbers (1) through (6) representing the corresponding contents of the data items of the backup path control response message may be referred to in the descriptions below. Further, the backup path control response message may include only data items

(1) through (6).

### Backup Path Control Response Message

### (1) Process Request

### (2) ADD Node Identification Information

### (3) Currently Used Path Receiving Line Number of ADD Node Device

### (4) DROP Node Identification Information

### (5) Currently Used Path Transmitting Line Number of DROP Node Device

### (6) Process Result

In FIG. 22, after the message transfer process in East direction has been completed, the process in West direction similar to the process in East direction is performed in steps S20 through S26. Namely, the ADD node device as the sequence start point node device transmits the backup path control message to the adjoining node device in West direction, and the backup path control message is sequentially transferred in the ring type network in West direction. By doing this, the backup path in both directions is configured (established) in the ring type network.

In the following description of the backup path adding/deleting process, a case is described where the message is transferred in East direction, and the similar description in which the in message is transferred in West direction is omitted.

### 4.1 Adding and Deleting Process of Backup Path (Process Per Each Node Device)

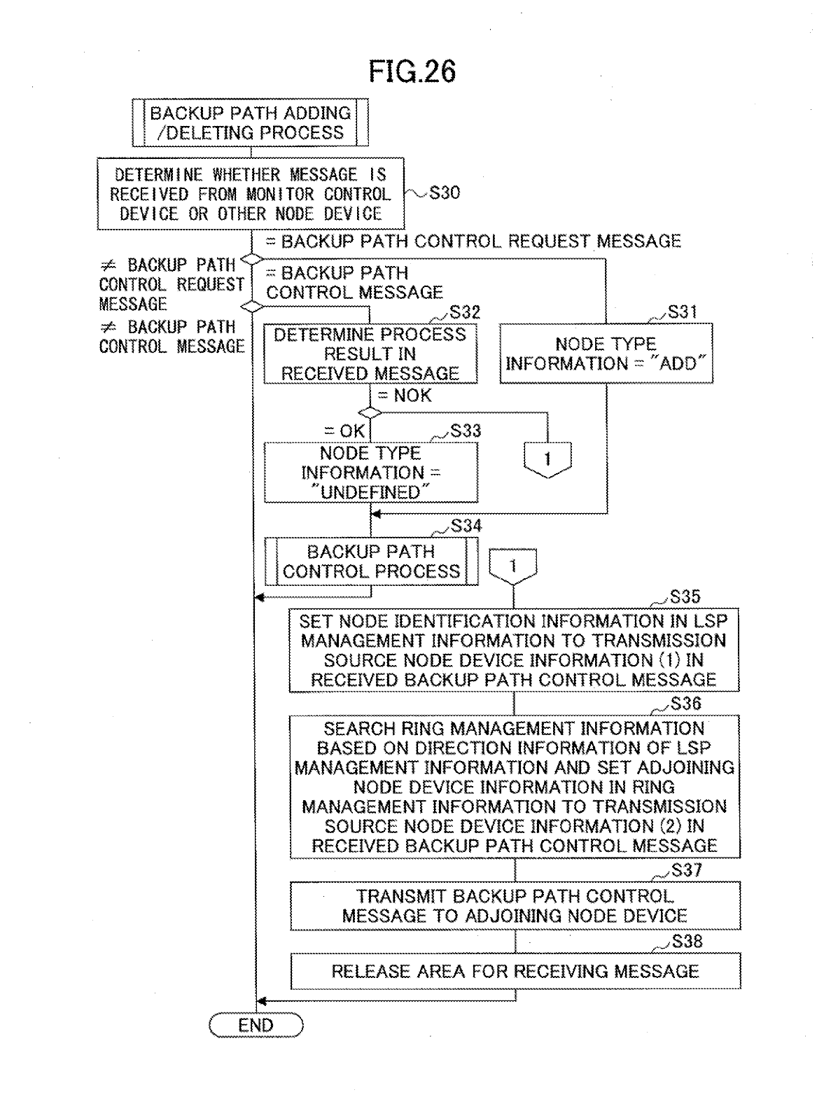

Details of the processes of the node devices described in the entire sequence with reference to FIG. 22 (specifically processes in steps S21, S23, S25, and the like) will be next described with reference to FIGS. 26 through 42. It should be noted that the contents of the backup path adding/deleting process differ depending on the types of the messages and the types of the node devices (i.e., the ADD node device, the DROP node device, the THR node device, the non THR node device, or the sequence end point node device). Further, the backup path adding/deleting process is performed mainly by the LSP controller 20.

### (A) Process Outline

FIG. 26 is an example flowchart illustrating the entire backup path adding/deleting process. As illustrated in FIG. 26, upon receiving a message, the node device determines whether the message is received from the monitor control device or another node device (step S30). As described with reference to FIG. 22, the backup path control request message is transmitted only to the ADD node device from the monitor control device. Therefore, upon receiving the backup path control request message, the node device sets the data “ADD” to the “Node Type Information” of the node device (step S31). Then, the process goes to step S34 to perform a backup path control process.

On the other hand, upon receiving the backup path control message, as described with reference to FIG. 22, the node device is not the ADD node device. Namely, the node device receives the backup path control message from an adjoining node device in the same ring type network. In this case, the node device refers to the “(11) process result” (step S32). When determining that the data of the “(11) process result” is OK, the node device sets the data “undefined” in the “Node Type Information” of the node device (step S33). Then, the process goes to step S34 to perform the backup path control process.

When determining that the “(11) process result” is NOK, the node device performs processes in steps S35 through S38 to transfer the backup path control message to the adjoining node device.

Namely, the node device sets the data of the “(1) Node Identification Information” of the node device into the “(1) Transmission Source Node Identification Information” of the received backup path control message (step S35). Next, the node device searches the ring management information based on the data of the “(3) Direction” of the LSP management information, and sets the data of the adjoining node device information (node identification information) into the “(2) Transmission Destination Node Identification Information” of the received backup path control message (step S36). Further, the node device transmits the backup path control message to the adjoining device (step S37), and releases a receiving message region (step S38). In the transmitting process in step S37, the device communication data inserting section 14 inserts a message into the main signal.

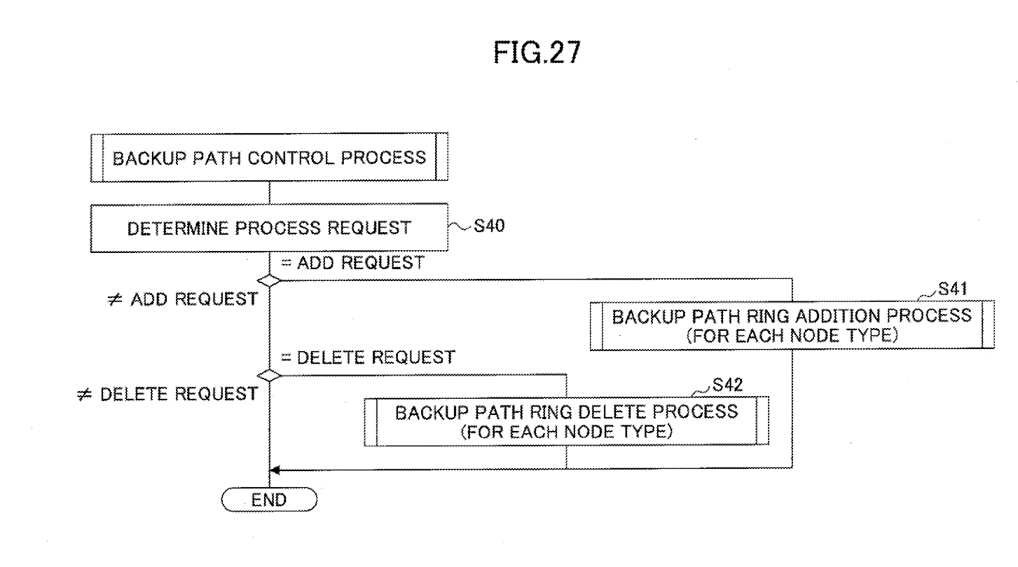

Next, the outline of the backup path control process performed in step S34 of FIG. 26 is described with reference to FIG. 27.

As illustrated in FIG. 27, first, the node device determines the contents of the process request included in the backup path control request message or the backup path control message (step S40). In the case of the backup path control request message, the contents of the data of the “(1) Process Request” of FIG. 23 are checked. On the other hand, in the case of the backup path control message, the contents of the data of the “(3) Process Request” of FIG. 24 are checked. As a result of checking the contents, when determining that the contents indicate a request to add the backup path, the process goes to step S41 to add the backup path. On the other hand, when determining that the contents indicate a request to delete the backup path, the process goes to step S42 to delete the backup path.

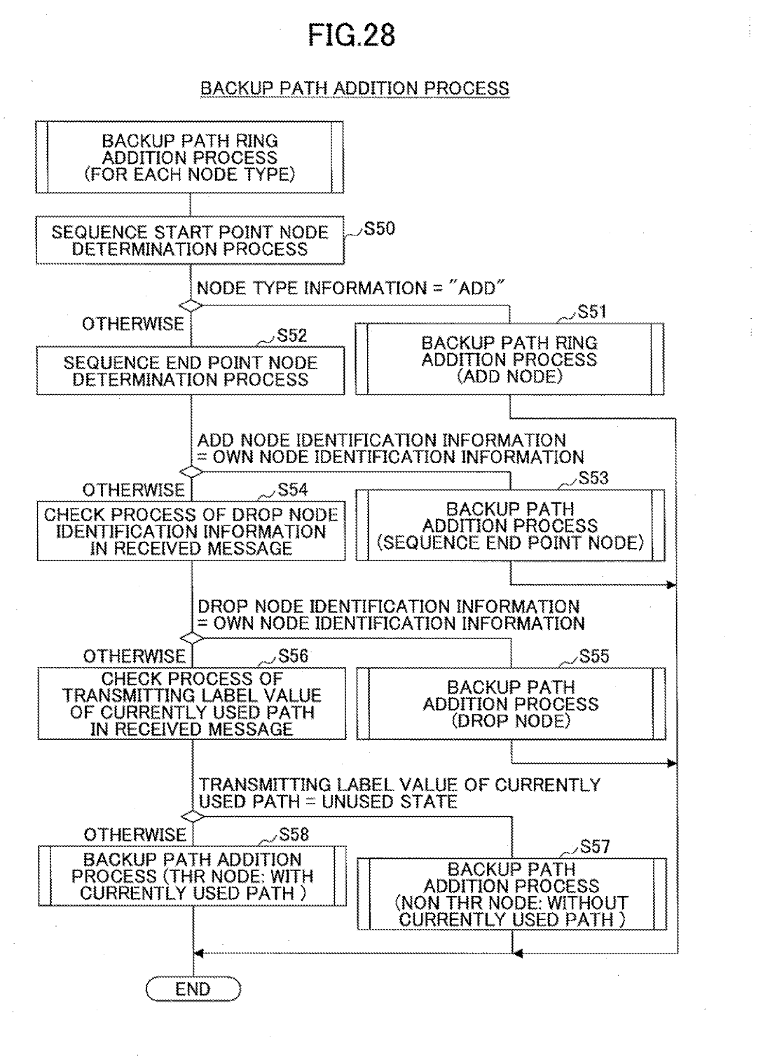

(B) Backup Path Ring Adding process (FIGS. 28 to 41)

Next, a backup path ring addition process performed by the node device will be described with reference to FIGS. 28 through 41.

FIG. 28 is an example flowchart illustrating the backup path ring addition process. In the backup path ring addition process, the node devices read receiving messages, set transmitting labels, update the LSP management information, and generate transmitting messages and the like. However, the contents of the backup path ring addition process differ depending on the types of the node devices. Because of this feature, the flowchart of FIG. 28 illustrates the process of selecting the process to be executed depending on the types of the node devices.

As illustrated in FIG. 28, the node device performs a sequence start point node determination process (step S50). As described above, the sequence start point node device is the ADD node device. Further, in step S31 of FIG. 26, as the sequence start point node device, the ADD node device sets the data “ADD” to the “Node Type Information” of the node device. Therefore, in step S50, the node devices determine whether the data “ADD” is set to the “Node Type Information” of the respective node devices. When determining that the data “ADD” is set to the “Node Type Information” in the node device, the node device performs a backup path ring addition process (ADD Node) which is for the ADD node device (step S51). Further, in this embodiment, in the process (sequence) in which the backup path in bidirection is established in the ring type network, the “sequence start point node device” is distinguished from the “sequence end point node device” for the same ADD node device. In this regard, the process goes to step S51 only when determining that the ADD node is the “sequence start point node device” (i.e., only when the ADD node receives the backup path control request message from the monitor control device).

In step S50, when determining that the data “ADD” is not set to the “Node Type Information” in the node device, the process goes to step S52, where the node device determines whether the node device is the “sequence end point node device” (step S52). In a case where the node device receives the backup path control message, when the data of the “(5) ADD node identification information” included in the received backup path control message is the same as the data of the node identification of the node device, it is possible to determine that the node device is the “sequence end point node device”. In this case, it is determined that the node device is the “sequence end point node device”. Therefore, the node device performs the backup path ring addition process (Sequence End Point Node Device) (step S53).

On the other hand, when determining that the node device to be processed is neither the “sequence start point node device” nor the “sequence end point node device”, the node device checks (detects) the “(7) DROP Node Identification Information” in the received backup path control message (step S54). Then, the node device determines whether the data of the “(7) DROP Node Identification Information” in the received backup path control message is the same as the data of the node identification information of the node device. When determining that the data of the “(7) DROP Node Identification Information” in the received backup path control message is the same as the data of the node identification information of the node device, the node device performs a backup path ring addition process (DROP Node) which is for the DROP node device (step S55).

Further, when determining that the node device to be process is not any of the ADD node device, the sequence end point node device, and the DROP node device, the node device is either the THR node device (i.e., the node device relaying the main signal from a client using the currently used path) or the non THR node device (i.e., the node device that does not transmit/receive or relay the main signal from the client using the currently used path). Therefore, to determine whether the node device is the THR node device or the non THR node device, the node device checks the “(11) Transmitting Line of Currently Used Path” or the “(12) Transmitting Label of Currently Used Path” in the LSP management information. Namely, by doing this, when the value of the “(11) Transmitting Line of Currently Used Path” or the “(12) Transmitting Label of Currently Used Path” indicates “Unused state”, it is possible to determined that the currently used path is not established. As a result, when determining that the node device is the non THR node device, the node device performs a backup path ring addition process (non THR Node) (step S57). On the other hand, when determining that the node device is the THR node device, the node device performs a backup path ring addition process (THR Node) (step S58).

In the following, details of the processes in steps S51 through S58 which are selected based on the determined types of the node devices in FIG. 28 will be separately described. Hereinafter and in the figures, the terms “backup path control request message” and “backup path control message” may be simplified as “backup path control request” and “backup path control”, respectively.

(B-1) Backup Path Ring Adding process (ADD Node)

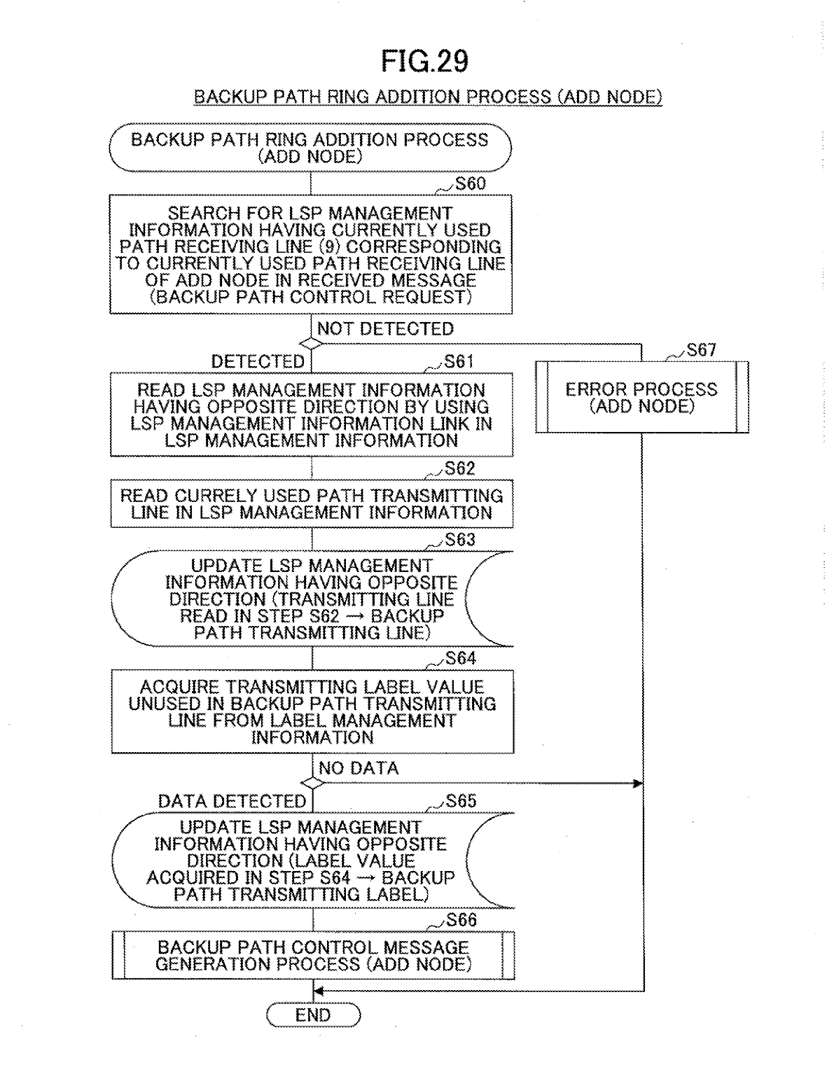

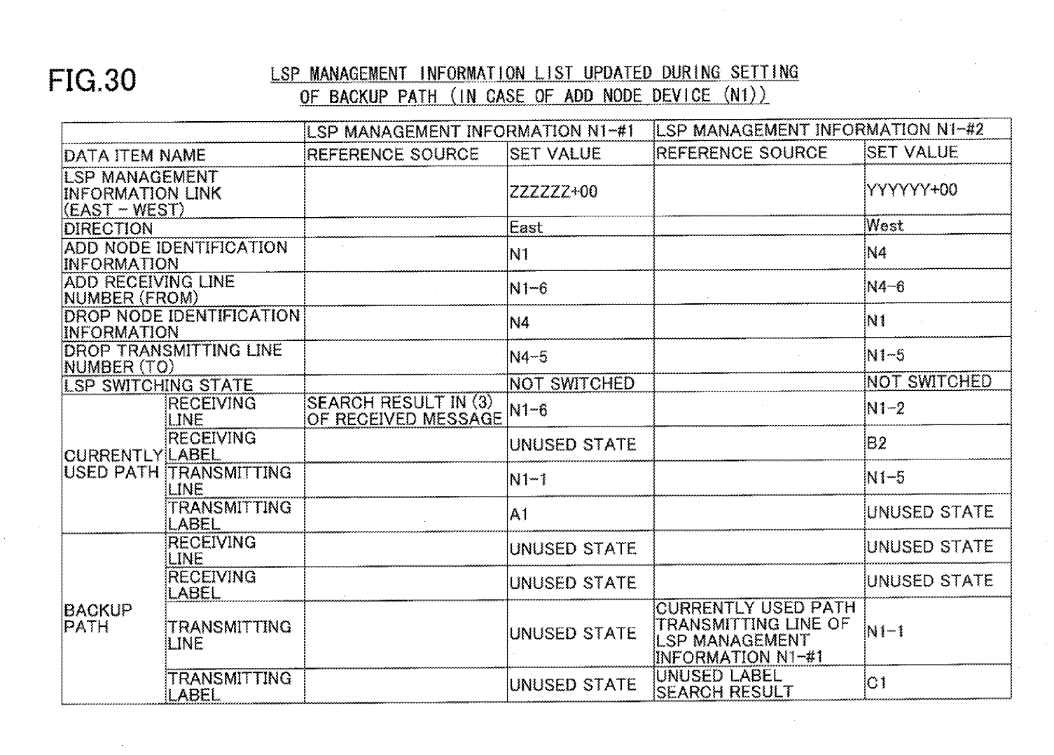

FIG. 29 is an example flowchart of the detailed backup path ring addition process (ADD Node). FIG. 30 illustrates the LSP management information set in the ADD node device N1 when the backup path corresponding to the currently used path of FIG. 6 is established (prepared), the LSP management information including reference sources indicating what is referred to when the LSP management information is set. More specifically, in FIG. 30, a pair of (two) LSP management information corresponding the currently used path having different directions are arranged side by side. In the following description of the flowchart of FIG. 29, the examples of the setting in the LSP management information of FIG. 30 may be adequately associated with steps of the flowchart.

In FIG. 29, first, the ADD node device as the sequence start point node device refers to the data of the “(3) Currently Used Path Receiving Line Number of ADD Node” in the received backup path control request message, and searches for the LSP management information having the data of the “(9) Receiving Line of Currently Used Path” which is the same as the data of the “(3) Currently Used Path Receiving Line Number of ADD Node” (step S60). At this timing, the addition process of the currently used path has been performed. Therefore, in the LSP management information of the node device, the data of the “(9) Receiving Line of Currently Used Path” has been set. Because of this feature, by performing this search, at least one set of the LSP management information is searched for (detected). For example, in FIG. 30, the data of the “(3) Currently Used Path Receiving Line Number of ADD Node” in the received backup path control request message that is received by the ADD node device from the monitor control device is “N1-6” (see FIG. 6). Therefore, the LSP management information having the data “N1-6” as the data of the “(9) Receiving Line of Currently Used Path” is searched for. One example of the LSP management information as a result of the search is the LSP management information N1-#1. In step S60, when no LSP management information is detected (not applicable (N/A)), an error process (ADD node) described below is performed (step S67) and the process is terminated.

The process after step S61 is performed on the LSP management information having been searched for (detected) in step S60 and the other LSP management information having the direction opposite to (different from) the direction of the LSP management information searched for (detected) in step S60.

The ADD node device refers to the data of the “(2) LSP Management Information Link” in the LSP management information to be processed, and reads the LSP management information having the opposite direction (step S61). In the example of FIG. 30, the ADD node device refers to the data of the “(2) LSP Management Information Link” in the LSP management information N1-#1, and reads the LSP management information N1-#1 having the opposite direction.

Next, the ADD node device reads the data of the “(11) Transmitting Line of Currently Used Path” of the LSP management information (step S62). Then, the ADD node device updates the LSP management information having the opposite direction by setting the read data of the “(11) Transmitting Line of Currently Used Path” to the data of the “(15) Transmitting Line of Backup Path” in the LSP management information having the opposite direction (step S63). In the example of FIG. 30, in the ADD node device N1, the data of the “(11) Transmitting Line of Currently Used Path” of the LSP management information N1-#1 is “N1-1”. Therefore, the data “N1-1” is set as the data of the “(15) Transmitting Line of Backup Path” in the LSP management information N1-#2 having the opposite direction. Namely, in the ADD node device, the transmitting line in a certain direction of the backup line is established by referring to the transmitting line of the currently used path having been established in the direction opposite to the certain direction.

Next, as the backup path transmitting line, the ADD node device acquires an unused transmitting label value from the label management information (step S64). Namely, in the ADD node device, the LSP controller 20 accesses the label management information of the label manager 21 and acquires the unused transmitting label value. In this case, when there is no unused transmitting label value (i.e., when there is no applicable value to be used as the transmitting label value in the label management information), the process is terminated because it may be no longer possible to establish the backup path. On the other hand, when there is the unused transmitting label value, the ADD node device updates the LSP management information having the opposite direction by setting the label value acquired in step S64 to the data of the “(16) Transmitting Label of Backup Path” (step S65). In the example of FIG. 30, the ADD node device N1 acquires the data “C1” as the unused transmitting label value and sets the data “C1” to the data of the “(16) Transmitting Label of Backup Path” of the LSP management information N1-#2 having the opposite direction.

As described above, the ADD node device sets the data of the transmitting line of the currently used path in a one direction of the ADD node device to the data of the transmitting line of the backup path having the direction opposite to the one direction. Further, the ADD node device acquires the transmitting label corresponding to the transmitting line, and sets the acquired transmitting label to the transmitting label corresponding to the transmitting line of the backup path having the opposite direction. Then, the ADD node device generates the backup path control message to be transmitted to the adjoining node device in, for example, East direction of the ring type network (step S66).

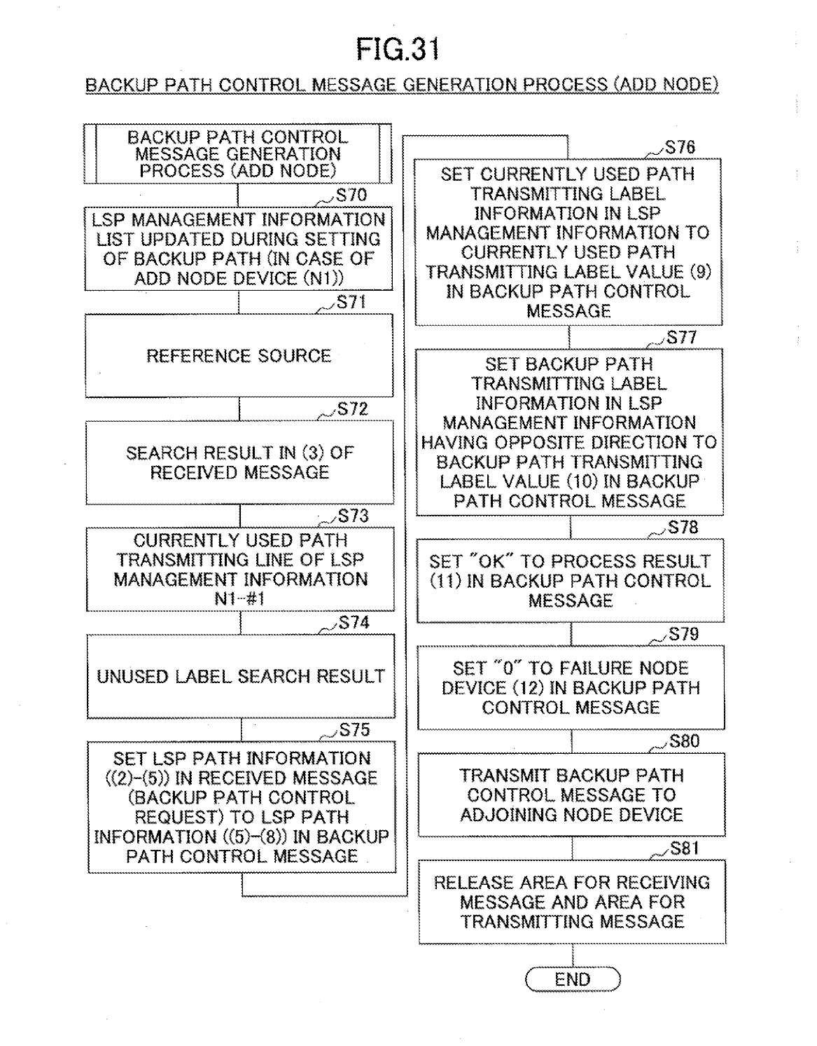

In the following, details of a backup path control message generation process in step S66 are described with reference to FIG. 31.

In FIG. 31, first, the ADD node device reserves an area (a memory area) for the backup path control message (step S70). Then, the ADD node device sets the data items (i.e., (1) through (12) of FIG. 24) of in the backup path control message to be transmitted to the adjoining node device as described below.

In step S71, the data value of the “(1) Node Identification Information” in the LSP management information is set to the data of the “(1) Transmission Source Node Identification Information” in the backup path control message.

In step S72, the ring management information is searched for based on the data of the “(3) Direction” (e.g., East direction) in the LSP management information, and the adjoining node device information of the node device is set to the data of the “(2) Transmission Destination Node Identification Information” in the backup path control message.

In step S73, the data value of the “(1) Process Request” in the received message (i.e., the backup path control request message from the monitor control device) is set to the data of the “(3) Process Request” in the backup path control message.

In step S74, the data value of the “(3) Direction” in the LSP management information is set to the data of the “(4) Direction” in the backup path control message.

In step S75, the LSP path information items (2) through (5) in East direction of the received message (i.e., the backup path control request message) are set to the LSP path information items (2) through (5), respectively, in the backup path control message.

In step S76, the value of the “(12) Transmitting Label of Currently Used Path” in the LSP management information is set to the data of “(9) Transmitting Label Value of Currently Used Path” in the backup path control message.

In step S77, the value of the “(16) Transmitting Label of Backup Path” in the LSP management information having the opposite direction (i.e., the value set in step S65 of FIG. 29) is set to the “(10) Transmitting Label Value of Backup Path” in the backup path control message.

In step S78, the data value “OK” is set to the “(11) Process Result” in the backup path control message.

In step S79, the value “0” is set to the “(12) Failure Node Device” in the in the backup path control message.

After completing the generation of the backup path control message, the ADD node device transmits the backup path control message to the adjoining node device (step S80), and releases the memory area for the receiving message and the memory area for the transmitting message (step S81).

The above is the backup path control message generation process of the ADD node device.

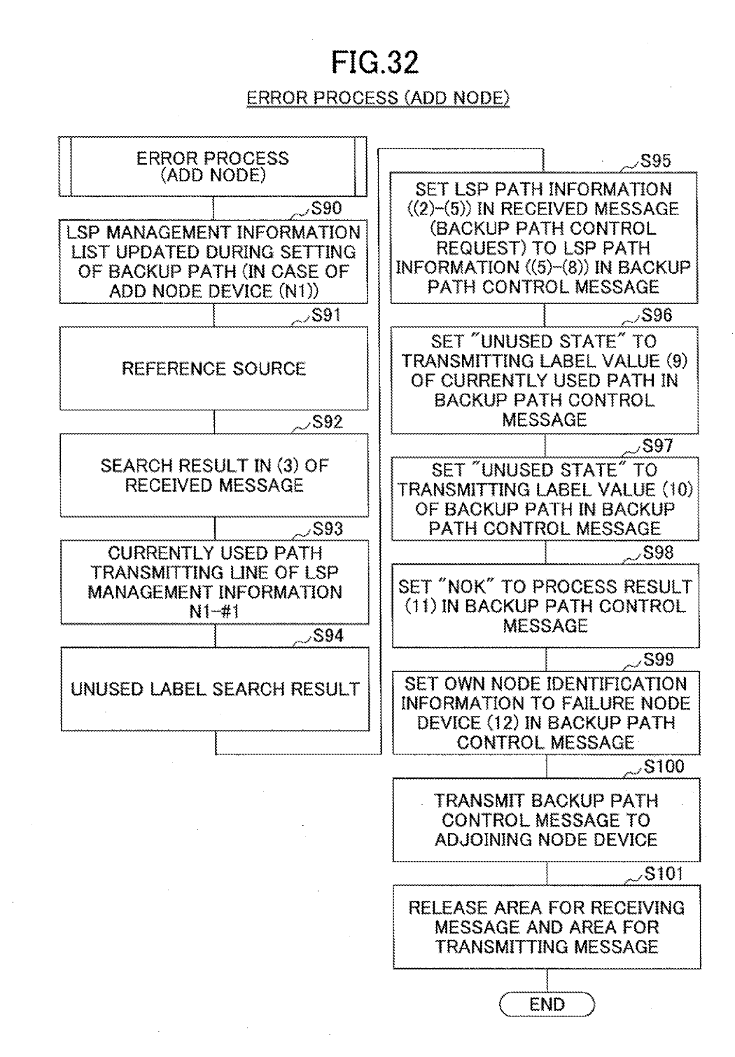

Next, details of the error process (ADD node) in the ADD node device (step S67 in FIG. 29) are described with reference to FIG. 32. In FIG. 32, first, the ADD node device reserves an area (a memory area) for the backup path control message (step S90). Then, the ADD node device sets the data items (i.e., (1) through (12) of FIG. 24) of in the backup path control message to be transmitted to the adjoining node device as described below.

In step S91, the data value of the “(1) Node Identification Information” in the LSP management information is set to the data of the “(1) Transmission Source Node Identification Information” in the backup path control message.

In step S92, the ring management information is searched for based on the data of the “(3) Direction” (e.g., East direction) in the LSP management information, and the adjoining node device information of the node device is set to the data of the “(2) Transmission Destination Node Identification Information” in the backup path control message.

In step S93, the data value of the “(1) Process Request” in the received message (i.e., the backup path control request message from the monitor control device) is set to the data of the “(3) Process Request” in the backup path control message.

In step S94, the data value of the “(3) Direction” in the LSP management information is set to the data of the “(4) Direction” in the backup path control message.

In step S95, the LSP path information items (2) through (5) in East direction of the received message (i.e., the backup path control request message) are set to the LSP path information items (2) through (5), respectively, in the backup path control message.

In step S96, the data value “unused state” is set to the data of “(9) Transmitting Label Value of Currently Used Path” in the backup path control message.

In step S97, the data value “unused state” is set to the “(10) Transmitting Label Value of Backup Path” in the backup path control message.

In step S98, the data value “NOK” is set to the “(11) Process Result” in the backup path control message.

In step S99, the data value of the node identification information of the ADD node device is set to the “(12) Failure Node Device” in the in the backup path control message.

After completing the generation of the backup path control message, the ADD node device transmits the backup path control message to the adjoining node device (step S100), and releases the memory area for the receiving message and the memory area for the transmitting message (step S101).

When generating the backup path control message, the error process in FIG. 32 differs from the process in normal state in FIG. 31 in that the data value “unused state” is set as the data of the transmitting label values of the currently used path and the backup path, the data value “NOK” is set as the data of the process result, the node device is reported as the failure node device and the like.

(B-2) Backup Path Ring Adding process (Sequence End Point Node)

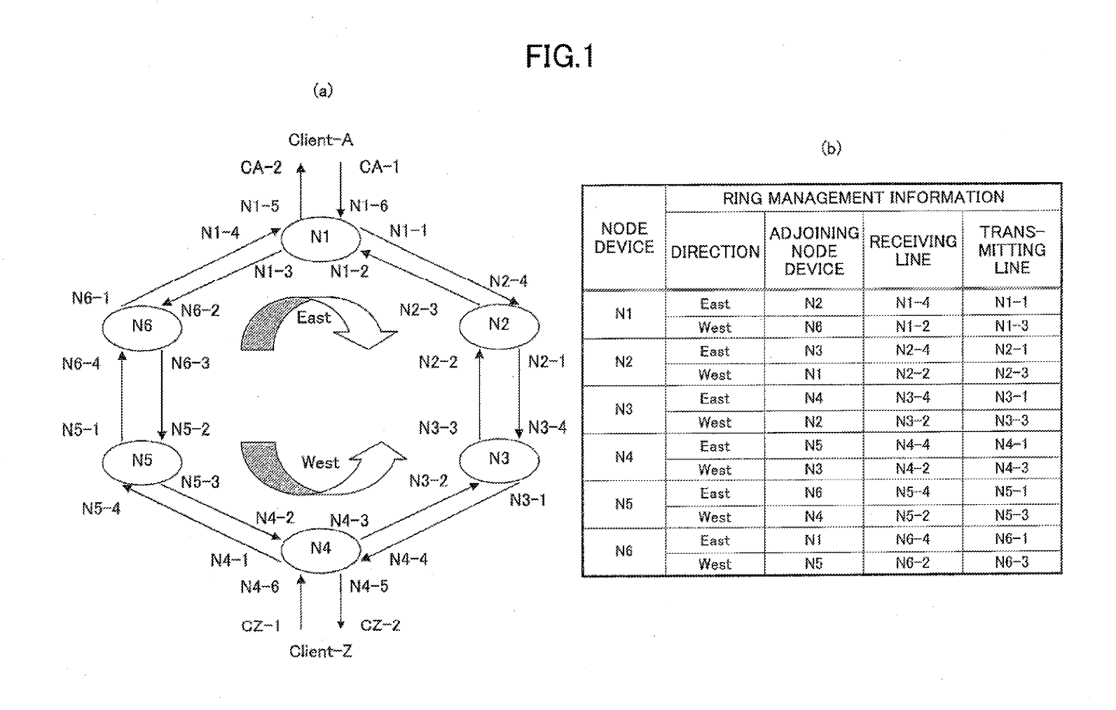

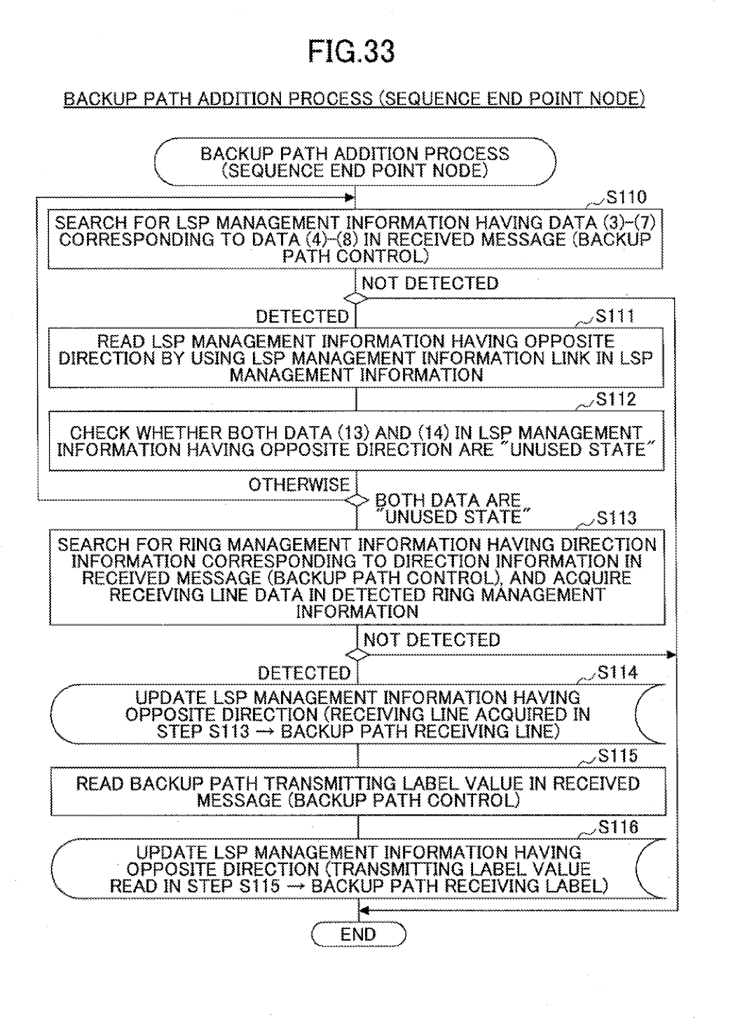

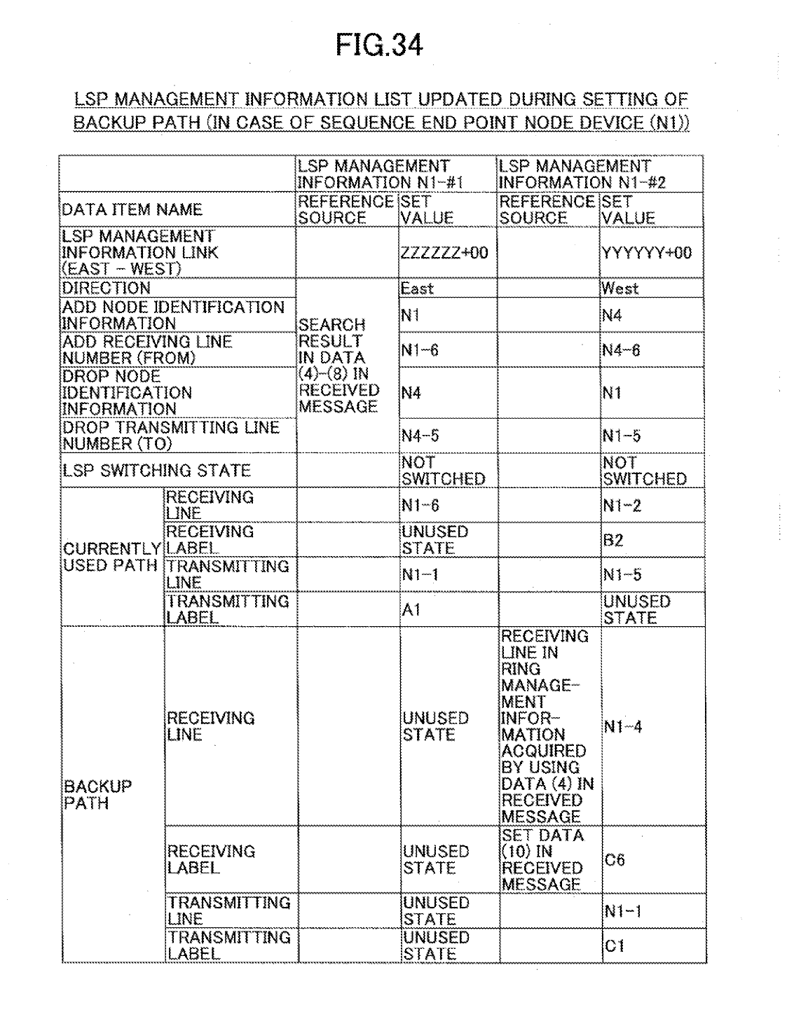

FIG. 33 is an example flowchart illustrating a detailed backup path ring adding process (sequence end point node). FIG. 34 illustrates the LSP management information set in the sequence end point node device N1 when the backup path corresponding to the currently used path of FIG. 1 is established (prepared), the LSP management information including reference sources indicating what is referred to when the LSP management information is set. More specifically, in FIG. 30, a pair of (two) LSP management information corresponding the currently used path having different directions are arranged side by side. In the following description of the flowchart of FIG. 33, the examples of the setting in the LSP management information of FIG. 34 may be adequately associated with steps of the flowchart.

In FIG. 33, first, the sequence end point node device searches for the LSP management information having the data items (3) through (7) which are the same as the data items (4) through (8), respectively, in the received message (i.e., the backup path control message) from among plural sets of the LSP management information in the sequence end point node device (step S110). The data of the data items (3) through (7) are already set in the currently used path establish process in the ADD node device which is the sequence end point node device. Therefore, the same data as the data of the data items (3) through (7) are set as the data of the data items (4) through (8), respectively, in the backup path control message. For example, in FIG. 34, the data value of the “(3) Direction” in the LSP management information N1-#1 is “East”, the data value of the “(4) ADD Node Identification Information” is “N1”, the data value of the “Currently Used Path Receiving Line Number of ADD Node” is “N1-6”, the data value of the “(6) DROP Node Identification Information” is “N4”, and the data value of the “(7) Currently Used Path Transmitting Line Number of DROP node” is “N4-5”. Therefore, in the searching process in step S110, when no LSP management information is searched for (detected), the process is terminated. The sequence end point node device is a terminating device of the backup path control message. Therefore, it may not be necessary to perform the error process.

The processes after step S111 are performed on the LSP management information having been searched for (detected) in step S110 and the other LSP management information having the direction opposite to the direction of the detected LSP management information.

The sequence end point node device reads the LSP management information having the opposite direction by using the LSP management information link in the LSP management information to be processed (step S111). Then, the sequence end point node device determines whether each of the data of the data items (13) and (14) in the LSP management information having the opposite direction indicates “unused state” (step S112). In this case, the data of the “(13) Receiving Line of Backup Path” and the “(14) Receiving Label of Backup Path” are normally “unused state”. Therefore, when determining that each of the data of the data items (13) and (14) does not indicate “unused state” (“Other”), the process goes back to step S110. On the other hand, when determining that each of the data of the data items (13) and (14) indicates “unused state”, the process goes to step S113.

In step S113, the sequence end point node device searches the direction information in the ring management information based on the data of the “(4) Direction” in the received message (i.e., the backup path control message), and acquires the data of the receiving line in the ring management information. When the receiving line is not acquired (i.e., when there is no receiving line), it may be thought that, for example, the ring management information is abnormal. Therefore, the process is terminated (step S113).

Upon acquiring the receiving line in step S113, the sequence end point node device updates the LSP management information having the opposite direction by setting the acquired receiving line to the data of the “(13) Receiving Line of Backup Path” in the LSP management information having the opposite direction (step S114). In the example of FIG. 34, the sequence end point node device N1 acquires the data “N1-4” as the receiving line in East direction in the sequence end point node device N1, and sets the data “N1-4” to the data of the “(13) Receiving Line of Backup Path” in the LSP management information having the opposite direction (i.e., the LSP management information N1-#2). Namely, in the sequence end point node device, the receiving line in a certain direction is established by referring to the receiving line of the currently used path having already been established and having the direction opposite to the certain direction.

Next, the sequence end point node device reads the data of the “(10) Transmitting Label Value of Backup Path” in the received message (i.e., the backup path control message) (step S115). Then, the sequence end point node device updates the LSP management information having the opposite direction by setting the transmitting label value to the data of the “(14) Receiving Label of Backup Path” in the LSP management information having the opposite direction (step S116). In the example of FIG. 34, the sequence end point node device N1 reads the data “C6” as the data of the “(10) Transmitting Label Value of Backup Path” in the received message, and sets the data “C6” to the data of the “(14) Receiving Label of Backup Path” in the LSP management information having the opposite direction (i.e., the LSP management information N1#2).

Further, the backup path control message transmitted in the ring type network is terminated at the sequence end point node device.

(B-3) Backup Path Ring Adding process (THR/DROP Nodes)

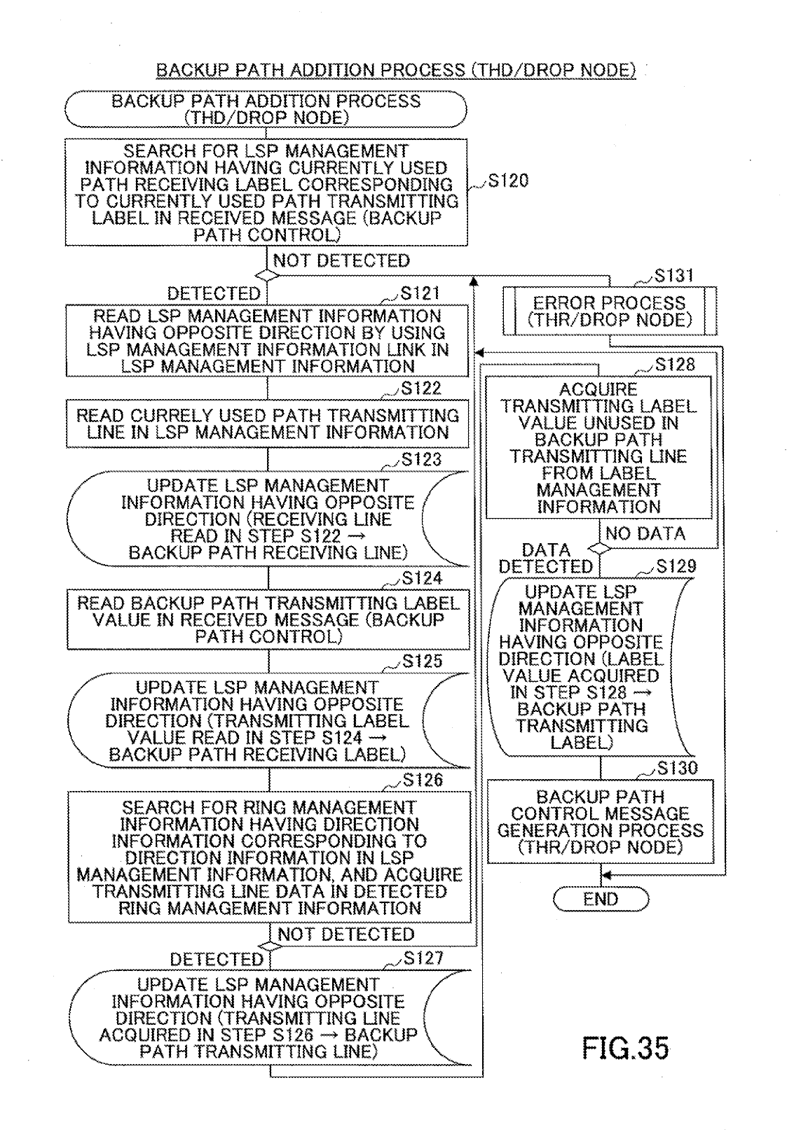

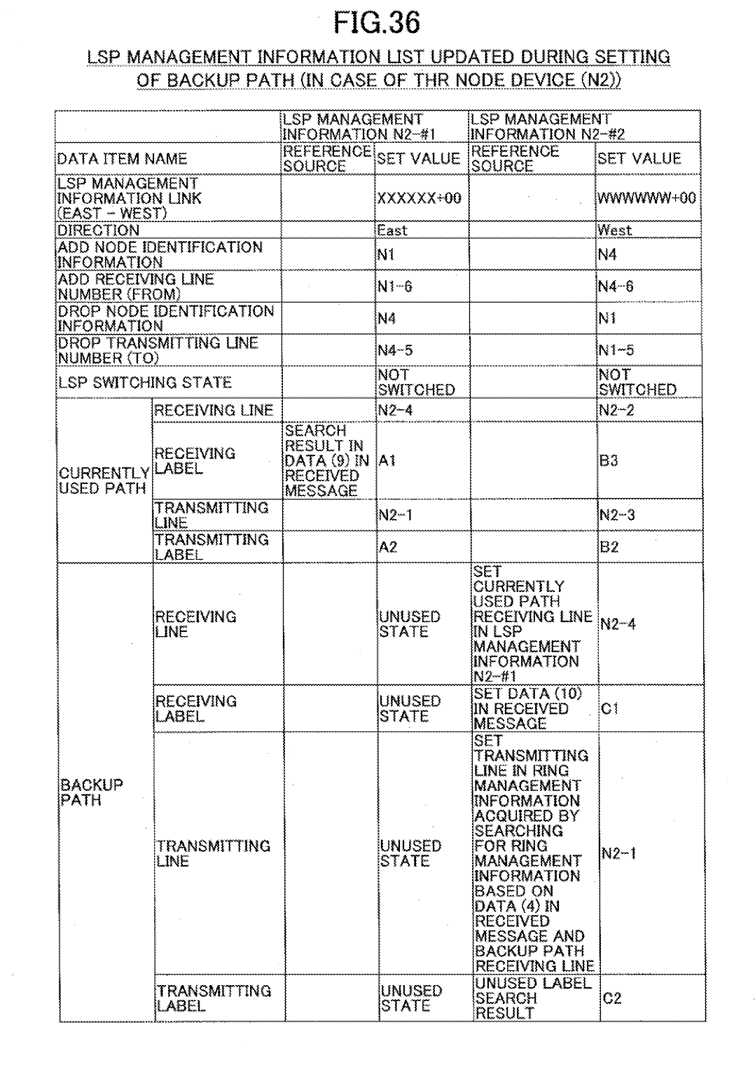

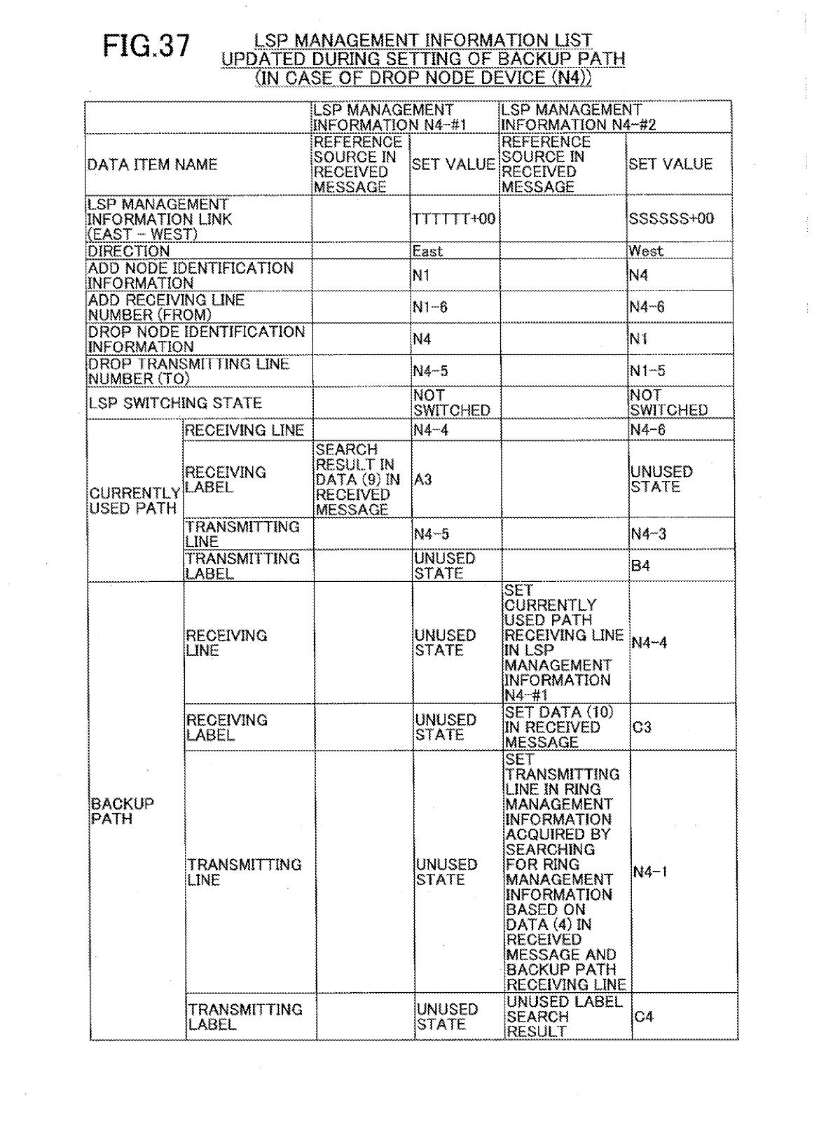

FIG. 35 is an example flowchart illustrating a detailed backup path ring adding process (THR/DROP nodes) commonly applied to the THR node device and the DROP node in the ring type network. FIG. 36 illustrates the LSP management information set in, for example, one THR node device (N2) when the backup path corresponding to the currently used path of FIG. 6 is established (prepared), the LSP management information including reference sources indicating what is referred to when the LSP management information is set. FIG. 37 illustrates the LSP management information set in the DROP node device (N4) when the backup path corresponding to the currently used path of FIG. 6 is established (prepared), the LSP management information including reference sources indicating what is referred to when the LSP management information is set. In FIGS. 36 and 37, a pair of (two) the LSP management information having directions opposite to each other in the node devices are arranged side by side. In the following description of the flowchart of FIG. 35, the examples of the setting in the LSP management information of FIGS. 36 and 37 may be adequately associated with steps of the flowchart.

Further, in the description of (B-3), the term “node device” refers to both the THR node device and the DROP node device.

First, the node device refers to the data of the “(9) Transmitting Label Value of Currently Used Path” in the backup path control message received from the adjoining node device in the ring type network, and searches for the LSP management information having the data of the “(10) Receiving Label of Currently Used Path” which is the same as the data of the “(9) Transmitting Label Value of Currently Used Path” (step S120). In the case, the data of the “(10) Receiving Label of Currently Used Path” has been already set in the LSP management information of the node device since the addition process of the currently used path has been performed. Therefore, normally, at least one LSP management information is acquired by the above searching process. For example, in FIG. 36, the data value of the “(9) Transmitting Label Value of Currently Used Path” in the backup path control message received by the THR node device N2 from the ADD node device N1 is “A1”. Therefore, the THR node device N2 searches for the LSP management information having the data value “A1” as the data of the “(10) Receiving Label of Currently Used Path”. One example of the LSP management information acquired in the above search process is the LSP management information N2-#1 illustrated in FIG. 36. In step S120, however, when no LSP management information is detected (not applicable (N/A)), the error process described below is performed (step S131) and the process is terminated.

The processes after step S120 are performed on the LSP management information acquired by the search process in step S120 and the other LSP management information having the direction opposite to the LSP management information acquired in step S120, the LSP management information and the other LSP management information constituting a pair of LSP management information.

The node device refers to the data value of the “(2) LSP Management Information Link” in the LSP management information to be processed, and reads the LSP management information having the opposite direction (step S121). In the example of FIG. 36, the THR node device N2 refers to the data value of the“(2) LSP Management Information Link” in the LSP management information N2-#1, and reads the LSP management information having the opposite direction (i.e., the LSP management information N2-#2). In the example of FIG. 37, the DROP node device N4 refers to the data value of the“(2) LSP Management Information Link” in the LSP management information N4-#1, and reads the LSP management information having the opposite direction (i.e., the LSP management information N4-#2).

Next, the node device reads the data of the “(9) Receiving Line of Currently Used Path” in the LSP management information (step S122). Then, the node device updates the LSP management information having the opposite direction by setting the read data of the “(9) Receiving Line of Currently Used Path” to the data of the “(13) Receiving Line of Backup Path” in the LSP management information having the opposite direction read in step S121. In the example of FIG. 36, the data value of the“(9) Receiving Line of Currently Used Path” in the LSP management information N2-#1 is “N2-4”. Therefore the THR node device N2 sets the data “N2-4” to the data of the “(13) Receiving Line of Backup Path” in the LSP management information having the opposite direction (i.e., the LSP management information N2-#2). In the example of FIG. 37, the data value of the“(9) Receiving Line of Currently Used Path” in the LSP management information N4-#1 is “N4-4”. Therefore the DROP node device N4 sets the data “N4-4” to the data of the “(13) Receiving Line of Backup Path” in the LSP management information having the opposite direction (i.e., the LSP management information N4-#2). Namely, the node device sets the receiving line of the backup path in a certain direction by referring to the receiving line of the currently used path already established in the direction opposite to the certain direction.

Next, the node device reads the data of the “(10) Transmitting Label Value of Backup Path” in the received message (i.e., the backup path control message) (step S124). Then, the node device updates the LSP management information having the opposite direction by setting the read data of the “(10) Transmitting Label Value of Backup Path” to the data of the “(13) Receiving Line of Backup Path” in the LSP management information having the opposite direction (step S125). As a result, in the example of the THR node device N2 of FIG. 36, the data value “C1” is set as the data of the “(13) Receiving Line of Backup Path” in the LSP management information (N2-#2) having the direction opposite to the direction of the LSP management information (N2-#1). In the example of the DROP node device N4 of FIG. 37, the data “C3” is set to as the data of the “(13) Receiving Line of Backup Path” in the LSP management information (N4-#2) having the direction opposite to the direction of the LSP management information (N4-#1).

Next, the node device searches for the ring management information based on the direction indicated in the data of the “(3) Direction” in the LSP management information, and acquires the transmitting line in the accorded (searched) ring management information (step S126). In the example of FIG. 36, the THR node device N2 searches for the ring management information based on the direction (in this case, East direction) indicated in the data of the “(3) Direction” in the LSP management information, and acquires the data “N2-1” as the data of the transmitting line corresponding to and having the same direction as the direction of the receiving line (N2-4) of the currently used path read in step S122. When no transmitting line is acquired in step S126, it is though that, for example, the ring management information is not normal. Therefore, the error process (THR/DROP node) is performed (step S131) and the process is terminated.

The node device updates the LSP management information having the opposite direction by setting the data of the transmitting line acquired in step S126 to the data of the transmitting line of the back path in the LSP management information having the opposite direction (step S127).

Next, the node device acquires an unused transmitting label value as the backup path transmitting line from the label management information (step S128). Namely, in the node device, the LSP controller 20 accesses the label management information of the label manager 21 and acquires the unused transmitting label value. In this case, when there is no unused transmitting label value (i.e., when there is no applicable value to be used as the transmitting label value in the label management information), it is thought that, for example, the label management information is abnormal. Therefore, the error process (THR/DROP node) is performed (step S131) and the process is terminated. On the other hand, when there is the unused transmitting label value, the node device updates the LSP management information having the opposite direction by setting the label value acquired in step S128 to the data of the “(16) Transmitting Label of Backup Path” in the LSP management information having the opposite direction (step S129). In the example of FIG. 36, the THR node device N2 acquires the data “C2” as the unused transmitting label value from the label management information, and sets the data “C2” to the data of the “(16) Transmitting Label of Backup Path” (or “(15) Transmitting Line of Backup Path”) of the LSP management information N2-#2 having the opposite direction. In the example of FIG. 37, the DROP node device N4 acquires the data “C4” as the unused transmitting label value from the label management information, and sets the data “C4” to the data of the “(16) Transmitting Label of Backup Path” (or “(15) Transmitting Line of Backup Path”) of the LSP management information N4-#2 having the opposite direction.

As described above, in setting the transmitting line of the backup path, the THR node device or the DROP node device acquires the transmitting line number from the ring management information by using the receiving line of the currently used path as a key. Then, the node device generates the backup path control message to be transmitted to the adjoining node device in, for example, East direction in the ring type network (step S130).

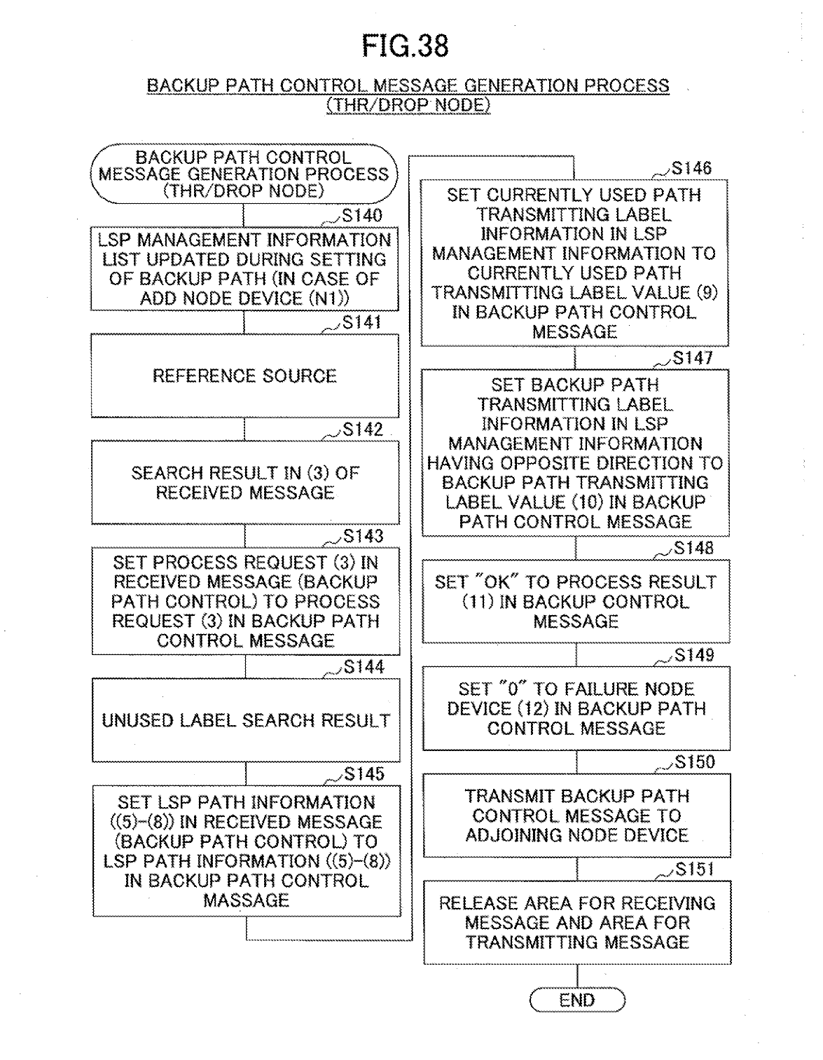

In the following, details of the backup path control message generation process in step S130 are described with reference to FIG. 38.

As illustrated in FIG. 38, first, the node device reserves an area (a memory area) for the backup path control message (step S140). Then, the node device sets the data items ((1) through (12) in FIG. 24) in the backup path control message to be transmitted to the adjoining node device as described below.

In step S141, the data value of the “(1) Node Identification Information” in the LSP management information is set to the data of the “(1) Transmission Source Node Identification Information” in the backup path control message.

Step S142: The ring management information is searched for based on the data of the “(3) Direction” (e.g., East direction) in the LSP management information, and the adjoining node device information of the node device is set to the data of the “(2) Transmission Destination Node Identification Information” in the backup path control message.

Step S143: The data value of the “(3)

Process Request” in the received message (i.e., the backup path control message from the adjoining node device) is set to the data of the “(3) Process Request” in the backup path control message.

Step S144: The data value of the “(3) Direction” in the LSP management information is set to the data of the “(4) Direction” in the backup path control message.

Step S145: The LSP path information items (5) through (8) in East direction of the received message (i.e., the backup path control message from the adjoining node device) are set to the LSP path information items (5) through (8), respectively, in the backup path control message.

Step S146: The value of the “(12) Transmitting Label of Currently Used Path” in the LSP management information is set to the data of the “(9) Transmitting Label Value of Currently Used Path” in the backup path control message.

Step S147: The value of the “(16) Transmitting Label of Backup Path” in the LSP management information having the opposite direction (i.e., the value set in step S129 in FIG. 35) is set to the data of the “(10) Transmitting Label Value of Backup Path” in the backup path control message.

Step S148: The data value “OK” is set to the “(11) Process Result” in the backup path control message.

Step S149: The data value “0” is set to the “(12) Failure Node Device” in the in the backup path control message.

After the generation of the backup path control message is completed, the node device transmits the backup path control message to the adjoining node device (step S150), and releases the memory area for the receiving message and the memory area for the transmitting message (step S151).

The above is the backup path control message generation process of the THR node device or the DROP node device.

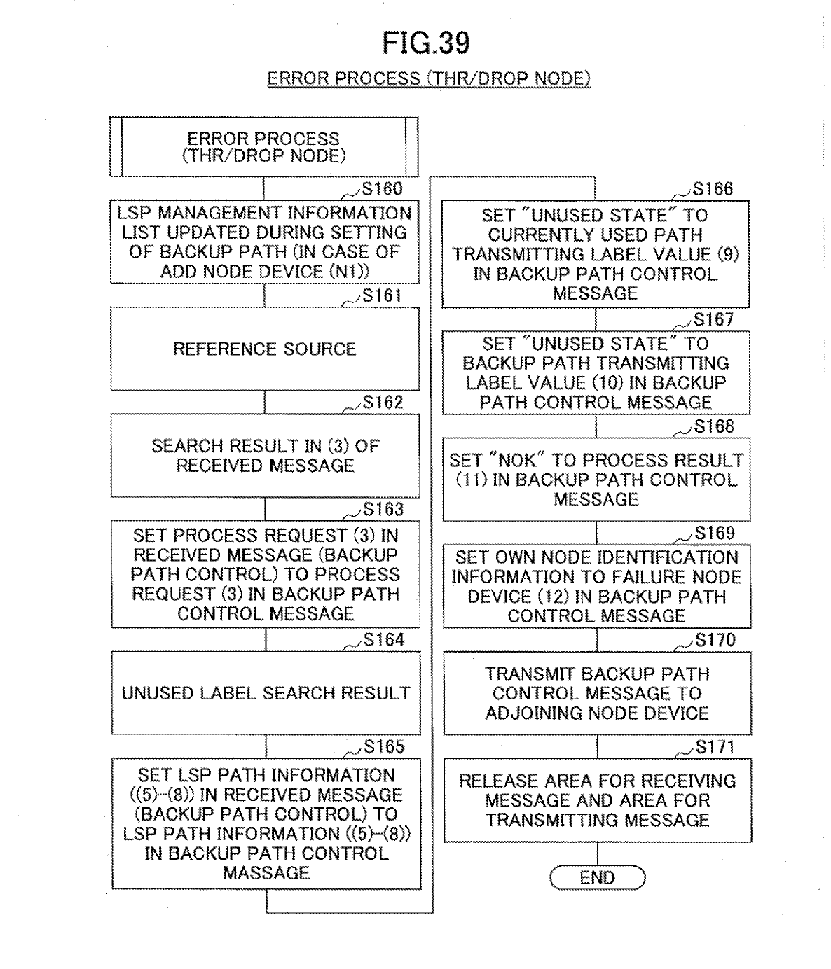

Next, details of the error process (THR/DROP node) in the THR node device or the DROP node device (in step S131) are described with reference to FIG. 39.

As illustrated in FIG. 39, first, the node device reserves an area (a memory area) for the backup path control message (step S160). Then, the node device sets the data items ((1) through (12) of FIG. 24) in the backup path control message to be transmitted to the adjoining node device as described below.

In step S161, the data value of the “(1) Node Identification Information” in the LSP management information is set to the data of the “(1) Transmission Source Node Identification Information” in the backup path control message.

In Step S162, the ring management information is searched for based on the data of the “(3) Direction” (e.g., East direction) in the LSP management information, and the adjoining node device information of the node device is set to the data of the “(2) Transmission Destination Node Identification Information” in the backup path control message.

In Step S163, the data value of the “(3) Process Request” in the received message (i.e., the backup path control message from the adjoining node device) is set to the data of the “(3) Process Request” in the backup path control message.

In Step S164, the data value of the “(3) Direction” in the LSP management information is set to the data of the “(4) Direction” in the backup path control message.

In Step S165, the LSP path information items (5) through (8) in East direction of the received message (i.e., the backup path control message from the adjoining node device) are set to the LSP path information items (5) through (8), respectively, in the backup path control message.

In Step S166, the data value “unused state” is set to the data of the “(9) Transmitting Label Value of Currently Used Path” in the backup path control message.

In Step S167, the data value “unused state” is set to the data of the “(10) Transmitting Label Value of Backup Path” in the backup path control message.

In Step S168, the data value “NOK” is set to the “(11) Process Result” in the backup path control message.

In Step S169, the data value of the identification information of the node device is set to the “(12) Failure Node Device” in the in the backup path control message.

After completing the generation of the backup path control message, the node device transmits the backup path control message to the adjoining node device (step S170), and releases the memory area for the receiving message and the memory area for the transmitting message (step S171). When generating the backup path control message, the error process in FIG. 39 differs from the process in normal state in FIG. 38 in that the data value “unused state” is set as the data of the transmitting label values of the currently used path and the backup path, the data “NOK” is set as the data of the process result, the node device is reported as the failure node device and the like.

### (B-4) Backup Path Ring Adding Process (Non THR Node)

As described above, there is no established currently used path in the non THR node device. In the example of the currently used path of FIG. 6, for example, the node devices N5 and N6 correspond to the non THR node device.

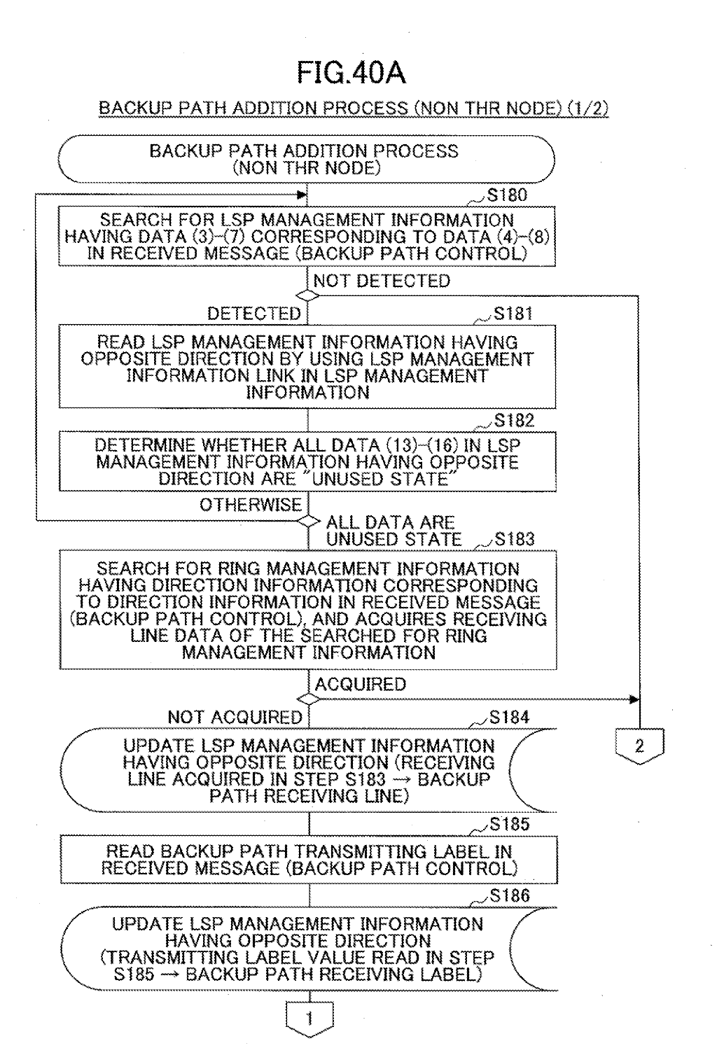

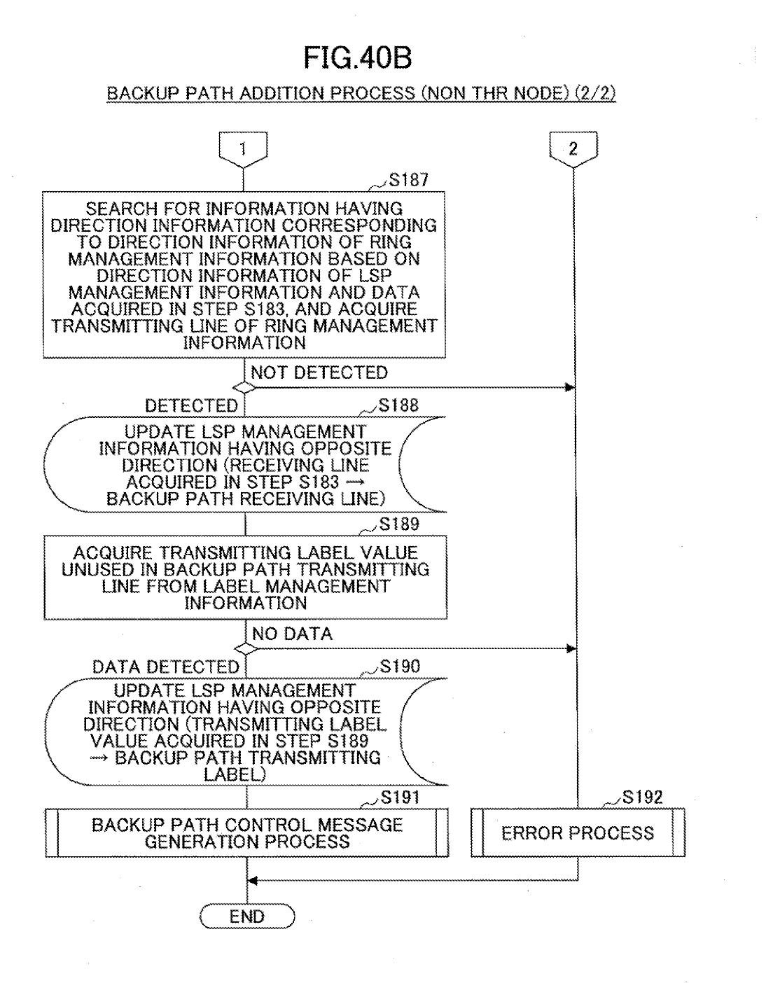

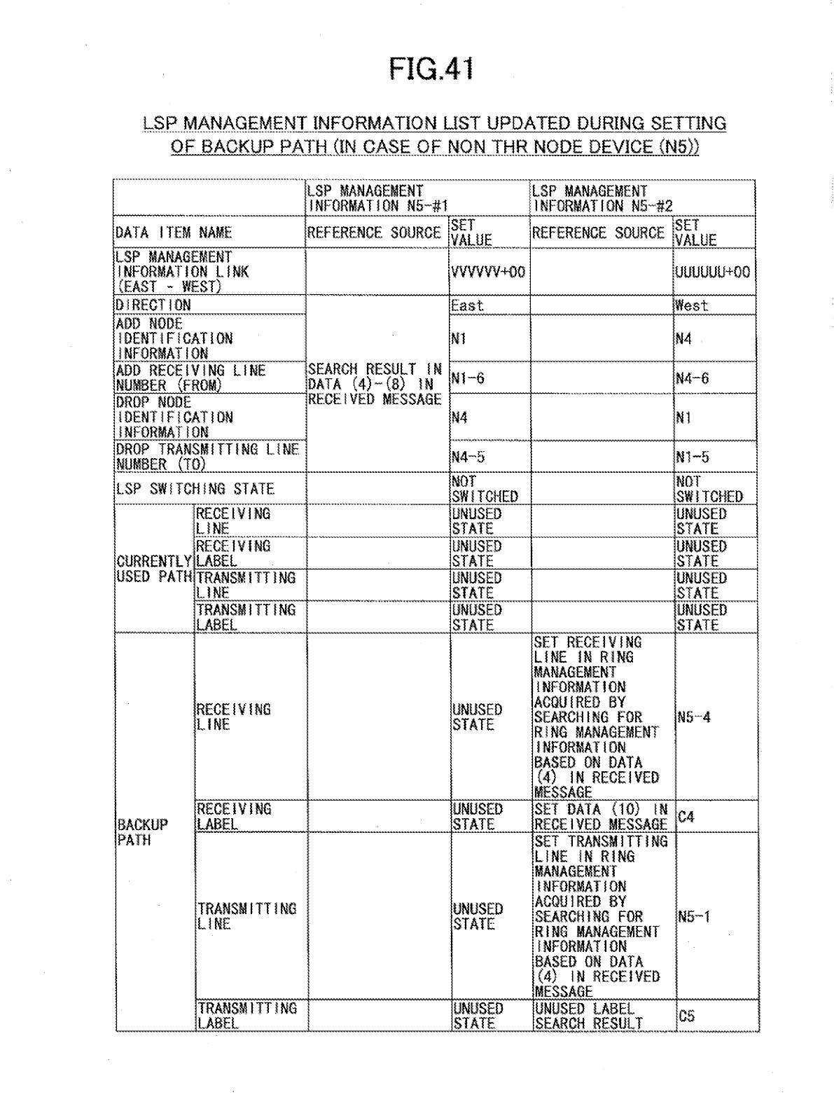

FIGS. 40A and 40B are a flowchart of the backup path ring adding process (non THR node) of the non THR node device in the ring type network. FIG. 41 illustrates the LSP management information set in, for example, one non THR node device (N5) when the backup path corresponding to the currently used path of FIG. 6 is established (prepared), the LSP management information including reference sources indicating what is referred to when the LSP management information is set. In FIG. 41, a pair of (two) the LSP management information having directions opposite to each other in the node devices are arranged side by side. In the following description of the flowchart of FIGS. 40A and 40B, the examples of the setting in the LSP management information of FIG. 41 may be adequately associated with steps of the flowchart.

In FIG. 40A, first, from among plural sets of the LSP management information in the non THR node device, the non THR node device searches for the LSP management information having the data items (3) through (7) corresponding to the data items (4) through (8) of the received message (i.e., the backup path control message) from the adjoining node device of the non THR node device (step Step S180). The data of the data items (3) through (7) in the LSP management information have been set since the backup path has been established in the non THR node device. Accordingly, the same data as the data of the data items (3) through (7) have been set in the data items (4) through (8) in the backup path control message by the ADD node device which is the sequence start point node device. For example, in FIG. 41, the data value of the “(3) Direction” in the LSP management information N5-#1 is “East”, the data value of the “(4) ADD Node Identification Information” is “N1”, the data value of the “(5) Currently Used Path Receiving Line Number of ADD Node” is “N1-6”, the data value of the “(6) DROP Node Identification Information” is “N4”, and the data value of the “(7) Currently Used Path Transmitting Line Number of DROP Node” is “N4-5”. Therefore, in the search process in step S180, when no corresponding LSP management information is detected, the error process is performed (step S192), and the process is terminated. The error process in step S192 may be the same as that illustrated in FIG. 39.

The processes after step S181 are performed on the LSP management information acquired by the search process in step S180 and the other LSP management information having the direction opposite to the LSP management information acquired in step S180, the LSP management information and the other LSP management information constituting a pair of LSP management information.

The non THR node device reads the LSP management information having the opposite direction by using the data of the “(2) LSP Management Information Link” in the LSP management information to be processed (step S181). Then, the non THR node device determines whether all data of the data items (13) through (16) in the LSP management information set to the data of the management information having the opposite direction are “unused state” (step S182). This is because, in the non THR node device, the data of the receiving line and the receiving label in the backup path and the data of the transmitting line and the transmitting label in the backup path are “unused state”. Therefore, in step S182, when determining that all the data of the above data items are not “unused state” (“other”), the process goes back to step S180. Otherwise (in case of “all unused state”), the process goes to step S183.

After step S183, the non THR node device sets the data of the receiving line and the receiving label in the backup path and the data of the transmitting line and the transmitting label in the backup path in the LSP management information.

First, in step S183, the non THR node device acquires the data of the receiving line in the ring management information by searching for the direction information of the ring management information based on the data of the “(4) Direction” in the received message (i.e., backup path control message). When no data of the receiving line are acquired (i.e., when there are no data of the receiving line), it is thought that, for example, the ring management information is abnormal. Therefore, the error process is performed (step S192) and the process is terminated.

Then, the non THR node device updates the LSP management information having the opposite direction by setting the data of the receiving line acquired in step S183 to the data of the “(13) Receiving Line of Backup Path” in the LSP management information having the opposite direction (step S184). In the example of FIG. 41, the non THR node device N5 acquires the data value “N5-4” which is the data of the receiving line in East direction of the non THR node device N5 from the ring management information, and sets the data “N5-4” to the data of the “(13) Receiving Line of Backup Path” in the LSP management information having the opposite direction (i.e., the LSP management information N5-#2).

Next, the non THR node device reads the data of the “(10) Transmitting Label Value of Backup Path” in the received message (i.e., the backup path control message) (step S185). Then, the non THR node device updates the LSP management information having opposite direction by setting the data of the “(10) Transmitting Label Value of Backup Path” to the data of the “(14) Receiving Label of Backup Path” in the LSP management information having the opposite direction (step S186). In the example of FIG. 41, the non THR node device N5 reads the data “C4” as the data of the “(10) Transmitting Label Value of Backup Path” in the received message, and sets the data “C4” to the data of the “(14) Receiving Label of Backup Path” in the LSP management information having the opposite direction (i.e., the LSP management information N5-#2).

Next, the non THR node device searches for the direction information in the ring management information based on the data of the “(4) Direction” in the received message (i.e., the backup path control message), and acquires the data of the transmitting line in the ring management information (step S187). When no data of the transmitting line are acquired (i.e., when there are no data of the receiving line), it is thought that, for example, the ring management information is abnormal. Therefore, the error process is performed (step S192) and the process is terminated.

Then, the non THR node device updates the LSP management information having the opposite direction by setting the data of the transmitting line acquired in step S187 to the data of the “(15) Transmitting Line of Backup Path” in the LSP management information having the opposite direction (step S188). In the example of FIG. 41, the non THR node device N5 acquires the data value “N5-1” which is the data of the transmitting line in East direction of the non THR node device N5 from the ring management information, and sets the data “N5-1” to the data of the “(15) Transmitting Line of Backup Path” in the LSP management information having the opposite direction (i.e., the LSP management information N5-#2).

Next, the non THR node device acquires an unused transmitting label value as the transmitting line of the backup path from the label management information (step S180). Namely, in the no THR node device, the LSP controller 20 accesses the label management information of the label manager 21 and acquires the unused transmitting label value. In this case, when there is no unused transmitting label value (i.e., when there is no applicable value to be used as the transmitting label value in the label management information), the error process is performed (step S192) and the process is terminated. On the other hand, when there is the unused transmitting label value, the non THR node device updates the LSP management information having the opposite direction by setting the label value acquired in step S189 to the data of the “(16) Transmitting Label of Backup Path” (step S190). In the example of FIG. 41, the non THR node device N5 acquires the data “C5” as the unused transmitting label value and sets the data “C5” to the data of the “(16) Transmitting Label of Backup Path” (“(15) Transmitting Line of Backup Path”) of the LSP management information N5-#2 having the opposite direction.

Then, the non THR node device performs the backup path control message generation process (step S191). The process may be similar to the process performed in the case of the THR/DROP node device (see FIG. 38).

(C) Backup Path Ring Deleting process

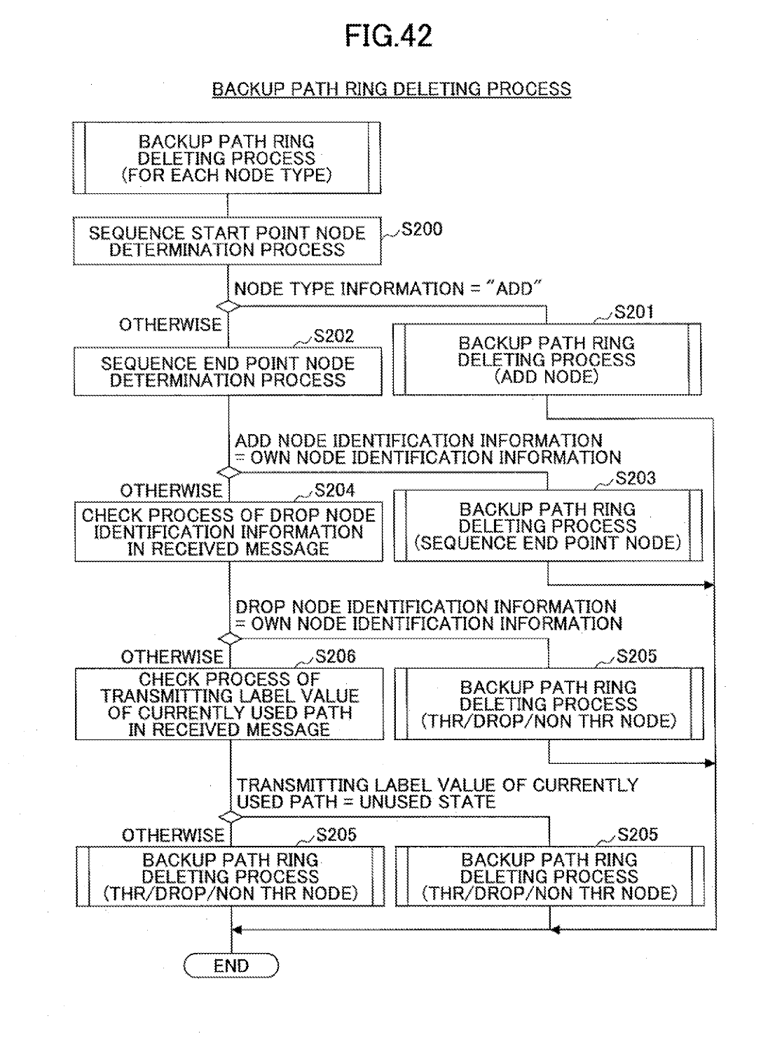

Next, a backup path ring deleting process performed by the node device will be described with reference to FIGS. 42 through 45.

FIG. 42 is an example flowchart illustrating the backup path ring deleting process. In the backup path ring deleting process, the node devices read receiving messages, release the memory areas for the messages, update the LSP management information, generate transmitting messages and the like. However, the contents of the backup path ring deleting process differ depending on the types of the node devices. Because of this feature, the flowchart of FIG. 42 illustrates the process of selecting the process to be executed depending on the types of the node devices.

As illustrated in FIG. 42, the node device performs a sequence start point node determination process (step S200). As described above, the sequence start point node device is the ADD node device. Further, in step S31 of FIG. 26, as the sequence start point node device, the ADD node device sets the data “ADD” to the “Node Type Information” of the node device. Therefore, in step S200, the node devices determine whether the data value “ADD” is set to the “Node Type Information” of the respective node devices. When determining that the data value “ADD” is set to the “Node Type Information” in the node device, the node device performs a backup path ring deleting process (ADD Node) which is for the ADD node device (step S201). Further, in this embodiment, in the process (sequence) in which the backup path in both directions is established in the ring type network, the “sequence start point node device” is distinguished from the “sequence end point node device” for the same ADD node device. In this regard, the process goes to step S201 only when determining that the ADD node is the “sequence start point node device”.

In step S200, when determining that the data value “ADD” is not set to the “Node Type Information” in the node device, the process goes to step S202, where the node device determines whether the node device is the “sequence end point node device” (step S202). In a case where the node device receives the backup path control message, when the data value of the “(5) ADD node identification information” included in the received backup path control message is the same as the data value of the node identification of the node device, it is possible to determine that the node device is the “sequence end point node device”. In this case, it is determined that the node device is the “sequence end point node device”. Therefore, the node device performs the backup path ring deleting process (Sequence End Point Node Device) (step S203).

On the other hand, when determining that the node device to be processed is neither the “sequence start point node device” nor the “sequence end point node device”, the node device checks (detects) the “(7) DROP Node Identification Information” in the received backup path control message (step S204). Then, the node device determines whether the data value of the “(7) DROP Node Identification Information” in the received backup path control message is the same as the data of the node identification information of the node device. When determining that the data value of the “(7) DROP Node Identification Information” in the received backup path control message is the same as the data of the node identification information of the node device, the node device performs a backup path ring deleting process (DROP Node) which is for the DROP node device (step S205).

Further, when determining that the node device to be processed is not any of the ADD node device, the sequence end point node device, and the DROP node device, the node device is either the THR node device (i.e., the node device relaying the main signal from a client using the currently used path) or the non THR node device (i.e., the node device that does not transmit/receive or relay the main signal from the client using the currently used path). In step S206 of FIG. 42, it is determined whether the node device to be processed is the THR node device node device or the non THR node device. However, this step is provided for convenience only so as to be compared with the backup path ring addition process in FIG. 28. However, in the backup path ring deleting process, the same process is performed regardless of whether the type of the node device to be processed is the DROP node device, the THR node device, or the non THR node device (step S205; backup path ring deleting process (THR/DROP/non THR node)).

In the following, details of the processes in steps S201, S203, and S205 which are selected based on the determined types of the node devices in FIG. 42 will be separately described. Hereinafter and in the figures, the terms “backup path control request message” and “backup path control message” may be simplified as “backup path control request” and “backup path control”, respectively.

(C-1) Backup Path Ring Deleting process (ADD Node)

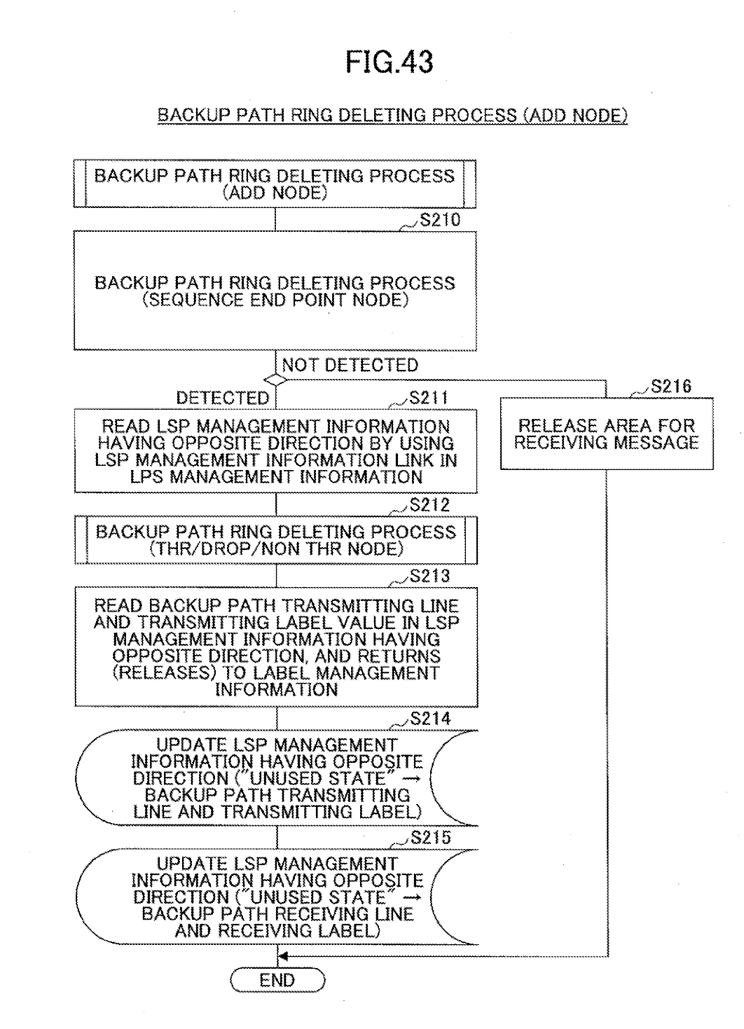

FIG. 43 is an example flowchart of the detailed backup path ring deleting process (ADD Node). In FIG. 43, first, the ADD node device as the sequence start point node device refers to the data of the “(3) Currently Used Path Receiving Line Number of ADD Node” in the received backup path control request message, and searches for the LSP management information having the data of the “(9) Receiving Line of Currently Used Path” which is the same as the data of the “(3) Currently Used Path Receiving Line Number of ADD Node” (step S210). At this timing, the addition process of the currently used path has been performed. Therefore, in the LSP management information of the node device, the data of the “(9) Receiving Line of Currently Used Path” has been set. Because of this feature, by performing this search, at lease one set of the LSP management information is searched for (detected). In step S210, when no LSP management information is detected (not applicable (N/A)), the area for the receiving message is released (step S216) and the process is terminated without executing steps 5211 through 5215. The processes of steps 5211 through S215 are performed on the LSP management information having been searched for (detected) in step S210 and the other LSP management information having the direction opposite to (different from) the direction of the LSP management information searched for (detected) in step S210.

The ADD node device refers to the data of the “(2) LSP Management Information Link” in the LSP management information to be processed, and reads the LSP management information having the opposite direction (step S211). Next, the ADD node device performs the backup path control message generation process (step S212), and transmits the backup path control message to the adjoining node device in the ring type network. The backup path control message generation process is descried above with reference to FIG. 31. Further, the ADD node device reads the data of the “(15) Transmitting Line of Backup Path” and the data of the “(16) Transmitting Label of Backup Path” in the LSP management information read in step S211, and returns (releases) the label to the label management information (step S213). Namely, the ADD node device returns the label value acquired in the backup path ring adding process (see step S64 in FIG. 29) to the label management information. The returned label may be used when another path is established.

Further, the ADD node updates the LSP management information having the opposite direction read in step S211 by setting the data “unused state” to the data of the “(15) Transmitting Line of Backup Path” and the data of the “(16) Transmitting Label of Backup Path” in the LSP management information having the opposite direction (step S214). In the same manner, the ADD node updates the LSP management information having the opposite direction read in step S211 by setting the data “unused state” to the data of the “(13) Receiving Line of Backup Path” and the data of the “(14) Receiving Label of Backup Path” in the LSP management information having the opposite direction (step S215). By executing the steps 5214 and 5215, the state of the backup path in the LSP management information is returned to the initial state (i.e., the state before adding the backup path).

(C-2) Backup Path Ring Deleting process (Sequence End Point Node)

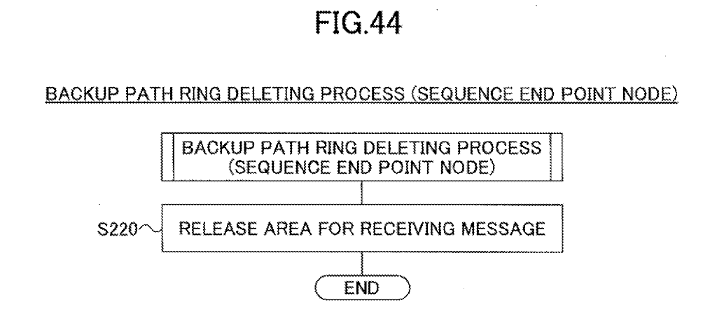

FIG. 44 is an example flowchart of a backup path ring deleting process (Sequence End Point Node).

In FIG. 44, the sequence end point node device is the ADD node device which is the sequence start point node device. Therefore, the backup path ring deleting process (Sequence End Point Node) is completed by performing the process in FIG. 43. Therefore, the area for the receiving message is released (step S220), and the process is terminated.

Further, as described above, the backup path control message traveling in the ring type network is terminated at the sequence end point node device.

### (C-3) Backup Path Ring Deleting Process (THR/DROP/Non Thr Node)

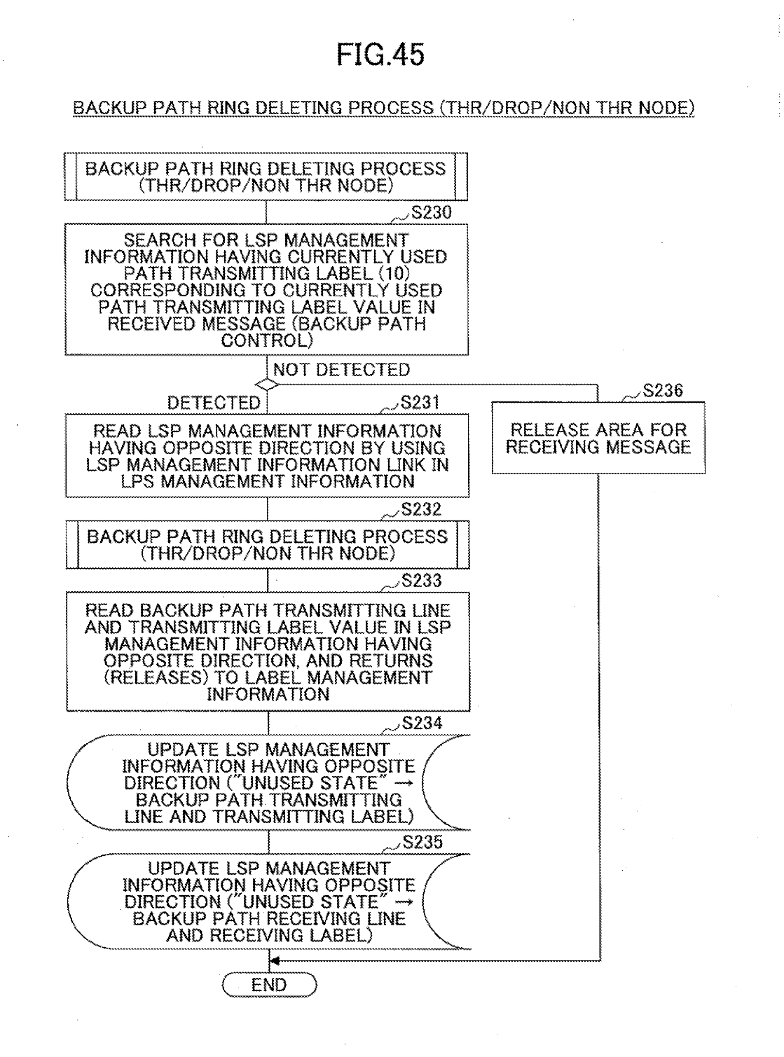

FIG. 45 is an example flowchart of the detailed backup path ring deleting process (THR/DROP/Non THR Node). In FIG. 45, first, the node device refers to the data of the “(9) Transmitting Label Value of Currently Used Path” in the backup path control message received from the adjoining node device in the ring type network, and searches for the LSP management information having the data of the “(10) Receiving Label of Currently Used Path” which is the same as the data of the “(9)

Transmitting Label Value of Currently Used Path” (step S230). At this timing, the addition process of the currently used path has been performed. Therefore, in the LSP management information of the node device, the data value of the “(9) Receiving Line of Currently Used Path” has been set. Because of this feature, by performing this search, at lease one set of the LSP management information is searched for (detected). In step S230, when no LSP management information is detected (not applicable (N/A)), the area for the receiving message is released (step S236) and the process is terminated without executing steps S231 through S235. The processes of steps S231 through S215 are performed on the LSP management information having been searched for (detected) in step S230 and the other LSP management information having the direction opposite to (different from) the direction of the LSP management information searched for (detected) in step S230.

The node device refers to the data of the “(2) LSP Management Information Link” in the LSP management information to be processed, and reads the LSP management information having the opposite direction (step S231). Next, the node device performs the backup path control message generation process (step S232), and transmits the backup path control message to the adjoining node device in the ring type network. The backup path control message generation process may be the same process descried above with reference to FIG. 38. Further, the node device reads the data of the “(15) Transmitting Line of Backup Path” and the data of the “(16) Transmitting Label of Backup Path” in the LSP management information read in step S231, and returns (releases) the label to the label management information (step S233). Namely, the node device returns the label value acquired in the backup path ring adding process (see step S128 in FIG. 35) to the label management information. The returned label may be used when another path is established.

Further, the node updates the LSP management information having the opposite direction read in step S231 by setting the data “unused state” to the data of the “(15) Transmitting Line of Backup Path” and the data of the “(16) Transmitting Label of Backup Path” in the LSP management information having the opposite direction (step S234). In the same manner, the node updates the LSP management information having the opposite direction read in step S231 by setting the data “unused state” to the data of the “(13) Receiving Line of Backup Path” and the data of the “(14) Receiving Label of Backup Path” in the LSP management information having the opposite direction (step S235). By executing the steps S234 and S235, the state of the backup path in the LSP management information is returned to the initial state (i.e., the state before adding the backup path).

In the above descriptions, details of adding and deleting the backup path depending on the types of the node devices are described.

4.2 Example of Transmitting and Receiving Messages between Node Devices

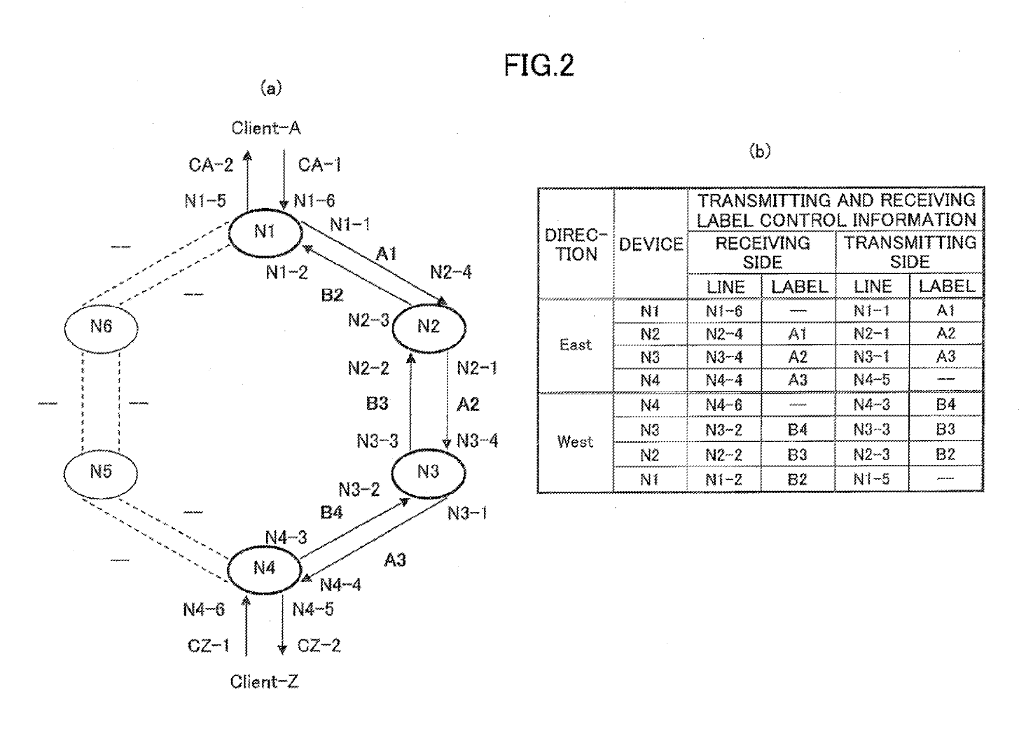

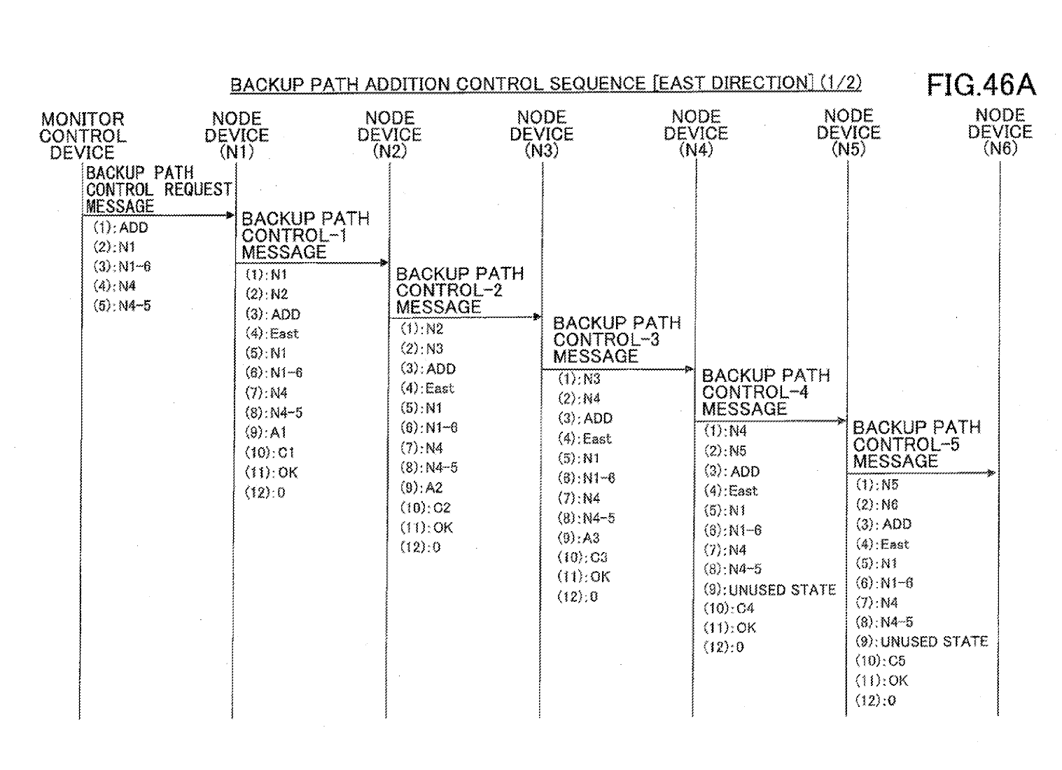

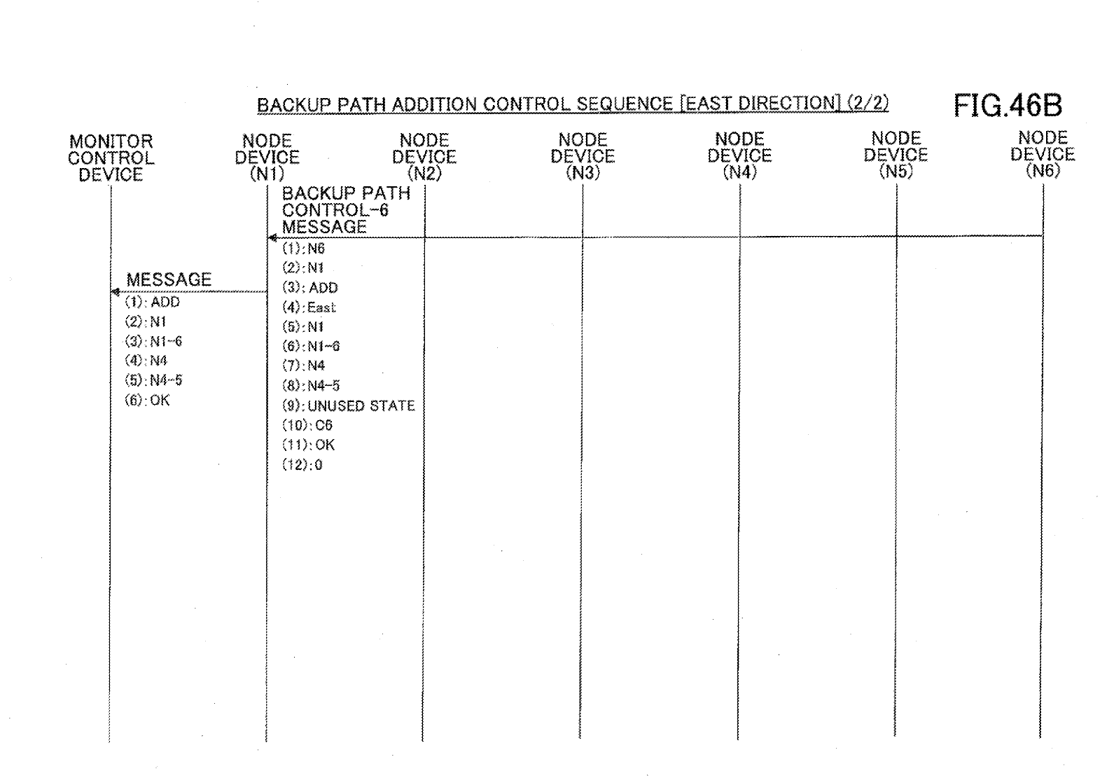

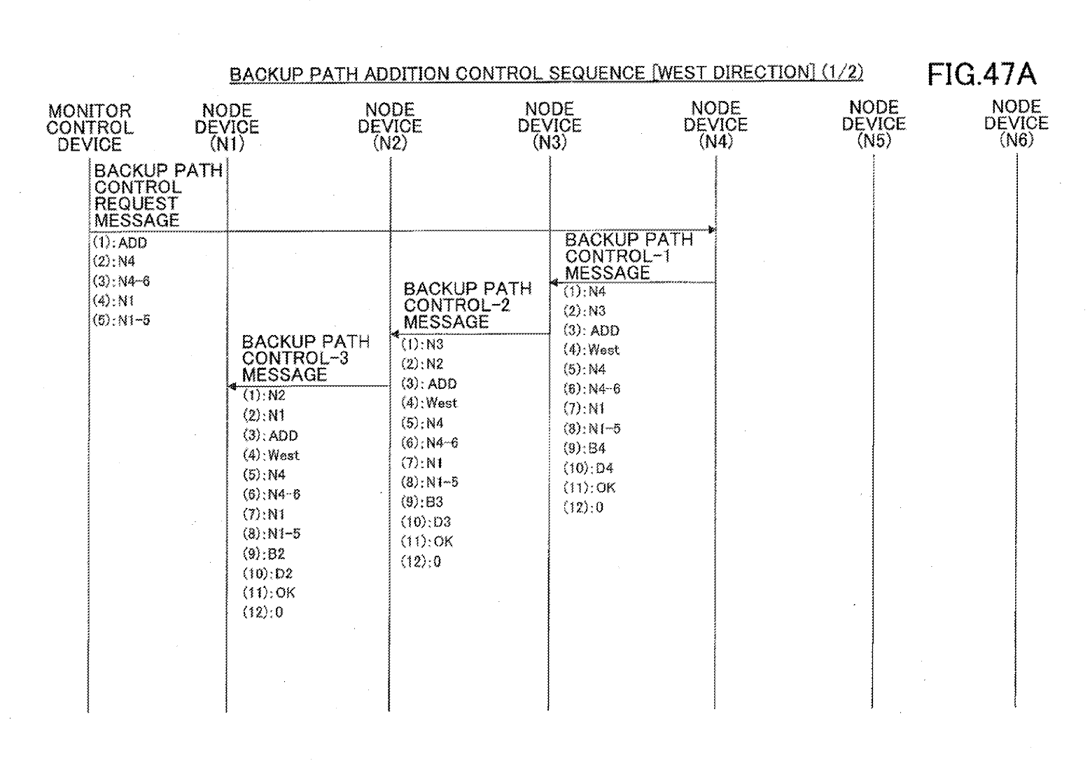

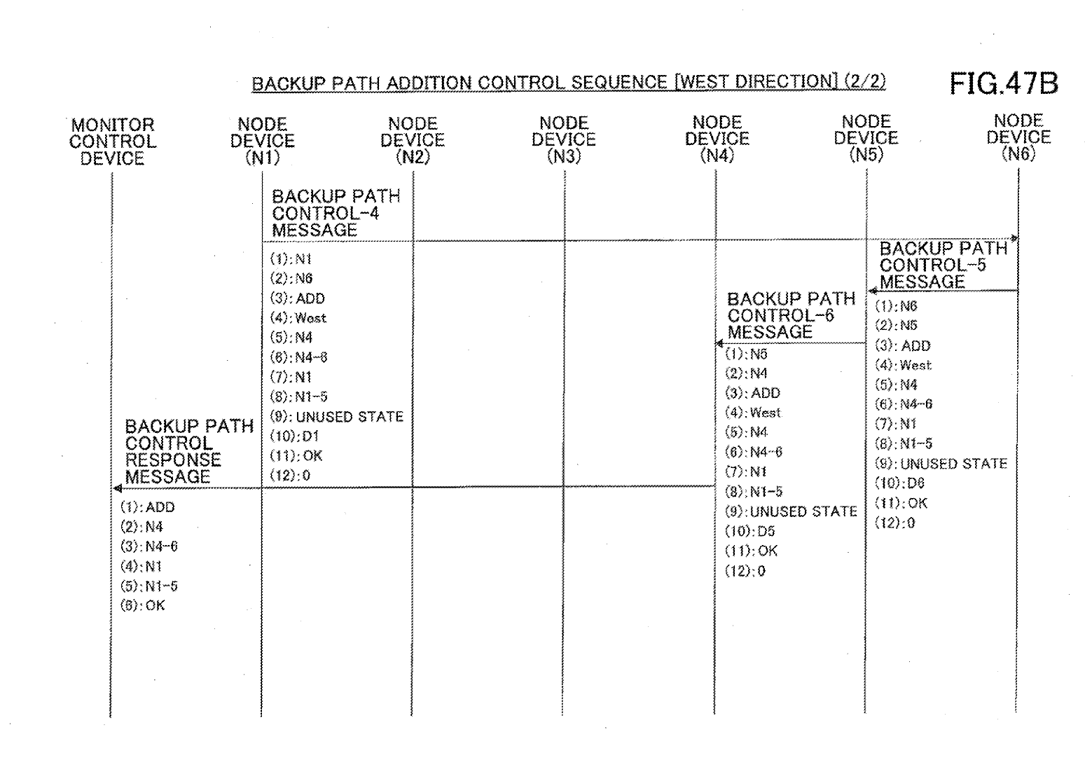

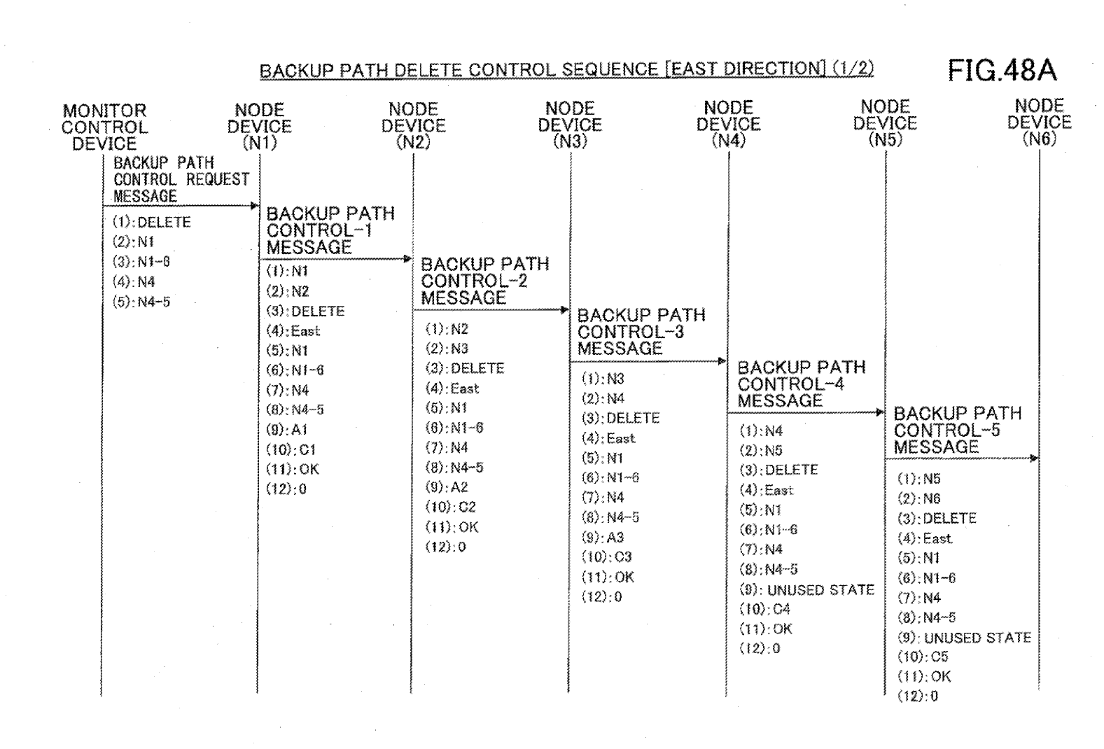

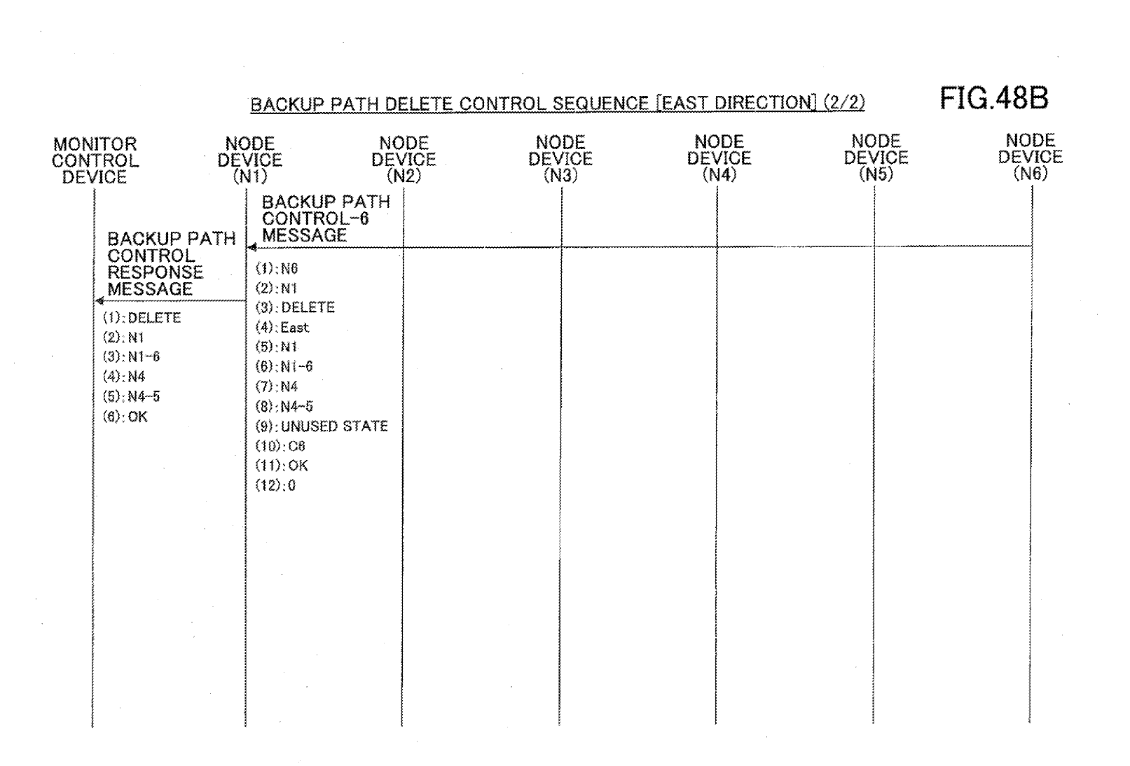

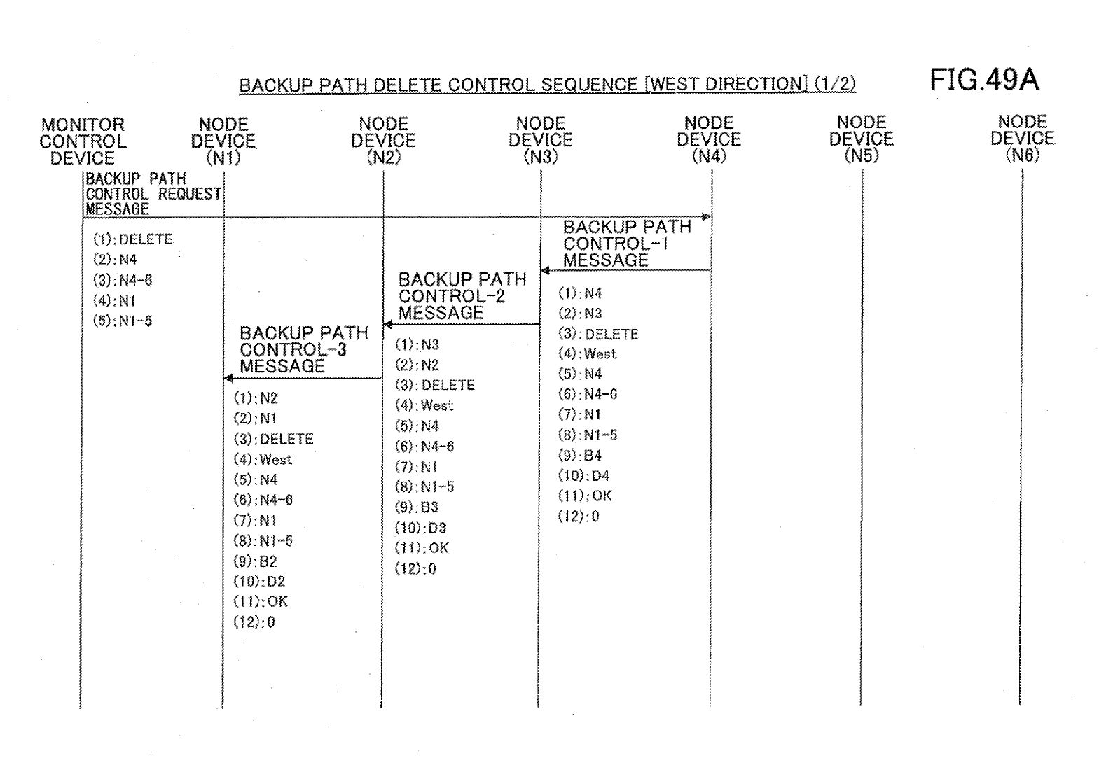

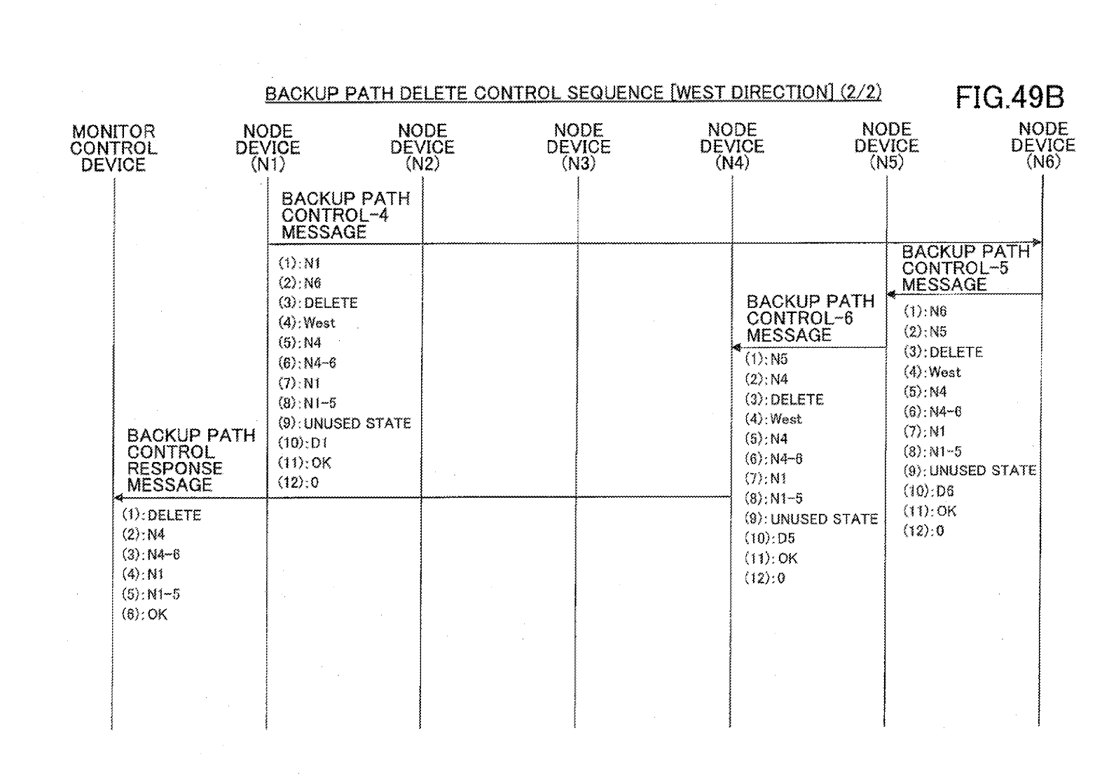

Next, with reference to FIGS. 46A through 49B, specific examples of the contents of the messages transmitted and received between the node devices bidirectionally in the ring type network as a result of the processes described with the reference to FIGS. 26 through 42 are described. Herein, FIGS. 46A through 49B exemplarily illustrate cases where the backup path corresponding to the currently used path is added or deleted as illustrated in FIG. 2. More specifically, FIGS. 46A and 46B are sequence diagrams illustrates the contents of the message sequentially transmitted in East direction in the ring type network when the backup path is added (established). FIGS. 47A and 47B are sequence diagrams illustrates the contents of the message sequentially transmitted in West direction in the ring type network when the backup path is added (established). FIGS. 48A and 48B are sequence diagrams illustrates the contents of the message sequentially transmitted in East direction in the ring type network when the backup path is deleted. FIGS. 49A and 49B are sequence diagrams illustrates the contents of the message sequentially transmitted in West direction in the ring type network when the backup path is deleted.

In FIGS. 45 through 49B, the term “Backup Path Control-x Message” refers to the backup path control message transmitted from the node device Nx (x:1-5) to the node device Nx+1. Further, the data of the data items (1) through (5) of the backup path control request message correspond to the data of the numbers ((1) through (5)) in FIG. 23. The data of the data items (1) through (12) in the “Backup Path Control-x Message” (x:1-5) correspond to the data of the numbers ((1) through (12)) in FIG. 24. The data of the data items (1) through (6) of the backup path control response message correspond to the data of the numbers ((1) through (6)) in FIG. 25.

As illustrated in FIGS. 46A and 46B, when the backup path is added, the backup path control request message is transmitted from the monitor control device to the node device N1 which is the ADD node device. Then the backup path control message is sequentially transmitted from the ADD node device N1 to the adjoining node device in the order of N1→N2→N3→N4→N5→N6→N1. In this case, the backup path control request message transmitted from the monitor control device includes data items of the (1) Process Request, (2) ADD Node Identification Information, (3) Currently Used Path Receiving Line Number of ADD Node, (4) DROP Node Identification Information, and (5) Currently Used Path Transmitting Line Number of DROP Node. The data of those data items (1) through (5) are disposed (set) to the data of the data items (3), (5), (6), (7), and (8), respectively, in the backup path control message in the ADD node device N1, and also disposed in the same positions (data items) in all the backup path control message to be transmitted between the node devices later. The data of the data items (1) and (2) in the backup path control message are the data of the “(1) Transmission Source Node Identification Information” and the data of the “(2) Transmission Destination Node Identification Information”, respectively. Therefore, the data of the data items (1) and (2) of the “Backup Path Control-x Message” are “Nx” and “Nx+1”, respectively. Further, the data of the data item (4) of the “Backup Path Control-x Message” represents the direction of the backup path to be added (see FIG. 24). Therefore, in FIGS. 46A and 46B, all the data of the data item (4) of the “Backup Path Control-x Message” is “East”.

The data of the data item (9) in the backup path control message represents the transmitting label value of the currently used path (see FIG. 24). However, the transmitting label value of the currently used path has already been set in the node device where the currently used path exists since the currently used path has been added (as the data of the data item (11) in the LSP management information). In the example of FIG. 6, in the currently used path formed in the order of N1→N2→N3→N4, the transmitting label values of the node devices N1, N2, and N3 are A1, A2, and A3, respectively. Therefore, the data of the data item “(9) Transmitting Label Value of Currently Used Path” of the “Backup Path Control-x Message” (x=1,2,3) in FIG. 46A are A1, A2, and A3, respectively. On the other hand, in the example of FIG. 6, no currently used path is established in an area expressed in N4→N5→N6→N1. Therefore, all the data of the data item “(9) Transmitting Label Value of Currently Used Path” of the “Backup Path Control-x Message” (x=1,2,3) in FIGS. 46A and 46B are “unused state”.

The data of the data item (10) in the backup path control message represents the transmitting label value of the backup path (see FIG. 24). However, the transmitting label value of the backup path has set in the node device regardless of whether the currently used path exists in the node device. Upon receiving the backup path control request message or the backup path control message, the node device searches for and acquires the unused transmitting label value as the transmitting label value of the backup path from the label management information. Then, the node device sets the acquired transmitting label value as the data of data item (10) in the backup path control message transmitted from the node device. The node devices N1 through N6 in FIGS. 46A and 46B set the values C1 through C6 as the respective transmitting label values as illustrated in FIG. 7. As a result, the data of the data item (10) in the “Backup Path Control-x Message” (x=1 through 6) are Cx (x: 1 through 6).

When the backup path control message is circulated and returned to the node device N1, the transmitting label values of the backup path in East direction in the ring type network are set for each of the node devices. When the backup path control message is circulated and returned to the node device N1 without incurring a failure, as illustrated in FIG. 46B, the node device N1 reports the backup path control response message having the data of “(6) Process Result” indicating “OK” to the monitor control device.

The sequence diagram of FIGS. 47A and 47B differs from the sequence diagram of FIGS. 46A and 46B in that the direction in adding the backup path is “West”. Accordingly, for example, the data setting in the message FIGS. in 47A and 47B is similar to that in FIGS. 46A and 46B. In the case of FIGS. 47A and 47B, the backup path is established so as to correspond to the currently used path formed in N4→N3→N2→N1. Therefore, first, the backup path control request message is transmitted to the node device N4 which is the ADD node device from the monitor control device. Then, the backup path control message is transmitted from the ADD node device N4 to the adjoining node device and further transmitted in the order of N4→N3→N2→N1→N6→N5→N4.

In the example of FIG. 6, in the currently used path formed in the order of N4→N3→N2→N1, the transmitting label values of the node devices N4, N3, and N2 are B4, B3, and B2, respectively. Therefore, the data of the data item “(9) Transmitting Label Value of Currently Used Path” of the “Backup Path Control-x Message” (x=1,2,3) in FIG. 47A are B4, B3, and B2, respectively. On the other hand, in the example of FIG. 6, no currently used path is established in N1→N6→N5→N4. Therefore, all the data of the of the data item “(9) Transmitting Label Value of Currently Used Path” of the “Backup Path Control-x Message” (x=4,5,6) in FIG. 47B are “unused state”.

The node devices N1 through N6 in FIGS. 46A and 46B sets the respective values D1 through D6 as the transmitting label values. As a result, the data of the data item (10) in the “Backup Path Control-x Message” (x=1 through 6) are D4, D3, D2, D1, D6, and D5, respectively.

As illustrated in FIGS. 48A and 48B, to delete the backup path, the backup control request message is transmitted from the monitor control device to the node device N1 which is the ADD node device. Then, the backup control message is transmitted from the ADD node device N1 to the adjoining node device, and further transmitted in the order of N1→N2→N3→N4→N5→N6→N1. The data of the backup path control message in the sequence diagram of FIGS. 48A and 48B differ from the data of the backup path control message in the sequence diagram of FIGS. 46A and 46B in that the data of the data item “(3) Process Request” indicate the request to delete data. As the backup path control message sequentially transmits through the node devices, the data value “unused state” is accordingly set to the data of the transmitting line, the transmitting label, the receiving line, and the receiving label.

As illustrated in FIGS. 49A and 49B, to delete the backup path, the backup control request message is transmitted from the monitor control device to the node device N4 which is the ADD node device. Then, the backup control message is transmitted from the ADD node device N4 to the adjoining node device, and further transmitted in the order of N4→N3→N2→N1→N6→N5→N4. The data of the backup path control message in the sequence diagram of FIGS. 49A and 49B differ from the data of the backup path control message in the sequence diagram of FIGS. 47A and 47B in that the data of the data item “(3) Process Request” indicate the request to delete data. As the backup path control message sequentially transmits through the node devices, the data value “unused state” is accordingly set to the data of the transmitting line, the transmitting label, the receiving line, and the receiving label.

As described above, in the ring type network according to an embodiment, the node device sets a first label as the transmitting label of the backup path corresponding to a specific currently used path in two directions. The direction of the backup path is East, and the first label is not used in any other paths. Then, the node device transmits the first label to the adjoining node device in East direction. The node device having received the first label sets the first label as the receiving label of the backup path in East direction of the node device. Herein, the labels C1 through C6 included in the respective backup path control messages in FIGS. 46A and 46B are examples of a first label.

Further, the node device sets a second label as the transmitting label of the backup path corresponding to the specific currently used path. The direction of the backup path is East which is opposite to West, and the second label is not used in any other paths. Then, the node device transmits the second label to the adjoining node device in West direction. The node device having received the second label sets the second label as the receiving label of the backup path in West direction of the node device. Herein, the labels D1 through D6 included in the respective backup path control messages in FIGS. 46A and 46B are examples of a second label.

As described above, in the ring type network according to an embodiment, when a currently used path is established, a corresponding backup path in both directions is also established by circulating the message in East and West directions in the ring type network. In this case, the transmitting label and the receiving label set as the backup path are also set when the currently used path is established and do not change depending on the position of a failure. Because of this feature, the number of labels prepared for the backup path corresponds to a number which is expressed by a formula (the number of node devices in network)×2 per each currently used path.

5. Protection Operation during Failure

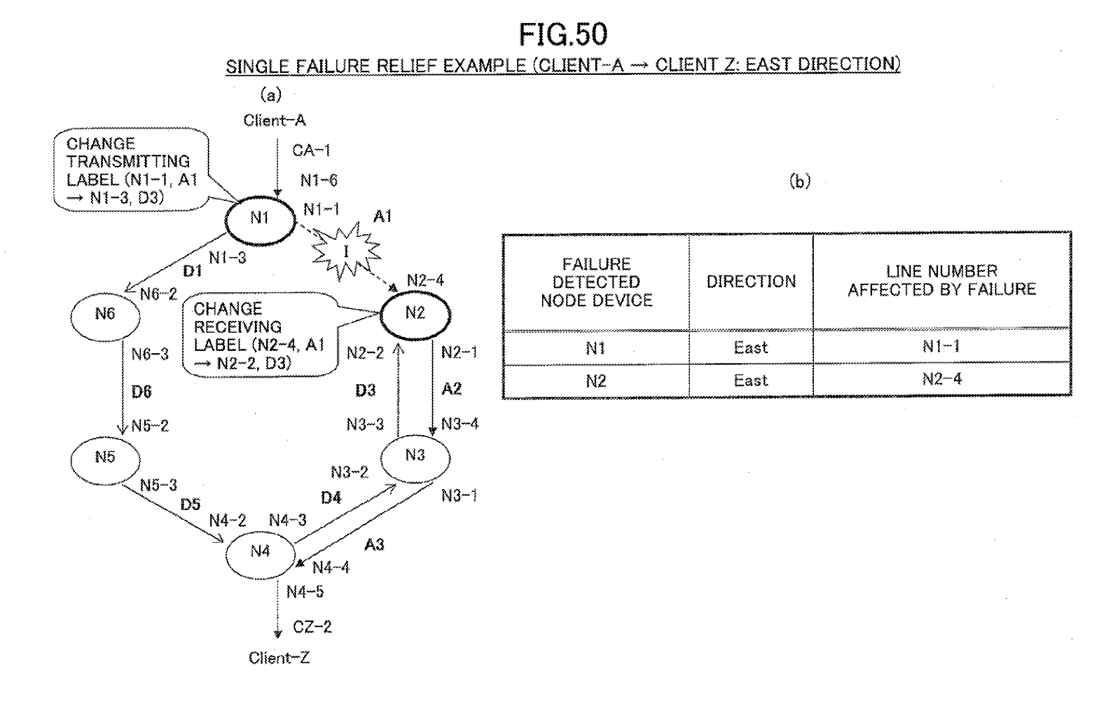

Next, an example protection operation when a failure occurs in the ring type network according to an embodiment is described with reference to FIGS. 50 through 52.

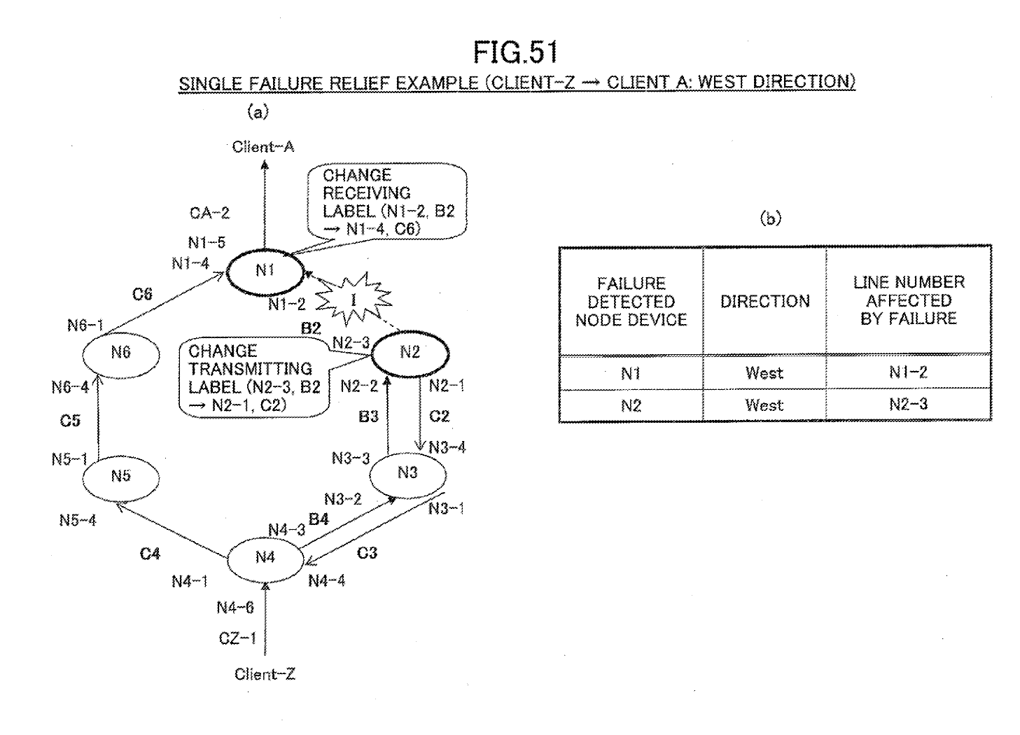

First, a protection operation when a single failure occurs in the ring type network is described with reference to FIGS. 50 and 51.

FIG. 50 illustrates an example protection operation (i.e., a communication path) when the backup path of FIG. 7 is established and a failure occurs between the node device N1 and the node device N2 in the currently used path in East direction of FIG. 6. On the other hand, FIG. 51 illustrates an example protection operation (i.e., a communication path) when the backup path of FIG. 7 is established and a failure occurs between the node device N1 and the node device N2 in the currently used path in West direction of FIG. 6.

In FIG. 50, it is assumed that the currently used path is established in East direction formed in the order of CA-1→N1→N2→N3→N4→CZ-2, and a failure I (e.g., line cut) occurs between the node device N1 and the node device N2. In this case, failure detecting node devices are node devices N1 and N2. The line numbers of the lines affected by the failure are “N1-1” and “N2-4”. In this case, the failure is detected by the node devices N1 and N2. As a result, in the node device N1, the data of the transmitting line is changed from “N1-1” to “N1-3” and the data of the transmitting label is changed from “A1” to “D1”. In the node device N2, the data of the transmitting line is changed from “N2-4” to “N2-2” and the data of the transmitting label is changed from “A1” to “D3”. Further, when the failure occurs, the communication path of CA-1→N1-3(D1)→N6-2(D1) [symbol] N6-3(D6)→N5-2 (D6) [symbol] N5-3 D5)→N4-2(D5) [symbol] N4-3(D4)→N3-2(D4) [symbol] N3-3(D3)→N2-2(D3) [symbol] N2-1(A2)→N3-4(A2) [symbol] N3-1(A3)→N4-4(A3)→CZ-2 is established.

In FIG. 51, it is assumed that the currently used path is established in West direction formed in the order of CZ-1→N4→N3→N2→N1→CA-2, and a failure I (e.g., line cut) occurs between the node device N1 and the node device N2. In this case, failure detecting node devices are node devices N1 and N2. The line numbers of the lines affected by the failure are “N1-2” and “N2-3”. In this case, the failure is detected by the node devices N1 and N2. As a result, in the node device N2, the data of the transmitting line is changed from “N2-3” to “N2-1” and the data of the transmitting label is changed from “B2” to “C2”. In the node device N1, the data of the transmitting line is changed from “N1-2” to “N1-4” and the data of the transmitting label is changed from “B2” to “C6”. Further, when the failure occurs, the communication path of CZ-1→N4-3(B4)→N3-2(B4) [symbol] N3-3(B3)→N2-2 (B3) [symbol] N2-1(C2)→N3-4(C2) [symbol] N3-1(C3)→N4-4(C3) [symbol] N4-1(C4)→N5-4(C4) [symbol] N5-1(C5)→N6-4 (C5) [symbol] N6-1 (C6)→N1-4 (C6)→CA-2 is established (formed).

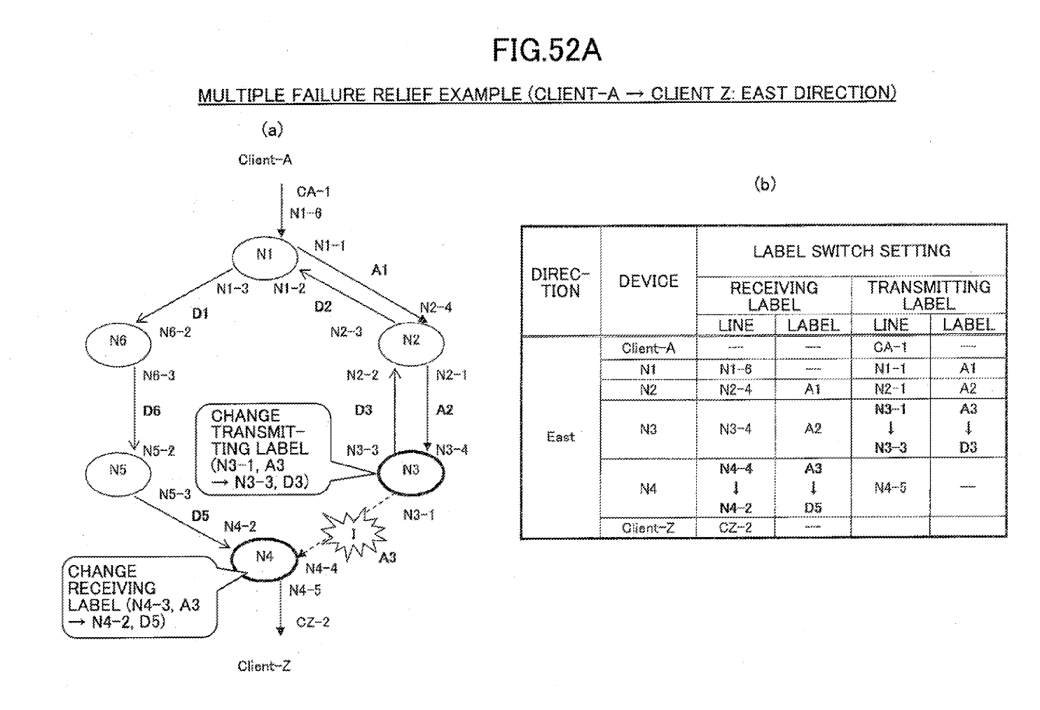

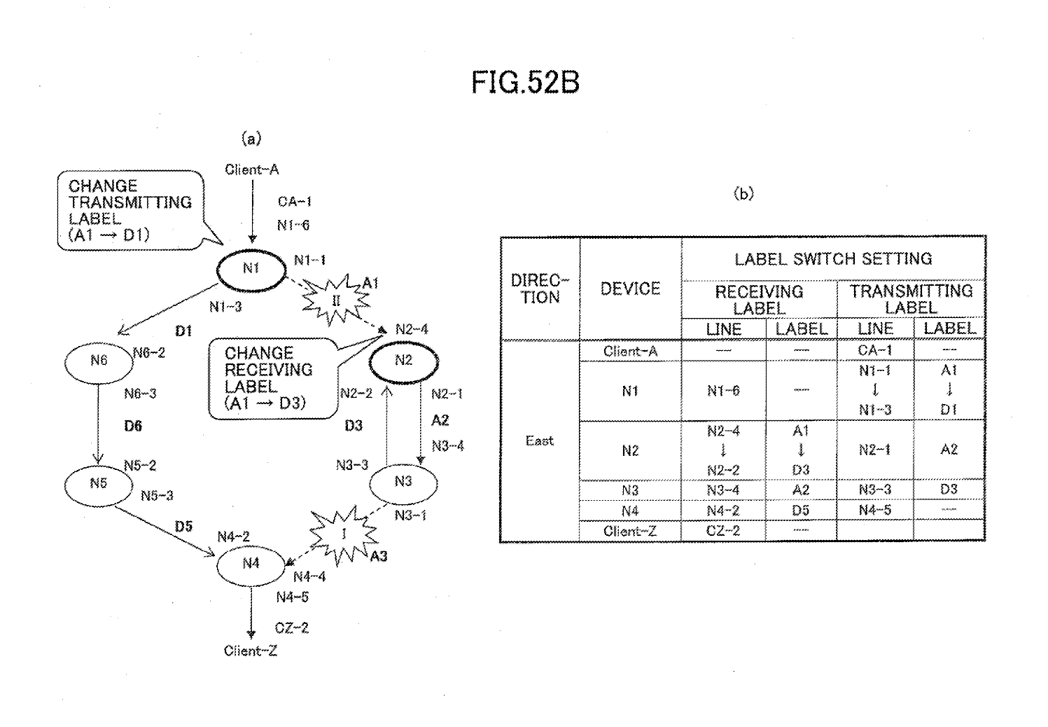

Next, an example protection operation when multiple failures occur in the ring type network according to an embodiment is described with reference to FIGS. 52A and 52B.

FIG. 52A illustrates an example protection operation when a first failure I occurs between the node device N3 and the node device N4 in the currently used path in East direction illustrated in FIG. 6. FIG. 52B illustrates an example protection operation when a second failure II subsequently occurs between the node device N1 and the node device N2 after the first failure I. In each of FIGS. 52A and 52B, a part (a) illustrates the communication path formed when the failure occurs, and a part (b) illustrates switching operations of the lines and labels.

In FIG. 52A, it is assumed that the currently used path is established (formed) in East direction in the order of CA-1→N1→N2→N3→N4→CZ-2 and the failure I (e.g., line cut) occurs between the node device N3 and the node device N4. In this case, the failure is detected by the node devices N3 and N4, and the line numbers of the lines which are affected by the failure are “N3-1” and “N4-4”. As a result, as illustrated in the part (b) of FIG. 52A, in the node device N3, the transmitting line is changed from “N3-1” to “N3-3” and the transmitting label is changed from “A3” to “D3”. Further, in the node device N4, the transmitting line is changed from “N4-4” to “N4-2” and the transmitting label is changed from “A3” to “D5”. Further, when the failure I occurs, the communication path of CA-1→N1-1(A1)→N2-4(A1) [symbol] N2-1(A2)→N3-4(A2) [symbol] N3-3(D3)→N2-2(D3) [symbol] N2-3(D2)→N1-2(D2) [symbol] N1-3(D1)→N6-2(D1) [symbol] N6-3(D6)→N5-2(D6) [symbol] N5-3(D5)→N4-2(D5)→CZ-2 is established.

When the failure II further occurs between the node devices N1 and N2, the failure is detected by the node devices N1 and N2. As a result, as illustrated in the part (b) of FIG. 52B, in the node device N1, the transmitting line is changed from “N1-1” to “N1-3” and the transmitting label is changed from “A1” to “D1”. Further, in the node device N2, the transmitting line is changed from “N2-4” to “N2-2” and the transmitting label is changed from “A1” to “D3”. Further, after the failure II occurs, the communication path of CA-1→N1-3(D1)→N6-2(D1) [symbol] N6-3(D6)→N5-2 (D6) [symbol] N5-3(D5)→N4-2(D5)→CZ-2 is established. As described above, in the ring type network according to an embodiment, a fixed bi-directional backup path may be established. Therefore, it may become possible to rescue (transmit) the main signal even when multiple failures occur.

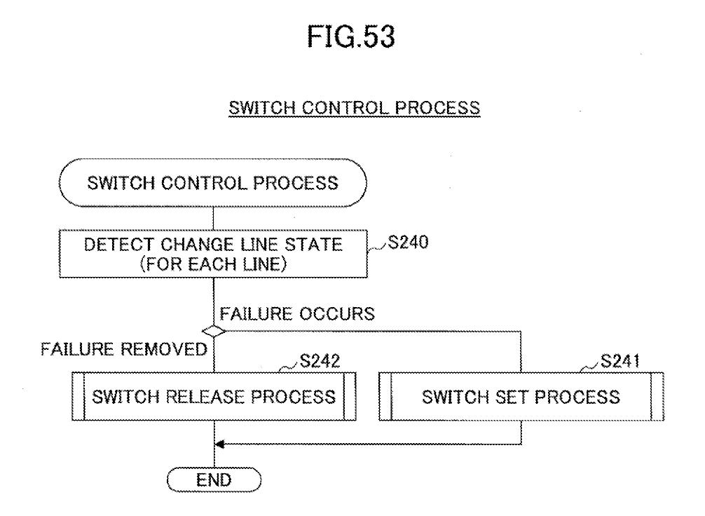

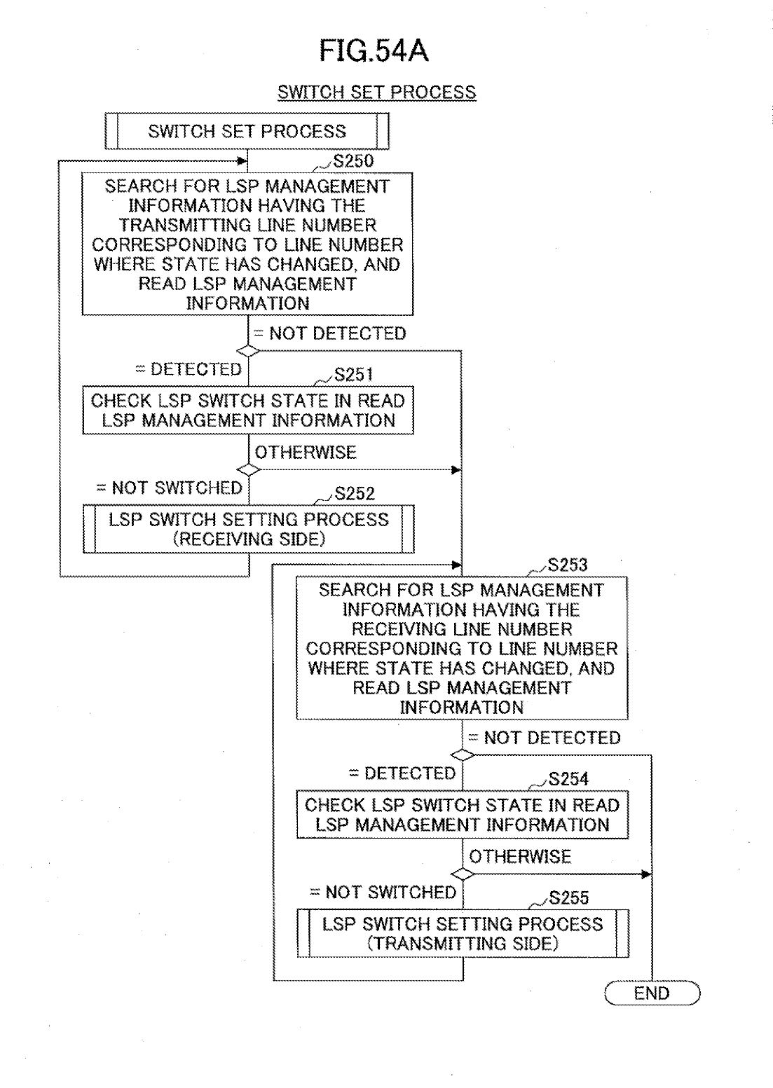

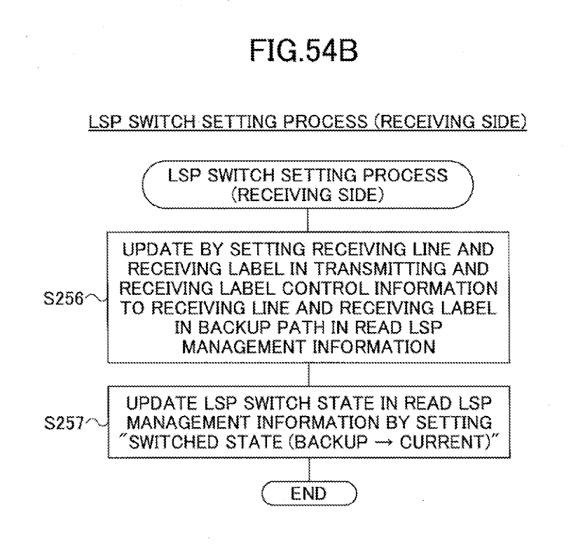

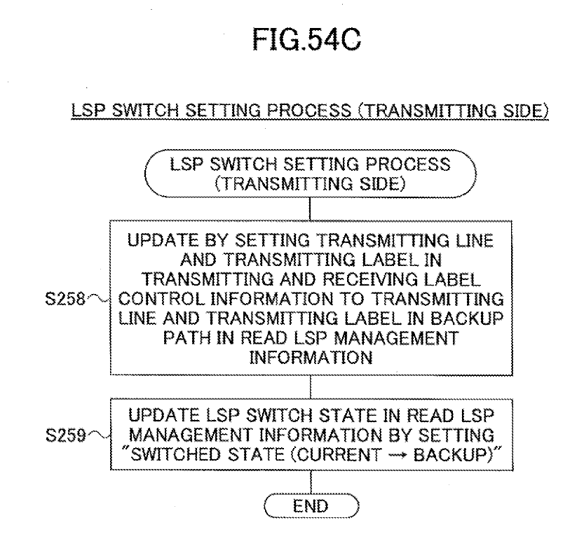

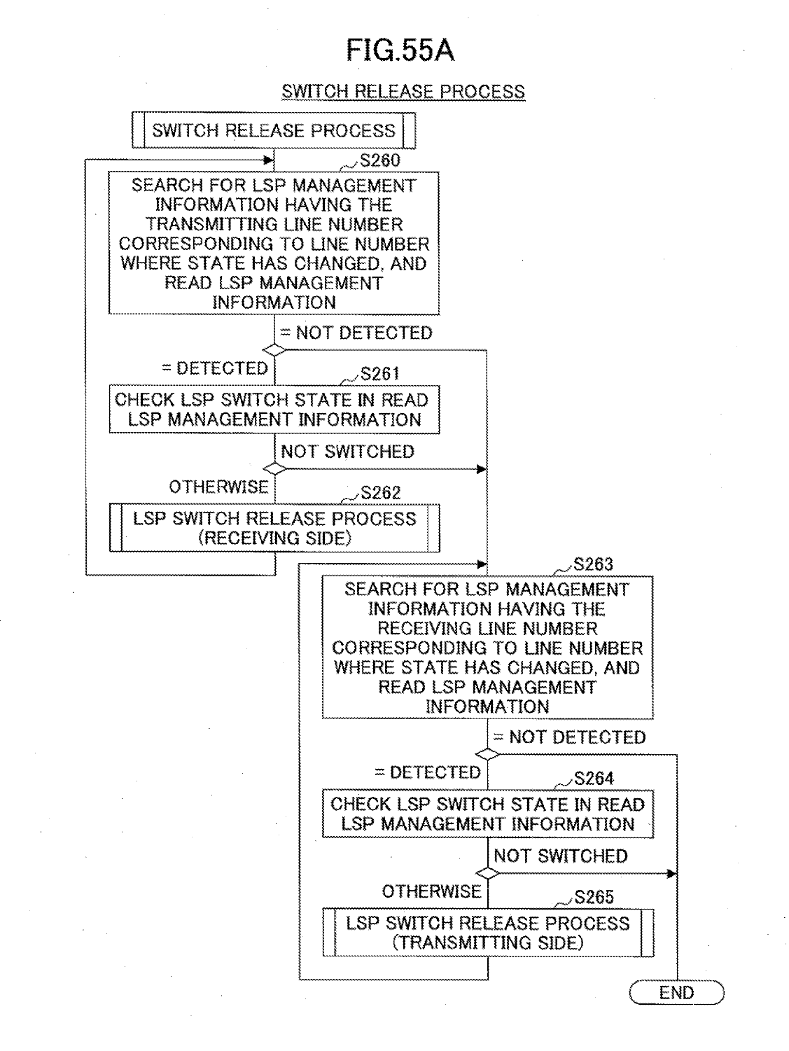

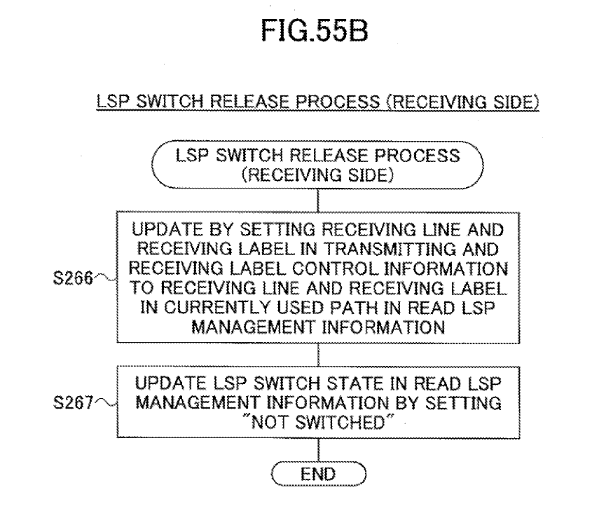

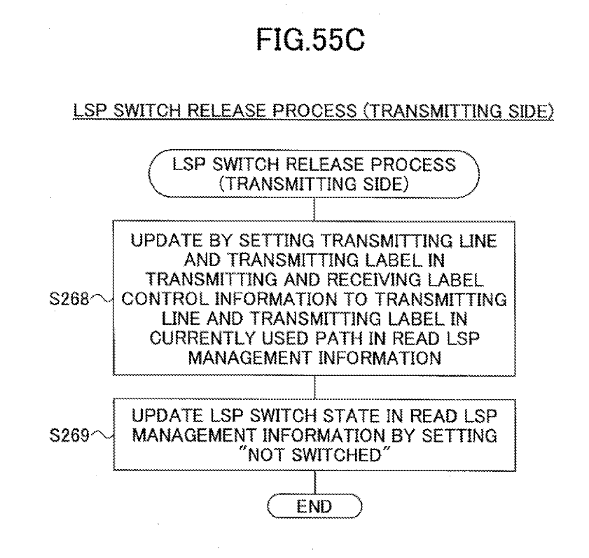

Next, the processes performed by the node device in the protection operation during a failure are further described with reference to FIGS. 53 through 55C. FIG. 53 is an example flowchart illustrating a switching control process when a failure occurs and the transmission is restored. FIGS. 54A through 54A and 55A through 55C are detailed flowchart illustrating the switch set process and the switch release process, respectively, of FIG. 53.

Referring to FIG. 53, in the node device, the failure detector 23 detects a change (failure) in each of the lines connected to the node device (step S240). Herein, the change in the line includes the change from a normal state to a failed state (i.e., a failure occurs in the line) and the change from the failed state to the normal state (i.e., the failure is corrected (removed) in the line). The change may be detected by, for example, determining whether a scheduled signal transmitted through the currently used path is received through the line. When determining that the state change in the line indicates a failure in the line, the node device performs the switch set process (in step S241). On the other hand, when determining that the state change in the line indicates that the correction of the failure, the node device performs the switch release process (in step S242).

The switch set process is described with reference to FIGS. 54A through 54C. FIG. 54A is an example flowchart of the switch set process in FIG. 53. FIG. 54B is an example flowchart of an LSP switch set process performed by the node device on the receiving side. On the other hand, FIG. 54C is an example flowchart of the LSP switch set process performed by the node device on the transmitting side.

When a failure occurs in a line, the failure detector 23 in the node device sends a report indicating the line number of the line where the state has changed (i.e. where the failure occurs) to the LSP controller 20. Upon receiving the report from the failure detector 23, the LSP controller 20 searches for the receiving line number of the currently used path in all the LSP management information by using the line number in the report as a key, and reads the LSP management information having the same line number as that in the report (step S250). In step S250, when there exists the LSP management information having the same line number as that in the report in a node device, it means that the node device is disposed on the receiving side of the line where the failure occurs. In step S250, the LSP management information corresponding to all the LSPs set in the node device disposed on the receiving side of the line where the failure occurs are read. Further, the processes after step S250 are performed on all of the read LSP management information. In step S250, however, when no LSP management information is detected, the process goes to step S253 described below.

In step S250, when the corresponding LSP management information is detected, the node device determines an LSP switch state in the detected LSP management information (step S251). When determining that the LSP switch state is “not switched”, the node device performs an LSP switch set process (receiving side) to switch the path (step S252). Namely, as illustrated in FIG. 54B, the node device updates the receiving line and the receiving label in the transmitting and receiving label control information storage section 12 by using the receiving line and the receiving label of the currently used path in the LSP management information read in step S250 (step S256). Further, the node device updates the LSP switch state by setting “switched state (backup→current)” (step S257).

In step S250, when no corresponding LSP management information is detected, the node device performs the following processes which vary depending on whether the node device is disposed on the transmitting side of the line where a failure occurs. The LSP controller 20 already receives the report including the line number of the line where a failure occurs. Therefore, the LSP controller 20 searches for (detects) LSP management information having the transmitting line number of the currently used path corresponding to the line number in the report from among all sets of the LSP management information in the node device, and reads the detected LSP management information (step S253). In step S253, when there exists the LSP management information having the same line number as that in the report in a node device, it means that the node device is disposed on the transmitting side of the line where the failure occurs. Further, in step S253, the LSP management information corresponding to all the LSPs set in the node device disposed on the transmitting side of the line where the failure occurs are read. Further, the processes after step S253 are performed on all of the read LSP management information. In step S253, however, when no LSP management information is detected, it means that the node device is not disposed on either the receiving side or the transmitting side of the line where a failure occurs. Therefore, it is not necessary to switch the path, and the process is terminated.

When there is corresponding LSP management information detected in step S253, the node device determines the LSP switch state in the LSP management information (step S254). When determining that the LSP switch state indicates “not switched”, the node device performs an LSP switch set process (transmitting side) to switch the path (step S255). Namely, as illustrated in FIG. 54C, the node device updates the transmitting line and the transmitting label in the transmitting and receiving label control information storage section 12 by using the transmitting line and the transmitting label of the backup path in the LSP management information read in step S253 (step S258). Further, the node device updates the LSP switch state by setting “switched state (current→backup)” (step S259).

Next, an example switch set process performed by the node devices N1 and N2 in FIGS. 50 and 51 is described.

When a failure (e.g., line cut) occurs in the line between the node devices N1 and N2, the failure detector 23 in the node devices N1 and N2 detects a receiving failure (LOS) in the line. Then, the failure detector 23 reports the line number of the line where the failure occurs to the LSP controller 20. In this case, the node device N1 reports the data “N1-1 (East direction)” and “N1-2 (West direction)” as the line numbers of the line where a failure is detected (failure detected line numbers). Further, the node device N2 reports the data “N2-3 (West direction)” and “N2-4 (East direction)” as the failure detected line numbers.

Upon receiving the failure detected line numbers, the LSP controller 20 of the node devices searches for (detects) the LSP management information having the transmitting line number of currently used path by using the failure detected line numbers as a key. Further, the LSP controller 20 reads the detected LSP management information to be switched.

As illustrated in FIG. 50, when the direction of the LSP where the failure occurs is East direction, it is thought that the node device N1 is disposed on the transmitting side of the line where the failure occurs. In this case, the node device N1 determines the LSP switch state in the corresponding LSP management information that satisfies the search condition. As a result, when determining that the LSP switch state indicates “not switched”, the node device N1 updates the transmitting line “N1-1” and the transmitting label “A1” in the transmitting and receiving label control information storage section 12 by using the transmitting line “N1-3” and the transmitting label “D1” of the backup path in the corresponding LSP management information that satisfies the search condition. Further, the node device updates the LSP switch state by setting “switched state (current→backup)”.

As illustrated in FIG. 51, when the direction of the LSP where the failure occurs is West direction, it is thought that the node device N2 is disposed on the transmitting side of the line where the failure occurs. In this case, the node device N2 determines the LSP switch state in the corresponding LSP management information that satisfies the search condition. As a result, when determining that the LSP switch state indicates “not switched”, the node device N2 updates the transmitting line “N2-3” and the transmitting label “B2” in the transmitting and receiving label control information storage section 12 by using the transmitting line “N2-1” and the transmitting label “C2” of the backup path in the corresponding LSP management information that satisfies the search condition. Further, the node device updates the LSP switch state by setting “switched state (current→backup)”.

Upon receiving the failure detected line numbers, the LSP controller 20 of the node devices searches for (detects) the LSP management information having the receiving line number of currently used path by using the failure detected line numbers as a key. Further, the LSP controller 20 reads the detected LSP management information to be switched.

As illustrated in FIG. 50, when the direction of the LSP where the failure occurs is East direction, it is thought that the node device N2 is disposed on the receiving side of the line where the failure occurs. In this case, the node device N2 determines the LSP switch state in the corresponding LSP management information that satisfies the search condition. As a result, when determining that the LSP switch state indicates “not switched”, the node device N2 updates the receiving line “N2-4” and the receiving label “A1” in the transmitting and receiving label control information storage section 12 by using the receiving line “N2-2” and the receiving label “D3” of the backup path in the corresponding LSP management information that satisfies the search condition. Further, the node device updates the LSP switch state by setting “switched state (backup→current)”.

As illustrated in FIG. 51, when the direction of the LSP where the failure occurs is West direction, it is thought that the node device N1 is disposed on the receiving side of the line where the failure occurs. In this case, the node device N1 determines the LSP switch state in the corresponding LSP management information that satisfies the search condition. As a result, when determining that the LSP switch state indicates “not switched”, the node device N1 updates the receiving line “N1-2” and the receiving label “B2” in the transmitting and receiving label control information storage section 12 by using the receiving line “N1-4” and the receiving label “C6” of the backup path in the corresponding LSP management information that satisfies the search condition. Further, the node device updates the LSP switch state by setting “switched state (backup→current)”.

Next, the switch release process is described with reference to FIGS. 55A through 55C. FIG. 55A is an example flowchart of the switch release process in FIG. 53. FIG. 55B is an example flowchart of the LSP switch set process performed by the node device on the receiving side. On the other hand, FIG. 55C is an example flowchart of the LSP switch set process performed by the node device on the transmitting side.

When the failure in the line is corrected, the failure detector 23 in the node device reports the line number of the line where the state is changed (i.e., where the failure is corrected) to the LSP controller 20. Upon receiving the report from the failure detector 23, the LSP controller 20 searches for the receiving line number of the currently used path in all the LSP management information by using the line number in the report as a key, and reads the LSP management information having the same line number as that in the report (step S260). In step S260, when there exists the LSP management information having the same line number as that in the report in a node device, it means that the node device is disposed on the receiving side of the line where the failure occurs. In step S260, the LSP management information corresponding to all the LSPs set in the node device disposed on the receiving side of the line where the failure occurs are read. Further, the processes after step S260 are performed on all of the read LSP management information. In step S260, however, when no LSP management information is detected, the process goes to step S263 described below.

In step S260, when the corresponding LSP management information is detected, the node device determines the LSP switch state in the detected LSP management information (step S261). When determining that the LSP switch state is “not switched”, the node device performs an LSP switch release process (receiving side) to switch the path (step S262). Namely, as illustrated in FIG. 55B, the node device updates the receiving line and the receiving label in the transmitting and receiving label control information storage section 12 by using the receiving line and the receiving label of the currently used path in the LSP management information read in step S260 (step S266). Further, the node device updates the LSP switch state by setting “not switched” (step S267).

In step S260, when no corresponding LSP management information is detected, the node device performs the following processes which vary depending on whether the node device is disposed on the transmitting side of the line where the failure is removed. The LSP controller 20 already receives the report including the line number of the line where the failure is removed. Therefore, the LSP controller 20 searches for (detects) LSP management information having the transmitting line number of the currently used path corresponding to the line number in the report from among all sets of the LSP management information in the node device, and reads the detected LSP management information (step S263). In step S263, when there exists the LSP management information having the same line number as that in the report in a node device, it means that the node device is disposed on the transmitting side of the line where the failure occurs. Further, in step S263, the LSP management information corresponding to all the LSPs set in the node device disposed on the transmitting side of the line where the failure is removed are read. Further, the processes after step S263 are performed on all of the read LSP management information. In step S263, however, when no LSP management information is detected, it means that the node device is not disposed on either the receiving side or the transmitting side of the line where the failure is removed. Therefore, it is not necessary to switch the path, and the process is terminated.

When there is corresponding LSP management information detected in step S263, the node device determines the LSP switch state in the LSP management information (step S264). When determining that the LSP switch state indicates “not switched”, the node device performs an LSP switch release process (transmitting side) to switch the path (step S255). Namely, as illustrated in FIG. 55C, the node device updates the transmitting line and the transmitting label in the transmitting and receiving label control information storage section 12 by using the transmitting line and the transmitting label of the backup path in the LSP management information read in step S263 (step S268). Further, the node device updates the LSP switch state by setting “not switched” (step S269).

### 6. Loop Back Operation of OAM

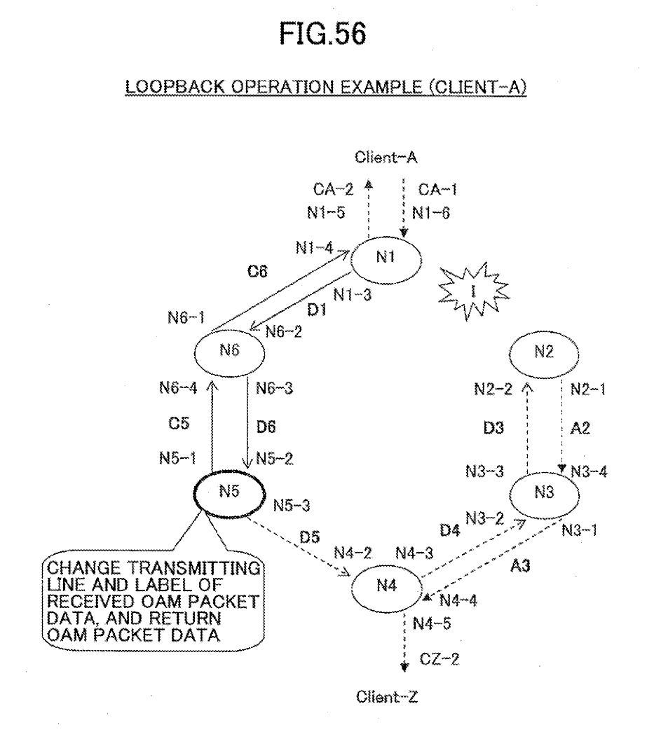

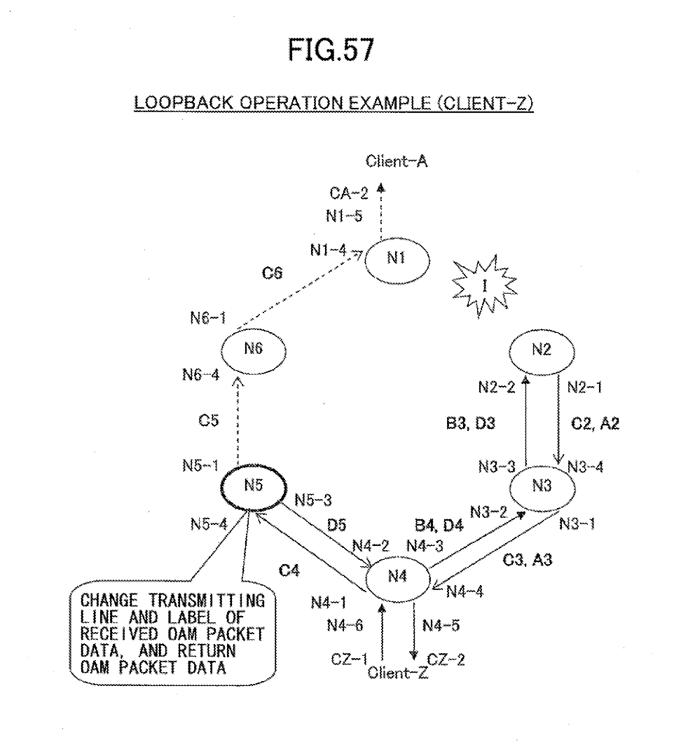

Next, an example operation when an OAM loopback function is performed by setting a specific node device in the ring type network according to an embodiment as the MIP is described with reference to FIGS. 56 and 57. FIGS. 56 and 57 illustrate a loopback operation (communication path of OAM packet data) when, for example, the MIP is set to the node device N5 and a failure occurs between the node device N1 and the node device N2. FIG. 56 illustrates a case where the node device N1 performs a loopback request using the MIP to the client-A, and FIG. 57 illustrates a case where the node device N4 performs the loopback request using the MIP to the client-Z.

In this case, in the node device where the MIP is set, the transmitting line number and the transmitting label of the OAM packet data received in East direction are updated by using the transmitting line number and the transmitting label in West direction, and the transmitting line number and the transmitting label of the OAM packet data received in West direction are updated by using the transmitting line number and the transmitting label in East direction. As described, the OAM packet data are terminated at the MIP and an MEP (ME End Point). Therefore, at the MIP and the MEP, the transmitting line and the transmitting label may be updated. In the examples of FIGS. 56 and 57, in the node device N5 where the MIP is set, the transmitting line number “N5-4” and the transmitting label “C4” of the OAM packet data received in East direction are updated by using the transmitting line number “N5-3” and the transmitting label “D5” in West direction. Further, the transmitting line number “N5-2” and the transmitting label “D6” of the OAM packet data received in West direction are updated by using the transmitting line number “N5-1” and the transmitting label “C5” in East direction. Such updating rules described above may be determined in advance.

Referring to FIG. 56, when the node device N1 performs loopback request using the MIP to the client-A, the transmitting line and the transmitting label are updated for the OAM packet data received by the node device N5 (i.e., transfer to the communication path in opposite direction). By doing this, the OAM packet data may be communicated by using the communication path of N1-3(D1) [MEP]→N6-2(D1) [symbol] N6-3 (D6)→N5-2 (D6) [symbol] N5-1 (C5) [MIP]→N6-4(C5) [symbol] N6-1(C6)→N1-4 (C6) [MEP].

On the other hand, referring to FIG. 57, when the node device N4 performs loopback request using the MIP to the client-Z, the transmitting line and the transmitting label are updated for the OAM packet data received by the node device N5 (i.e., transfer to the communication path in opposite direction). By doing this, the OAM packet data may be communication and the loopback function may be achieved by using the communication path of N4-3(B4) [MEP]→N3-2 (B4) [symbol] N3-3(B3)→N2-2 (B3) [symbol] N2-1(C2)→N3-4(C2) [symbol] N3-1(C3)→N4-4(C3) [symbol] N4-1(C4)→N5-4(C4) [symbol] N5-3 (D5) [MIP]→N4-2 (D5) [symbol] N4-3 (D4)→N3-2(D4) [symbol] N3-3(D3)→N2-2(D3) [symbol] N2-1(A2)→N3-4(A2) [symbol] N3-1 (A3)→N4-4(A3)[MEP].

As described above, in the ring type network according to an embodiment, a unique backup path in both directions (bi-directional backup path) is established. Therefore, it may become possible to communicate the OAM data packets in the protection operation regardless of the position where a failure occurs and without performing complex processes.

According to a path setting method and a transmission device according to an embodiment, it may become possible to execute the OAM function during the protection operation without performing a complicated process in the ring type network using the label switching method.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present inventions has been described in detail, it is to be understood that various changes, substitutions, and alterations could be made hereto without departing from the sprit and scope of the invention.

What is claimed is:

1. A path setting method for setting a backup path corresponding to a bi-directional currently used path in a ring type network including a plurality of transmission devices connected in a ring and using a label switching method, the path setting method comprising:
setting, by each of the transmission devices, an unused first label as a transmitting label of the backup path corresponding to the bi-directional currently used path in a first direction of the ring type network;
reporting, by each of the transmission devices, the corresponding first label to a adjoining transmission device in the first direction;
setting, by each of the adjoining transmission devices, the corresponding first label as a receiving label of the backup path in the first direction;
setting, by each of the transmission devices, an unused second label as the transmitting label of the backup path in a second direction opposite to the first direction;
reporting, by each of the transmission devices, the corresponding second label to a adjoining transmission device in the second direction; and
setting, by each of the adjoining transmission devices, the corresponding second label as the receiving label of the backup path in the second direction,
wherein the backup path is set when the currently used path is set between two of the transmission devices.

2. The path setting method according to claim 1, further comprising:
acquiring, by a transmission device receiving packet data in the currently used path or by a transmission device not transmitting and receiving packet data in the currently used path, at least one of the transmitting line and the receiving line of the backup path by accessing ring management information including information of the transmitting line and the receiving line between transmission devices adjoining each other in the ring type network.

3. A transmission device in a ring type network including the transmission devices connected in a ring and using a label switching method, the transmission device comprising:
a first storage that stores path management information including receiving lines, receiving labels, transmitting lines, and transmitting labels as setting information of a backup path corresponding to a currently used path;
a second storage that stores label management information including unused label information;
a third storage that stores ring management information including the transmitting lines and the receiving lines between the transmission devices adjoining each other in the ring type network;
a message communication circuit that transmits and receives a message with another of the transmission devices in the ring type network; and
a controller that acquires an unused transmitting label from the label management information as the transmitting label of the backup path corresponding to a specific currently used path, and sets the unused transmitting label in the path management information,
wherein the message communication circuit is configured to transmit a message including the unused transmitting label to an adjoining transmission device.

4. The transmission device according to claim 3,
wherein when the transmission device receives packet data using the currently used path or when the transmission device does not transmit and receive packet data using the currently used path, the controller is configured to acquire at least one of the transmitting line and the receiving line of the backup path corresponding to the currently used path by accessing the ring management information.

5. The transmission device according to claim 3,
wherein the path management information includes first path management information and second path management information managing a bi-directional currently used path between two specific adjoining transmission devices in the ring type network and the backup path corresponding to the bi-directional currently used path,
wherein the first path management information includes the receiving lines, the receiving labels, the transmitting lines, and the transmitting labels in the currently used path in a first direction of the ring type network and the receiving lines, the receiving labels, the transmitting lines, and the transmitting labels in the backup path in a second direction opposite to the first direction, and
wherein the second path management information includes the receiving lines, the receiving labels, the transmitting lines, and the transmitting labels in the currently used path in the second direction and the receiving lines, the receiving labels, the transmitting lines, and the transmitting labels in the backup path in the first direction.

6. The transmission device according to claim 5,
wherein in a case where the transmission device transmits packet data using the currently used path, when the transmission device transmits the message in the first direction,
the controller is configured to
set the transmitting line of the currently used path in the first path management information to the transmitting line of the backup path in the second path management information,
acquire a first label as an unused transmitting label from the label management information, and
set the first label to the transmitting label in the backup path in the second path management information, and
the message communication circuit is configured to transmit the message including the first label to an adjoining transmission device in the first direction, and
when the transmission device transmits the message in the second direction,
the controller is configured to
set the transmitting line of the currently used path in the second path management information to the transmitting line of the backup path in the first path management information,
acquire a second label as an unused transmitting label from the label management information, and
set the second label to the transmitting label in the backup path in the first path management information, and
the message communication circuit is configured to transmit the message including the second label to an adjoining transmission device in the second direction.

7. The transmission device according to claim 5,
wherein in a case where the transmission device receives packet data using the currently used path or in a case where the transmission device does not transmit and receive packet data using the currently used path, when the transmission device transmits the message in the first direction,
the controller is configured to
acquire the transmitting line in the first direction from the ring management information,
set the transmitting line to the transmitting line in the backup path in the second path management information,
acquire a first label as an unused transmitting label from the label management information, and
set the first label to the transmitting label of the backup path in the second path management information, and
the message communication circuit is configured to transmit the message including the first label to an adjoining transmission device in the first direction, and
when the transmission device transmits the message in the second direction,
the controller is configured to
acquire the transmitting line in the second direction from the ring management information,
set the transmitting line to the transmitting line in the backup path in the first path management information,
acquire a second label as an unused transmitting label from the label management information, and
set the second label to the transmitting label of the backup path in the first path management information, and
the message communication circuit is configured to transmit the message including the second label to an adjoining transmission device in the second direction.

8. The transmission device according to claim 5,
wherein in a case where the transmission device receives packet data using the currently used path or in a case where the transmission device relays packet data, when the transmission device transmits the message in the first direction,
the controller is configured to
set the receiving line of the currently used path in the first path management information to the receiving line of the backup path in the second path management information, and
set the transmitting label of the backup path of the transmission device transmitting the message to the receiving label of the backup path in the second path management information, the transmission label being included in the message, and when the transmission device transmits the message in the second direction,
the controller is configured to
set the receiving line of the currently used path in the second path management information to the receiving line of the backup path in the first path management information, and
set the transmitting label of the backup path of the transmission device transmitting the message to the receiving label of the backup path in the first path management information, the transmission label being included in the message.

9. The transmission device according to claim 5,
wherein in a case where the transmission device transmits packet data using the currently used path or in a case where the transmission device does not transmit, receive, and relay packet data, when the transmission device transmits the message in the first direction,
the controller is configured to
acquire the receiving line in the first direction from the ring management information,
set the receiving line to the receiving line of the backup path in the second path management information, and
set the transmitting label of the backup path of the transmission device transmitting the message to the receiving label of the backup path in the second path management information, the transmitting label being included in the message, and when the transmission device transmits the message in the second direction,
the controller is configured to
acquire the receiving line in the second direction from the ring management information,
set the receiving line to the receiving line of the backup path in the first path management information, and
set the transmitting label of the backup path of the transmission device transmitting the message to the receiving label of the backup path in the first path management information, the transmitting label being included in the message.
